(19) United States
(12) Patent Application Publication
(10) Pub. No.: US 2026/0233090 A1
(43) Pub. Date: Aug. 13, 2026

(54) APPLICATION EVENT-BASED COMMUNICATION CHANNEL CONTROL

(71) Applicant: Sony Interactive Entertainment LLC, San Mateo, CA (US)

(72) Inventor: Sankar Thiagasamudram, Foothill Ranch, CA (US)

(21) Appl. No.: 19/444,578

(22) Filed: Jan. 9, 2026

Related U.S. Application Data
(60) Provisional application No. 63/757,652, filed on Feb. 12, 2025.

(51) Int. Cl. A63F 13/31; A63F 13/54; A63F 13/55

(52) U.S. Cl. CPC A63F 13/31; A63F 13/54; A63F 13/55

(57) ABSTRACT

Methods, devices, and computer-readable storage media for application event -based communication channel control are disclosed. A method may be implemented by a first peripheral device, with steps including presenting first output data of an execution of a video game, wherein the first output data is received from a first user device with which the first peripheral device is communicatively coupled, receiving, over a communication channel with a second peripheral device, second output data from the second peripheral device, wherein the second output data represents user input received at the second peripheral device, presenting the second output data, identifying, based on game play data of the execution of the video game, an in-game event, and causing a change to the communication channel based on the in-game event.

### CROSS-REFERENCES TO RELATED APPLICATIONS

The present application is a U.S. Non-Provisional Appln. which claims the benefit under 35 USC §119(e) of U.S. Provisional Appln. No. 63/757,652, filed February 12, 2025; the full disclosure of which is incorporated herein by reference in its entirety for all purposes.

### BACKGROUND

This disclosure relates to systems, networks, devices, and methods relating to attachable elements carrying an identifier, multiple identifiers, attachable members, wearable accepting devices, headphones, the customization of electronic games, game software, game hosts, game engines, and game databases.

In electronic games there are various ways to interact with games including ways to modify the game play itself. For example, in some games “cheat codes,” exploits, glitches, hacks, mods, backdoors, manipulations, shortcuts, tricks, workarounds, or other entries are entered into the game controller or computer by physical sequential pressing of game controller buttons on a game controller, by typing in keys on a keyboard for a computer, or by manipulating graphical user interface (GUI) entries on displays, but these require considerable technical knowledge of the game, together with multiple game controller entries, computer keystrokes, or GUI entries, and none of these capabilities are simple, attachable, and wearable. These entries generally give characters in the game capabilities, superpowers, weapons, extra game points, or other advantages in the game. In another example, some electronic games have base units or other accepting devices for modifying games, but these accepting devices are not wearable. In another example, some electronic games can accept toys or other figures, but these toys or other figures are also not wearable. In another example, identifiers have been used with game controllers, but these identifiers are also not wearable. In other examples, gamer headphones are unable to provide simple, attachable, and wearable elements, devices, systems, and methods to activate or enter “cheat codes,” exploits, glitches, hacks, mods, backdoors, manipulations, shortcuts, tricks, workarounds, or other additional gaming capabilities.

There is a desire or need for alternative methods to customize headphones and game play in accordance with the previous issues.

### SUMMARY

Technical problems exist with systems, elements, devices, and methods of modifying or customizing headphones and characteristics of electronic games that are simple, attachable, and wearable. For example, headphones and electronic games generally don’t include elements, items, or devices that are attachable and wearable by a person, wherein the wearable attachable elements have one identifier or multiple identifiers which can change the headphone characteristics or game characteristics. This disclosure describes technical solutions with technical effects comprising systems, elements, devices, and methods for modifying headphones and customizing electronic games, game characteristics, and game play using attachable elements, identifiers, ID numbers, wearable accepting devices including headphones, and optionally communications to hosts, game engines, game databases, and networks in a simple, attachable, and wearable manner. Quite simply, instead of “plug-n-play,” this disclosure provides “attach-n-play.”

According to one embodiment, a method is implemented by a first peripheral device, including steps of presenting first output data of an execution of a video game, wherein the first output data is received from a first user device with which the first peripheral device is communicatively coupled, receiving, over a communication channel with a second peripheral device, second output data from the second peripheral device, wherein the second output data represents user input received at the second peripheral device, presenting the second output data, identifying, based on game play data of the execution of the video game, an in-game event, and causing a change to the communication channel based on the in-game event.

The method may include various optional embodiments. In some embodiments, the second peripheral device is communicatively coupled to the first user device, the communication channel is modified based on an instruction of the first user device, and the communication channel is modified by the first peripheral device. In some embodiments, the second peripheral device is communicatively coupled to a second user device associated with the execution of the video game, the communication channel is modified based on an instruction of the first user device, and the communication channel is modified by the first peripheral device.

Additionally, the method may include receiving an identifier from a hardware element that stores the identifier and that is communicatively coupled with the first peripheral device, wherein the communication channel is modified based on the identifier. In some embodiments, the first peripheral device includes a headphone, the first output includes audio, and the communication channel includes an audio channel. Additionally, the communication channel may be based on an earcup storing an identifier, attached to the headphone, and communicably coupled to the headphone. In some embodiments, third output data of the execution of the video game is presented by a video game console, and the communication channel between the first peripheral device and the second peripheral device is configured based on a direct, short range communication protocol.

According to another embodiment, a first peripheral device includes one or more processors and one or more memories storing instructions that, upon execution by the one or more processors, configure the first peripheral device to perform steps. Such steps may be configured to present first output data of an execution of an application, wherein the first output data is received from a first user device with which the first peripheral device is communicatively coupled, maintain a communication channel with a second peripheral device, receive an indication of an event associated with the execution of the application, and modify the communication channel in response to receiving the indication of the event.

In some embodiments, the first peripheral device is configured to interface with a hardware element storing an identifier; and wherein the communication channel is established based on the identifier. Additionally, modifying the communication channel may include at least one of: muting the communication channel, terminating the communication channel, changing the communication channel from being one-directional to being bi-directional, changing the communication channel from being bi-directional to being one-directional, changing a characteristic of audio sent over the communication channel, or changing, an accessibility setting associated with the communication channel. In some embodiments, the application includes a video game application, and the event includes an in-game event associated with a player operating the first user device or a second user device with which the second peripheral device is communicatively coupled. Additionally, the in-game event may correspond to game play data of the player.

In some embodiments, the user device includes a video game console operated by a player, wherein the event corresponding to a change in one or more characteristics of a in-game character corresponding to the player, and wherein the change includes at least one of: character resources, character equipment, character powers, character capabilities, character speed, character special movements, character skills, character visibility, or character senses. In some embodiments, modifying the communication channel causes a change to an input to the execution of the application, and wherein the change modifies the first output data. In some embodiments, the communication channel is a wired channel, a near-field communication channel, a Bluetooth channel, or an over Internet channel.

According to another embodiment, one or more non-transitory computer-readable storage media stores instructions that, upon execution on a first peripheral device, cause the first peripheral device to perform operations. The operations may include presenting first output data of an execution of an application, wherein the first output data is received from a first user device with which the first peripheral device is communicatively coupled, maintaining a communication channel with a second peripheral device, receiving an indication of an event associated with the execution of the application, and modifying the communication channel in response to receiving the indication of the event.

In some embodiments, modifying the communication channel comprises modifying one or more characteristics of the communication channel, and wherein the one or more characteristics relate to audio received from the second peripheral device and presented by the first peripheral device. In some embodiments, additional operations may include determining an identifier received by the second peripheral device upon the second peripheral device interfacing with a hardware element that stores the identifier, and establishing the communication channel based on the identifier. In some embodiments, an additional operation may include terminating the communication channel based on a status of the hardware element changing from active to inactive. In some embodiments, additional operations may include presenting, prior to the event, first audio data received from the second peripheral device, and presenting, after the event, second audio data received from the second peripheral device, wherein the second audio data is presented using a different output characteristic than the first audio data.

According to examples of the present disclosure, a system 100 comprises two components. The first is an attachable element 102 carrying an identifier 104 the identifier having ID number 106. The second element is a wearable accepting device 110 configured for accepting the attachable element 102 carrying the identifier 104. This wearable element 110 comprises a reader 112 configured to read the identifier 104 carried by the attachable element 102 and determine ID number 106; and a wearable accepting device processor 114 that executes wearable accepting device software 116 which is configured for receiving ID number 106 from the reader 112 and taking an action in the wearable accepting device 110.

In one example, taking the action in the wearable accepting device 110 includes verifying validity of ID number 106. In another example, taking the action in the wearable accepting device 110 includes modifying wearable accepting device software 116 in the wearable accepting device 110. In another example, the wearable accepting device 110 is a headphone 111. In another example, taking the action in the wearable accepting device 110 includes modifying acoustic parameters of the headphone 111. In another example, modifying acoustic parameters of the headphone 111 includes modifying frequency response of the headphone 111. In another example, the attachable element 102 carrying the identifier 104 is detachable from the wearable accepting device 110. In another example, the wearable accepting device 110 for accepting the attachable element 102 is at least one of a headphone, headset, earbud, earpiece, in-ear headphone, on-ear headphone, over-the-ear headphone, hang-from-the-ear headphone, earcup, headband, wearable computer, wearable mobile phone, or wearable keychain. In another example, the attachable element carrying the identifier is at least one of a decorative cover, sticker, headphone cover, headset cover, earcup cover, earbud cover, earpiece cover, keychain, keychain attachment, or figurine. In other embodiments, the attachable element includes a structural component such as a figurine or the like that couples to the peripheral device. In another example, the identifier 104 is at least one of a single unique identifier, one of a group of unique identifiers, or a non-unique identifier. In another example, ID number 106 is at least one of a single unique ID number, one of a group of unique ID numbers, or a non-unique ID number. In another example, the identifier 104 is at least one of an unencrypted identifier, encrypted identifier, hashed identifier, RFID (Radio Frequency Identification) tag, Electronic Product Code (EPC), electronic circuit, microchip, integrated circuit, antenna, substrate, active identifier, semi-passive identifier, passive identifier, or inductively coupled identifier. In another example, the reader 112 is configured to read the identifier 104 using a connection of at least one of wired, direct connection, near-field communications, Bluetooth, Internet, optical, inductively coupled, magnetic field induction, electromagnetic, capacitively coupled, or wireless.

On another example, the system 100 further comprises host 404 having host processor 406 executing host software 408, wherein taking the action in the wearable accepting device 110 includes communicating message 118 corresponding to ID number 106 over first communications link 402 from the wearable accepting device 110 to host processor 406 executing host software 408, and wherein host processor 406 is configured for receiving message 118 corresponding to ID number 106 and triggering an event in host 404 based on message 118 corresponding to ID number 106. In another example, first communications link 402 is at least one of wired, direct connection, near-field communications, Bluetooth, Internet, optical, inductively coupled, magnetic field induction, electromagnetic, capacitively coupled, or wireless. In another example, the system 100 triggers an event in host 404 based on message 118 corresponding to ID number 106 and includes verifying validity of ID number 106 from message 118. In a further example, the system 100 triggers an event in host 404 based on message 118 corresponding to ID number 106 and includes modifying host software 408 in host 404 correlated to ID number 106. In a further example, the system 100 includes host processor 406 executing host game 410, wherein modifying host software 408 in host 404 correlates to ID number 106 so that it changes characteristics of host game 410 in correlation to ID number 106. In a further example, the system 100 changes characteristics of host game 410 in at least one of changing characters in host game 410, changing characters’ characteristics in host game 410, granting powers, giving equipment, providing resources, providing capabilities, providing assets, providing weapons, improving speed, providing special movements, increasing skills, creating invisibility, enabling enhanced senses, enabling access to other player information, modifying interactions, modifying interactions with other players, and increasing physical capabilities.

In another example, the system further comprises game engine 504, wherein taking the action in the wearable accepting device 110 includes sending signal 618 corresponding to ID number 106 from the wearable accepting device 110 to game engine 504 over third communications link 602, and wherein game engine 504 is configured for receiving signal 618 corresponding to ID number 106 and causing an interrupt in game engine 504 based on information corresponding to ID number 106. In a further example, the system 100 wherein causing the interrupt in game engine 504 based on signal 618 corresponding to ID number 106 includes verifying validity of ID number 106 in game engine 504 based on signal 618 corresponding to ID number 106. In a further example, the system 100, wherein causing the interrupt in game engine 504 based on signal 618 corresponding to ID number 106 includes modifying game engine software 508 in game engine 504 in a manner that is correlated to ID number 106. In a further example, the system 100, wherein causing the interrupt in game engine 504 based on signal 618 corresponding to ID number 106 includes modifying game engine software 508 that changes characteristics of game engine game 510 in correlation to ID number 106. In a further example, the system 100, wherein changes characteristics of game engine game 510 is at least one of changing characters in game engine game 510, changing characters’ characteristics in game engine game 510, granting powers, giving equipment, providing resources, providing capabilities, providing assets, providing weapons, improving speed, providing special movements, increasing skills, creating invisibility, enabling enhanced senses, enabling access to other player information, modifying interactions, modifying interactions with other players, and increasing physical capabilities.

In another example, the system 100 further comprises network 718, wherein taking the action in the wearable accepting device 110 includes verifying validity of ID number 106 over fourth comms link 702 with messages 704 through network 718 and over seventh comms link 714 to game database 720, wherein game database 720, communicates back to the wearable accepting device 110 with responses 716 including at least one of verifying identifiers, returning info on actions, interactions, triggers, interrupts, and signals to the wearable accepting device 110. In a further example, the system 100, host 404 communicating over fifth comms link 706 with data 708 through network 718 includes verifying validity of ID number 106 through network 718 and over seventh comms link 714 to game database 720, wherein game database 720, communicates back to host 404 with responses 716 including at least one of verifying identifiers, returning info on actions, interactions, triggers, interrupts, and signals, modifying characteristics of host game 410, including modifying characteristics of host game 410 dynamically for specific time periods and durations. In a further example, the system 100 further includes game engine 504 communication over sixth comms link 710 with interrupts 712 through network 718 and includes verifying validity of ID number 106 through network 718 and over seventh comms link 714 to game database 720, wherein game database 720, communicates back to game engine 504 with responses 716 including at least one of verifying identifiers, returning info on actions, interactions, triggers, interrupts, and signals, modifying characteristics of game engine game 510, including modifying characteristics of game engine game 510 dynamically for specific time periods and durations.

According to examples of the present disclosure, an attachable element 102 comprises an attachable member 103 configured to attach to a headphone 111, the attachable member carrying an identifier 104. In a further example, the attachable element 102 is detachable from the headphone 111. In another example, in the attachable element 102 the identifier 104 is at least one of: affixed to, adhered to, attached to, embedded in, or embedded within, the attachable member 103. In another example, in the attachable element 102, the identifier 104 is at least one of a single unique identifier, one of a group of unique identifiers, or a non-unique identifier. In another example, in the attachable element 102 the identifier 104 is at least one of an unencrypted identifier, encrypted identifier, hashed identifier, RFID (Radio Frequency Identification) tag, Electronic Product Code (EPC), electronic circuit, microchip, integrated circuit, antenna, substrate, active identifier, semi-passive identifier, passive identifier, or inductively coupled identifier. In another example, in the attachable element 102, the attachable member 103 carrying the identifier 104 further carries at least one of a decoration, decal, emblem, design, label, sticker, sign, symbol, character, tag, marker, indicator, figure, figurine, statuette, ornamentation, embellishment, enhancement, adornment, pattern, advertisement, announcement, notice, information, movie, music, media figure, picture, image, photograph, logo, insignia, or 3D representation. In another example, in the attachable element 102, the attachable member 103 carrying the identifier 104 attaches to the headphone 111 by at least one of magnetic force, press-fitting into an indentation, screwing on, unscrewing off, adhering with adhesive substances, by fastening tabs, by fastening clips, or by electrostatic force. In another example, in the attachable element 102 the attachable member 103 carrying the identifier 104 attaches to an indentation 820 in an earcup 822, wherein the earcup has a cavity 824 on one side of the indentation 820, and wherein the attachable element 102 is removed by pressing the attachable member 103 into the cavity.

According to examples of the present disclosure, a headphone 111 comprises an external area of the headphone 111 configured for attaching an attachable element 102 carrying an identifier 104; and a reader 112 carried by the headphone 111, configured to read the identifier 104 carried by the attachable element 102 and determine ID number 106 of the identifier; and a wearable accepting device processor 114 carried by the headphone, the wearable accepting device processor configured for receiving ID number 106 from the reader 112 and taking an action in the headphone 111.

In a further example, the headphone 111 taking the action in the headphone 111 includes verifying validity of ID number 106. In a further example, the headphone 111 taking the action in the headphone 111 includes modifying wearable accepting device software 116 in the headphone 111 based on ID number 106. In a further example, the headphone 111 taking the action in the headphone 111 includes modifying acoustic parameters of the headphone 111 based on ID number 106. In a further example, the headphone 111 taking the action in the headphone 111 includes modifying frequency response of the headphone 111. In a further example, the headphone 111 taking the action in the headphone 111 includes sending messages to external devices over communications links and receiving responses from external devices over communications links causing taking a subsequent action in the headphone 111.

In another example, in the headphone 111 the attachable element 102 carrying the identifier 104 is detachable from the headphone 111. In another example, in the headphone 111 the reader 112 is affixed to, adhered to, attached to, embedded in, or embedded within, the headphone 111. In a further example, in the headphone 111, the reader 112 is configured to read the identifier 104 and the identifier 104 is at least one of an unencrypted identifier, encrypted identifier, hashed identifier, RFID (Radio Frequency Identification) tag, Electronic Product Code (EPC), electronic circuit, microchip, integrated circuit, antenna, substrate, active identifier, semi-passive identifier, passive identifier, or inductively coupled identifier. In a further example, in the headphone 111 the attachable element 102 carrying the identifier 104 attaches to an area of the headphone 111 by at least one of magnetic force, press-fitting into an indentation, screwing on, unscrewing off, adhesive substances, fastening tabs, fastening clips, or electrostatic force.

In another example, in the headphone 111, the reader 112 is configured to read the identifier 104 using a connection of at least one of wired, direct connection, near-field communications, Bluetooth, Internet, optical, inductively coupled, magnetic field induction, electromagnetic, capacitively coupled, or wireless. In another example, in the headphone 111 the communications links are at least one of wired, direct connection, near-field communications, Bluetooth, Internet, optical, inductively coupled, magnetic field induction, electromagnetic, capacitively coupled, or wireless. In a further example, in the headphone 111 an attachable element 102 carrying the identifier 104 attaches to an indentation 820 in the headphone 111, wherein the indentation 820 has a cavity 824 on one side of the indentation 820, and wherein the attachable element 102 is removed by pressing the attachable element 102 into the cavity 824.

According to examples of the present disclosure, a method 1100, comprises the steps of: attaching an attachable element 102 carrying an identifier 104 to a headphone 111; reading the identifier 104 by a reader 112 carried by the headphone 111; transferring ID number 106 of the identifier 104 from the reader 112 to a wearable accepting device processor 114 carried by the headphone 111; and taking an action in the headphone 111.

In further examples, in the method, taking the action in the headphone 111 optionally includes verifying validity of ID number 106; modifying wearable accepting device software 116 in the headphone 111 based on ID number 106; modifying frequency response of the headphone 111; communicating with external devices over communications links causing subsequent actions in the headphone 111; communicating with external devices over communications links causing actions in external devices, including receiving communications from the headphone 111, verifying ID number of the attachable element 102, modifying software in the external device, and receiving responses from external devices.

In further examples, in the method, taking the action in the headphone 111 optionally includes communicating over communications links with external devices which are games, including causing modifications of software in games based on ID number 106; and communicating over communications links with external devices which are games, including at least one of changing characters in games, changing characters’ characteristics in games, granting powers, giving equipment, providing resources, providing capabilities, providing assets, providing weapons, improving speed, providing special movements, increasing skills, creating invisibility, enabling enhanced senses, enabling access to other player information, modifying interactions, modifying interactions with other players, and increasing physical capabilities.

### BRIEF DESCRIPTION OF THE DRAWINGS

These and other technical features, aspects, examples, and advantages will become better understood with regard to the following description, appended claims, accompanying drawings, and abstract where:

FIG. 1 shows a block diagram of the system with attachable element and wearable accepting device, according to an embodiment of the present disclosure.

FIG. 2A shows a block diagram of the system with attachable element and headphone, according to an embodiment of the present disclosure.

FIG. 2B shows an isometric view of a headphone having a reader and an attachable element carrying an exemplary RFID identifier, according to an embodiment of the present disclosure.

FIG. 2C shows an isometric view of a headphone having a reader and an attachable element carrying an exemplary direct contact identifier, according to an embodiment of the present disclosure.

FIG. 3A shows an isometric view of a headphone having a reader and an attachable element 102 carrying an identifier where the attachable element is attachable and detachable, according to an embodiment of the present disclosure.

FIG. 3B shows an isometric view of an exemplary air bud headphone with an over the ear extension and an attachable element, according to an embodiment of the present disclosure.

FIG. 3C shows an isometric view of an exemplary air bud headphone with an over the ear extension having a reader and an attachable element with identifier that is attachable and detachable, according to an embodiment of the present disclosure.

FIG. 4 shows the block diagram of the system with attachable element and wearable accepting device as well as headphone connected to host over first communications link and message, according to an embodiment of the present disclosure.

FIG. 5 shows the block diagram of the system with attachable element and wearable accepting device as well as headphone connected to host over first communications link and message which is further connected to game engine over second communications link and information, according to an embodiment of the present disclosure.

FIG. 6 shows the block diagram of FIG. 5 in which the wearable accepting device as well as headphone are further directly connected to game engine over third communications link with signal, according to an embodiment of the present disclosure.

FIG. 7 shows the block diagram of network through which the wearable accepting device as well as headphone, host, game engine, and game database are all connected to network, according to an embodiment of the present disclosure.

FIG. 8A shows an isometric view of an attachable member with an RFID identifier, according to an embodiment of the present disclosure.

FIG. 8B shows an isometric view of an attachable member carrying an RFID identifier next to a headphone carrying an RFID reader, according to an embodiment of the present disclosure.

FIG. 8C shows an isometric view of an attachable member carrying a direct connection identifier, according to an embodiment of the present disclosure.

FIG. 8D shows an isometric view of an attachable member carrying a direct connection identifier next to a headphone carrying a direct connection reader, according to an embodiment of the present disclosure.

FIG. 9A shows an isometric view of a headphone with an earcup having an indentation in the earcup so that the attachable element with the attachable member can be inserted into the indentation, according to an embodiment of the present disclosure.

FIG. 9B shows an isometric view of an exemplary air bud headphone with an over the ear extension and an attachable element having an attachable member, according to an embodiment of the present disclosure.

FIG. 9C shows an isometric view of an exemplary air bud headphone with an over the ear extension, a reader, and an indentation where an attachable element with an identifier having an attachable member can be inserted into the indentation, according to an embodiment of the present disclosure.

FIG. 10A shows an isometric view of a headphone with an earcup having an indentation in the earcup so that the attachable member can be inserted into the indentation, according to an embodiment of the present disclosure.

FIG. 10B shows an isometric view of a headphone with an earcup having an indentation in the earcup and a cavity in the indentation so that the attachable member can be popped out of the indentation by pressing the attachable member into the cavity in the indentation of the earcup, according to an embodiment of the present disclosure.

FIG. 11 shows a method with steps of attaching, reading, transferring, and taking an action, according to an embodiment of the present disclosure.

FIG. 12 shows a method with further optional steps after taking the action, according to an embodiment of the present disclosure.

FIG. 13 shows a method with a further optional step after taking the action, according to an embodiment of the present disclosure.

FIG. 14 illustrates a computer system, according to an embodiment of the present disclosure.

FIG. 15 is a block diagram of a communication system, according to an embodiment of the present disclosure.

FIG. 16A is a flowchart illustrating an example method for identifier-based automatic communication according to an embodiment of the present disclosure.

FIG. 16B is a flowchart illustrating an example of an operation of the method for establishing identifier-based communication channel according to an embodiment of the present disclosure.

FIG. 17 is a block diagram of a communication system, according to an embodiment of the present disclosure.

FIG. 18 is a block diagram of an example of a hardware system suitable for implementing a peripheral device, according to embodiments of the present disclosure.

FIG. 19 is a block diagram of an identifier system, according to an embodiment of the present disclosure.

FIG. 20 is a block diagram of a grouping system, according to an embodiment of the present disclosure.

FIG. 21 is a block diagram of a network, according to an embodiment of the present disclosure.

FIG. 22 illustrates a computer system, according to an embodiment of the present disclosure.

FIG. 23 illustrates a process, according to an embodiment of the present disclosure.

FIG. 24 illustrates a computer system, according to an embodiment of the present disclosure.

FIG. 25 is a block diagram of a communication system, according to an embodiment of the present disclosure.

FIG. 26 illustrates a process, according to an embodiment of the present disclosure.

FIGS. 27-29 are block diagrams of communication systems, according to embodiments of the present disclosure.

### DETAILED DESCRIPTION

In the Summary above, in this Detailed Description, in the claims below, and in the accompanying drawings, reference is made to particular features (including method steps). It is to be understood that the disclosure in this specification includes any and all possible combinations of such particular features. For example, where a particular feature is disclosed in the context of a particular example, or a particular claim, that feature can also be used, to the extent possible, in combination with and/or in the context of other particular examples.

For this disclosure, the following definitions are at least the minimum definition, which may be expanded to suit the application. Here, “Wear” is at least defined as: to have on one's body, on one’s person, or a on part of one's body as clothing, decoration, protection, or for some other purpose. Here, headphones are worn on one’s head, which is part of the body. There are also many types of headphones. A non-exhaustive list of a headphone comprises a headset, earbud, earpiece, in-ear headphone, on-ear headphone, over-the-ear headphone, hang-from-the-ear headphone, earcup, gamer headphone, and Bluetooth or wireless headset, headband, all of which are “wearable.” “Wearable” is at least defined as: something that can be worn, capable of being worn, suitable for wearing, or an item that can be worn. So, “wearable” at least comprises a wearable computer, wearable mobile phone, wearable headphone, wearable keychain, wearable smartwatch, wearable fitness tracker, Virtual Reality headset, smart jewelry, web-enabled glasses, or other items which are capable of being worn or attached to the body or head.

“Attach” is at least defined as: fasten, join, affix, adhere, stick to, add, or connect, including in a permanent or temporary manner. “Attachable” is at least defined as: something that can be fastened to, added to, joined to, affixed to, adhere to, stuck to, added to, or connect to something else, temporarily or permanently. Examples of the attachable elements or attachable members are at least one of a decorative cover, sticker, headphone cover, headset cover, earcup cover, earbud cover, earpiece cover, keychain, keychain attachment, or figurine.

The term “identifier” is at least defined as: a thing that identifies something; a unique or non-unique label that identifies a person, object, or class of objects; or something that can be used to link someone or something to another thing or someone. Examples of identifiers include at least: letters, numbers, words, or symbols, that can be used to represent physical items, virtual items, locations, digital objects, or persons. In another example, the identifier is at least one of a single unique identifier, one of a group of unique identifiers, or a non-unique identifier. The term “ID number” is at least any form of textual, numeric, alphabetic, virtual, graphical, or physical number, character, words, symbols, or identity. In an example, an ID number is at least one of a single unique ID number, one of a group of unique ID numbers, or a non-unique ID number.

The term “accepting” is at least defined as: receiving, capable of receiving, consenting to receive, designed to receive or accept, able or willing to accept or receive something, or configured to receive, accept, or carry. Here, an example of an accepting device is at least: a device capable of accepting another device, a device capable of being attached to, configured to be attached to, designed to be attached to, or simply a device that can be attached to by something else. Here, an accepting device is a headphone or any other device that can accept or receive an item with an identifier, ID number, or identifying element.

Further, definitions, terms, and examples follow.

The term “comprises” and grammatical equivalents thereof such as “at least one of” or “includes at least one of” are used herein to mean that other components, ingredients, steps, etc. are optionally present. For example, an article "comprising" (or "which comprises") (or “includes at least one of”) components A, B, and C can consist of (i.e., contain only) components A, B, and C, or can contain not only components A, B, and C but also one or more other components. Where reference is made herein to a method comprising two or more defined steps, the defined steps can be carried out in any order or simultaneously, and the method can include one or more other steps which are carried out before any of the defined steps, between two of the defined steps, or after all the defined steps.

The term “at least” followed by a number is used herein to denote the start of a range beginning with that number (which is a range having an upper limit or no upper limit, depending on the variable being defined). For example, "at least l" means l or more than 1. The term "at most" followed by a number is used herein to denote the end of a range ending with that number (which is a range having 1 or 0 as its lower limit, or a range having no lower limit, depending upon the variable being defined). For example, "at most 4" means 4 or less than 4, and "at most 40%" means 40% or less than 40%. When, in this specification, a range is given as "(a first number) to (a second number)" or "(a first number)-(a second number)," this means a range whose lower limit is the first number and whose upper limit is the second number. For example, 25 to 100 mm means a range whose lower limit is 25 mm, and whose upper limit is 100 mm.

Advantages of wearable systems, attachable elements, attachable members, wearable accepting devices, headphones, and methods for modifying software and games described herein are numerous. As previously stated, advantages include using different identifiers attached to the wearable accepting device or headphone which enables modifications of the headphone acoustics, or modifications to a game, for example: changing characters in games, changing characters’ characteristics in games, granting powers to characters, giving equipment to characters, providing resources in games, providing capabilities, providing assets, providing weapons, improving speed, providing special movements, increasing skills, creating invisibility, enabling enhanced senses, enabling access to other player information, modifying interactions, modifying interactions with other players, changing game dynamics, and increasing physical capabilities. Additional advantages include that different identifiers can carry decorations, decals, emblems, designs, labels, stickers, signs, symbols, characters, tags, markers, indicators, figures, figurines, statuettes, ornamentations, embellishments, enhancements, adornments, patterns, advertisements, announcements, notices, information, movies, music, media figures, pictures, images, photographs, logos, insignia, sports teams logos, sports team players, musicians, game characters, or 3D representations of things like game characters.

A gamer or game player can therefore purchase a particular attachable element from a game manufacturer or other third parties and receive enhanced playing. An audiophile can purchase a particular attachable element for their headphones and receive specific equalization or other acoustic characteristics that enhance various types of music or other audio.

Thus, these attachable elements, wearable accepting devices, types of headphones, and methods for modifying software and games using wearable accepting devices provide unique and valuable ways to enhance and customize game play.

Present examples satisfy these and other needs and provide further related advantages. These and other examples are more fully understood upon review of this disclosure.

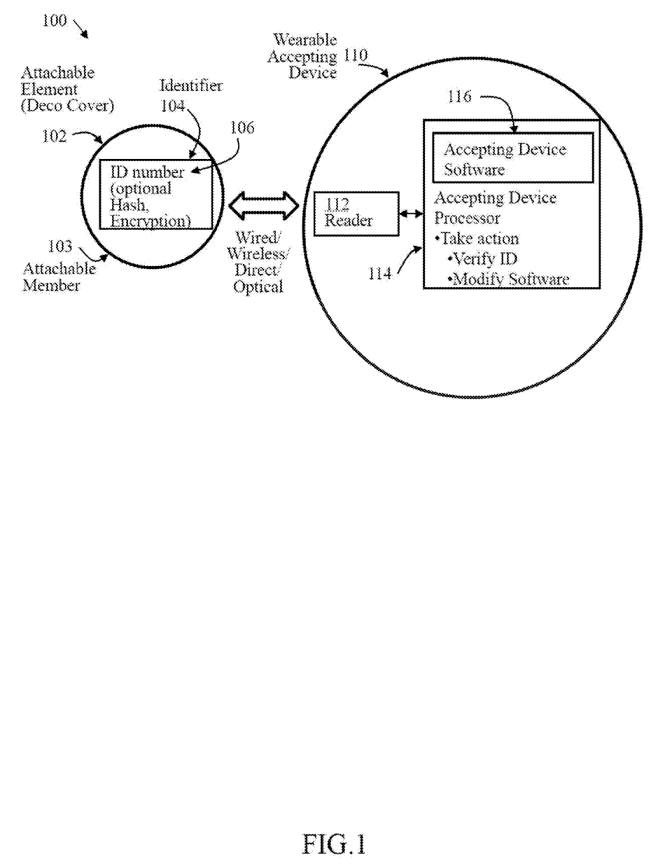

FIG. 1 shows a block diagram of the system 100 with an attachable element 102 also referred to as a decorative cover or deco cover, and a wearable accepting device 110, both of which may communicate with each other over a direct, wired, wireless or optical connection as shown by the two-way arrow between the devices in FIG. 1. Further, the attachable element 102 also referred to as a decorative cover or deco cover comprises an attachable member 103 and an identifier 104 which is affixed to, adhered to, attached to, glued on, stuck on, embedded in, embedded within, or is in some way carried by the attachable member 103 or the attachable element 102. Although the attachable element is shown and described throughout the present disclosure as a cover portion (e.g., decorative cover), the attachable element may include any structural component such as a figurine or the like that couples to the peripheral device, to be described in further detail below. Further, the identifier 104 includes at least one of an identification or ID number 106, ID (identifier) characters, ID (identification characteristics), or some form of representation or presentation which can be used to recognize the ID number 106 of the identifier 104, where the identifier 104 is in, on, attached to, or carried by the attachable member 103 or attachable element 102. Further, ID number 106 is comprised of at least one of an unencrypted identifier, an encrypted identifier, a hashed identifier, an RFID (Radio Frequency Identification) tag, an Electronic Product Code (EPC), electronic circuit, microchip, integrated circuit, antenna, substrate, active identifier, semi-passive identifier, passive identifier, direct connection identifier, or inductively coupled identifier. Further, ID number 106 is capable of being transmitted or read by a device designed to read or receive ID number 106 from the identifier 104 in a direct, wired, wireless or optical manner.

Advantages include being able to attach different identifiers to wearable accepting devices or headphones. FIG. 1 further shows the system 100 including a wearable accepting device 110. This wearable accepting device 110 carries externally or internally a transmitter, receiver, transceiver, direct connection, magnetic, optical, or other type of reader 112 configured to interact with, read, and determine ID number 106 from the identifier 104 carried by the attachable member 103 or the attachable element 102. The reader 112 reads ID number 106 when the attachable element is near the wearable accepting device 110, becomes attached to the wearable accepting device 110, or in any other way when the reader 112 is either internally or externally triggered to read ID number 106 from the identifier 104 carried by the attachable member 103 or the attachable element 102.

This disclosure includes processors, computer processors, and devices having processors such as in identifier 104, reader 112, wearable accepting device 110, headphone 111, wearable accepting device processor 114, host processor 406, game engine 504, and game database 720. These processors are not described in detail in the disclosure as they are well known to those skilled in the art, for example they may comprise a power source; various types of memory and memory at rest as is well known to those skilled in the art; various types of processing capability such as read, write, standard processing, graphical processing, artificial intelligence processing, and other types of processing as is well known to those skilled in the art; and various types of buses and connections in, to, and from the processor as is also well known to those skilled in the art. It is understood that these processors can be designed in many ways by those skilled in the art, so no further detailed description is necessary.

FIG. 1 further shows in system 100, the wearable accepting device 110 carrying, containing, transporting, or including externally or internally a wearable accepting device processor 114 which executes wearable accepting device software 116. When the reader 112 reads, receives, and determines ID number 106 from the identifier 104 carried by the attachable member 103 or the attachable element 102, the reader 112 is configured to pass or communicate ID number 106 to the wearable accepting device processor 114 and wearable accepting device software 116. The wearable accepting device processor 114 and wearable accepting device software 116 are configured for receiving ID number 106 from the reader 112 and taking an action in the wearable accepting device 110.

FIG. 1 further shows in system 100 that taking the action in the wearable accepting device processor 114 and wearable accepting device software 116 comprises optionally verifying validity of ID number 106, optionally modifying the wearable accepting device software 116 in the wearable accepting device 110, and optionally transmitting information from the reader 112 to the identifier 104 to change information in the identifier 104, including modifying ID number 106, or other useful information.

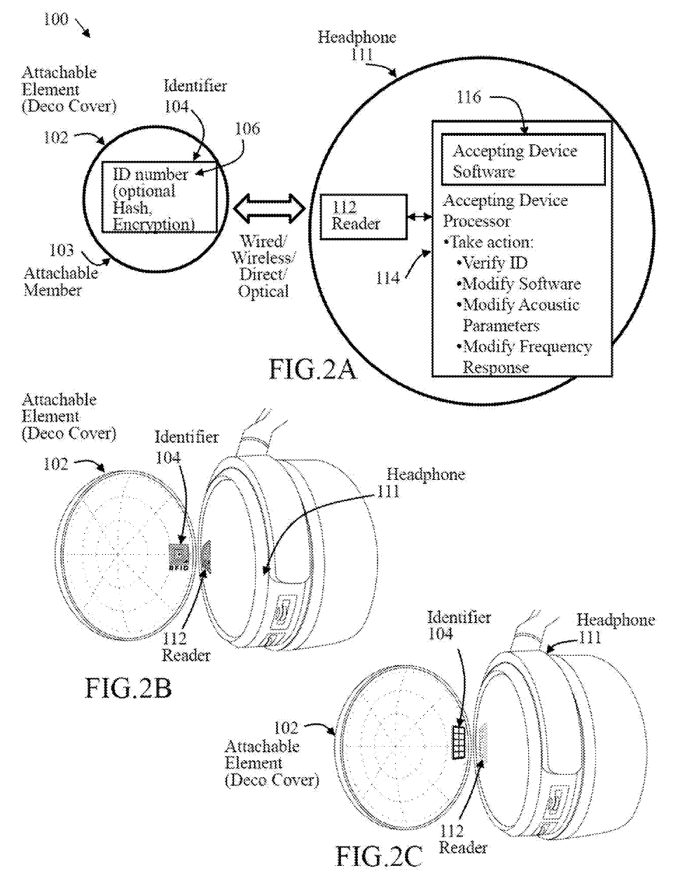

FIG. 2A shows a block diagram of the system 100 as in FIG. 1, where the wearable accepting device 110 is a headphone 111 in FIG. 2A and other figures.

In this disclosure the headphone 111 is construed as interchangeable with the wearable accepting device 110, since the headphone 111 is wearable on the head as the wearable accepting device 110. In this disclosure the headphone 111 may also be a subset of the wearable accepting device 110. Therefore, in this disclosure the wearable accepting device 110 is also described as having the corresponding headphone 111, correlative headphone 111, or correlated headphone 111.

In FIG. 2A, the system 100 works in a similar way as previously described above. In FIG. 2A, the attachable element 102, also referred to as a decorative cover or deco cover, with attachable member 103, identifier 104, and ID number 106 are now an attachable element that is attached to the headphone 111. In FIG. 2A, the headphone 111 carries the same reader 112 with the same capabilities as above. Here, the headphone 111 is still carrying, containing, transporting, or including externally or internally a wearable accepting device processor 114 which executes wearable accepting device software 116. When the reader 112 reads, receives, and determines ID number 106 from the identifier 104 carried by the attachable member 103 or the attachable element 102, the reader 112 in the headphone 111 is configured to pass or communicate ID number 106 to the wearable accepting device processor 114 and wearable accepting device software 116 in the headphone 111. The wearable accepting device processor 114 and wearable accepting device software 116 in the headphone 111 are configured to receive ID number 106 from the reader 112 and take an action in the headphone 111.

FIG. 2A further shows in system 100 that taking the action in the wearable accepting device processor 114 and wearable accepting device software 116 of the headphone 111 comprises optionally verifying validity of ID number 106, optionally modifying the wearable accepting device software 116 in the headphone 111, optionally modifying acoustic parameters in the headphone 111, optionally modifying frequency response in the headphone, or optionally transmitting information from the reader 112 in the headphone 111 to the identifier 104 to change information in the identifier 104, including modifying ID number 106, or other useful information.

Note that in all of the wearable accepting devices 110 and headphone 111 examples in this disclosure, the wearable accepting device 110 and headphone 111 comprise many different types. These types comprise at least one of a headphone, headset, earbud, earpiece, in-ear headphone, on-ear headphone, over-the-ear headphone, hang-from-the-ear headphone, earcup, headband, wearable computer, wearable mobile phone, or wearable keychain.

Further, in system 100, the identifier 104 is at least one of a single unique identifier, one of a group of unique identifiers, or a non-unique identifier. Further, in system 100, ID number 106 is at least one of a single unique identifier, one of a group of unique identifiers, or a non-unique identifier.

Although the disclosure describes a single attachable element 102 to be attached to the wearable accepting device 110 or headphone 111, it is understood that the wearable accepting device 110 or headphone 111 is optionally designed to accommodate or accept multiple attachable elements 102.

Further, although the disclosure describes a single identifier 104 and a single ID number 106 in the attachable element 102, it is to be understood that attachable element 102 may accommodate or carry multiple identifiers 104 and multiple ID numbers 106. Thus, multiple customizations are provided at the same time over multiple attachable elements 102, multiple identifiers 104, and multiple ID numbers 106.

In one example, FIG. 2B shows an isometric view of a headphone 111 having an reader 112 which is an RFID reader. FIG. 2B further shows an attachable element 102 carrying an identifier 104, which in this case is an exemplary RFID identifier. Here, the attachable element 102, also referred to as a decorative cover or deco cover, attaches to an area of the headphone 111 by at least one of magnetic force, press-fitting into an indentation, screwing on, unscrewing off, adhesive substances, fastening tabs, fastening clips, electrostatic force, or any other attachment method. The attachable element 102, also referred to as a decorative cover or deco cover, is also configured to detach from the headphone 111.

In another example, FIG. 2C shows an isometric view of a headphone 111 having an reader 112 which is an exemplary direct contact reader. FIG. 2C further shows an attachable element 102 carrying an identifier 104, which in this case is an exemplary direct contact identifier. Here, the attachable element 102 attaches to an area of the headphone 111 by at least one of magnetic force, press-fitting into an indentation, screwing on, unscrewing off, adhesive substances, fastening tabs, fastening clips, electrostatic force, or any other attachment method. The attachable element 102 is also configured to detach from the headphone 111.

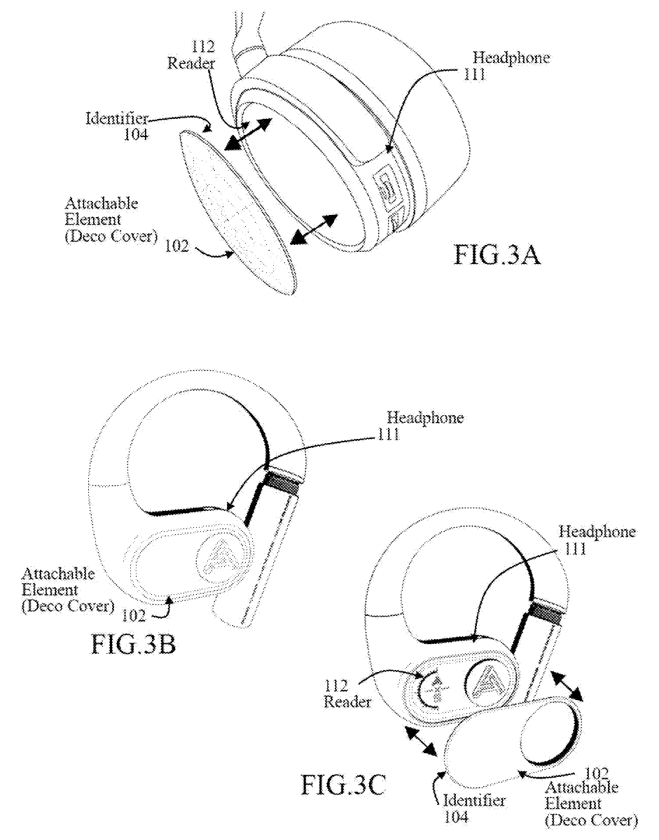

FIG. 3A shows an isometric view of a headphone 111 having a reader 112 and an attachable element 102 carrying an identifier 104 where the attachable element 102 is both attachable and detachable.

In FIGS. 3A, FIG. 3B, and FIG. 3C, the attachable element 102 carrying the identifier 104 includes at least one of a plain cover, a decorative cover, a partial headset cover, an earcup cover, an earbud cover, an earpiece cover, a keychain, a keychain attachment, a decoration, decal, emblem, design, label, sticker, sign, symbol, character, tag, marker, indicator, figure, figurine, statuette, ornamentation, embellishment, enhancement, adornment, pattern, advertisement, announcement, notice, information, movie, music, media figure, picture, image, photograph, logo, insignia, sports teams logos, sports team players, musicians, game characters, or 3D representation.

FIG. 3B shows an isometric view of an exemplary air bud headphone 111 with an over the ear extension and an attachable element 102. This is an example of an attachable element 102 on a wearable accepting device 110 or headphone 111. This exemplary attachable element may also include any of the decorations as described above.

FIG. 3C shows an isometric view of an exemplary air bud headphone 111, in-ear headphone 111, or hanging-on-the-ear headphone with an over the ear extension having a reader 112 and an attachable element 102 with identifier 104 that is attachable and detachable.

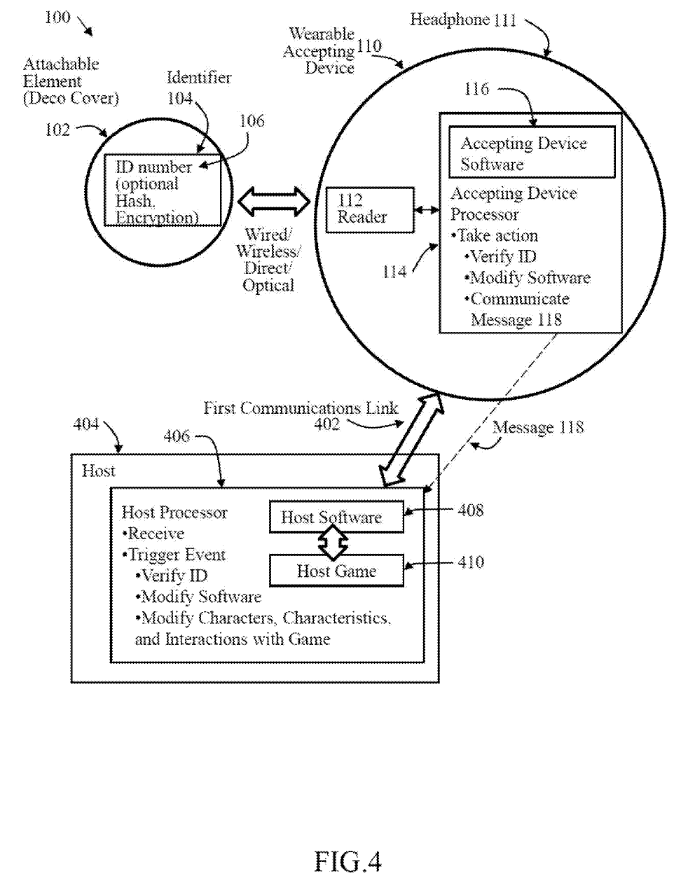

FIG. 4 shows the block diagram of the system 100 shown in FIG. 1 with attachable element 102, identifier 104, ID number 106. FIG. 4 also shows the block diagram of the system 100 shown in FIG. 1 with wearable accepting device 110 as well as correlative headphone 111 carrying reader 112 which communications with identifier 104 carried by attachable element 102 to retrieve ID number 106. As before, wearable accepting device 110 as well as correlative headphone 111 is also carrying, containing, transporting, or including externally or internally a wearable accepting device processor 114 which executes wearable accepting device software 116. When the reader 112 reads, receives, and determines ID number 106 from the identifier 104 carried by the attachable member 103 or the attachable element 102, the reader 112 is configured to pass or communicate ID number 106 to the wearable accepting device processor 114 and wearable accepting device software 116. The wearable accepting device processor 114 and wearable accepting device software 116 are configured to receive ID number 106 from the reader 112 and take an action in the wearable accepting device 110 or correlative headphone 111.

In FIG. 4, taking the action in the wearable device 110 and headphone 111 includes the previous taking the action as described above. Further, taking the action in the wearable accepting device 110 or correlative headphone 111 in FIG. 4 also comprises connecting to host 404 over first communications link 402 with message 118. Here, first communications link 402 is at least one of wired, direct connection, near-field communications, Bluetooth, Internet, optical, inductively coupled, magnetic field induction, electromagnetic, capacitively coupled, or wireless. Several examples of hosts on the market today comprise commercial game boxes such as PC Consoles, Sony PlayStation, Xbox, and Nintendo.

In FIG. 4, host 404 comprises at least one of host processor 406 executing host software 408 and executing host game 410. Here, taking the action in the wearable accepting device 110 includes communicating message 118 corresponding to ID number 106 over first communications link 402 from the wearable accepting device 110 to host processor 406 executing host software 408, and wherein host processor 406 is configured for receiving message 118 corresponding to ID number 106 and triggering an event in host 404 based on message 118 corresponding to ID number 106.

Further, in FIG. 4, triggering the event in host 404 based on message 118 corresponding to ID number 106 includes verifying validity of ID number 106 from message 118. Further, triggering the event in host 404 based on message 118 corresponding to ID number 106 includes modifying host software 408 in host 404 correlated to ID number 106. Further, in FIG. 4, host processor 406 is executing host game 410 wherein modifying host software 408 in host 404 correlated to ID number 106 changes characteristics of host game 410 in correlation to ID number 106.

Further in FIG. 4, changes characteristics of host game 410 is at least one of changing characters in host game 410, changing characters’ characteristics in host game 410, granting powers, giving equipment, providing resources, providing capabilities, providing assets, providing weapons, improving speed, providing special movements, increasing skills, creating invisibility, enabling enhanced senses, enabling access to other player information, modifying interactions, modifying interactions with other players, and increasing physical capabilities.

Finally, in FIG. 4, triggering the event in host 404 based on message 118 corresponding to ID number 106 includes sending further messages over first communications link 402 back to wearable accepting device 110 and the corresponding headphone 111 for further processing, including communicating to identifier 104.

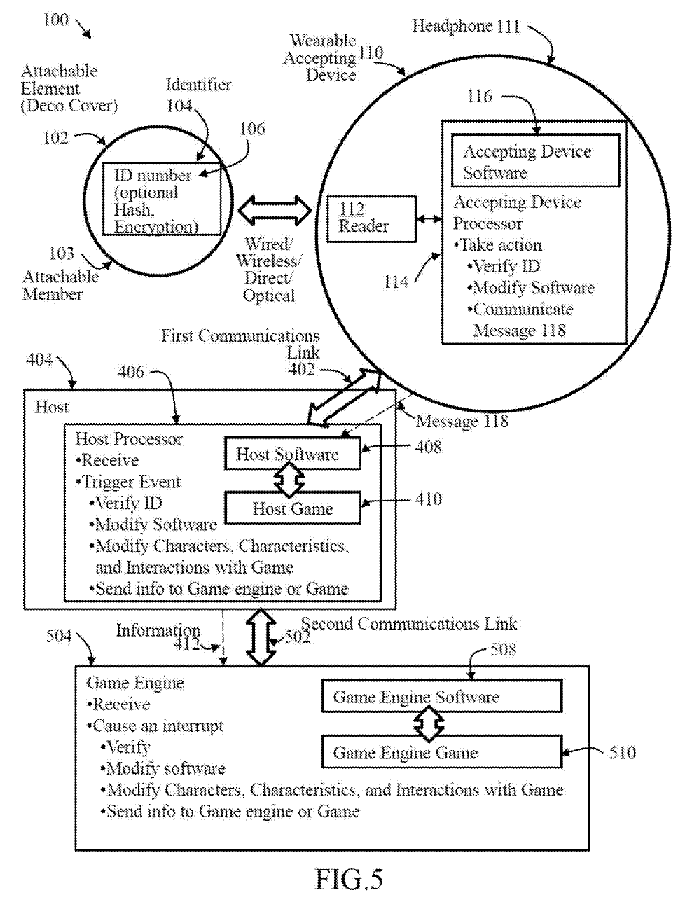

FIG. 5 shows the block diagram of system 100 as shown in FIGS. 1, FIG. 2A, and FIG. 4, with game engine 504 being communicated with by host 404 over second communications link 502 with information 412. Here, triggering the event in host 404 based on message 118 corresponding to ID number 106 includes sending information 412 corresponding to ID number 106 from host 404 to game engine 504 over second communications link 502. Further, game engine 504 is configured for receiving the information 412 corresponding to ID number 106 and causing the interrupt in game engine 504 based on information corresponding to ID number 106. Several examples of game engines on the market today comprise PC Consoles, Sony PlayStation, Xbox, and Nintendo.

In FIG. 4, causing an interrupt in game engine 504 based on information 412 corresponding to ID number 106 comprises verifying validity of ID number 106 in game engine 504 based on information 412 corresponding to ID number 106. Further, causing the interrupt in game engine 504 based on information 412 corresponding to ID number 106 comprises modifying game engine software 508 in game engine 504 in a manner that is correlated to ID number 106, and modifying game engine software 508 that changes characteristics of game engine game 510 in correlation to ID number 106. Further, changes characteristics of game engine game 510 is at least one of changing characters in game engine game 510, changing characters’ characteristics in game engine game 510, granting powers, giving equipment, providing resources, providing capabilities, providing assets, providing weapons, improving speed, providing special movements, increasing skills, creating invisibility, enabling enhanced senses, enabling access to other player information, modifying interactions, modifying interactions with other players, and increasing physical capabilities.

Finally, in FIG. 5, causing the interrupt in game engine 504 based on information 412 corresponding to ID number 106 comprises sending information over second communications link 502 back to host 404 for further processing, and back to wearable accepting device 110 and the corresponding headphone 111 for further processing, including communicating to identifier 104.

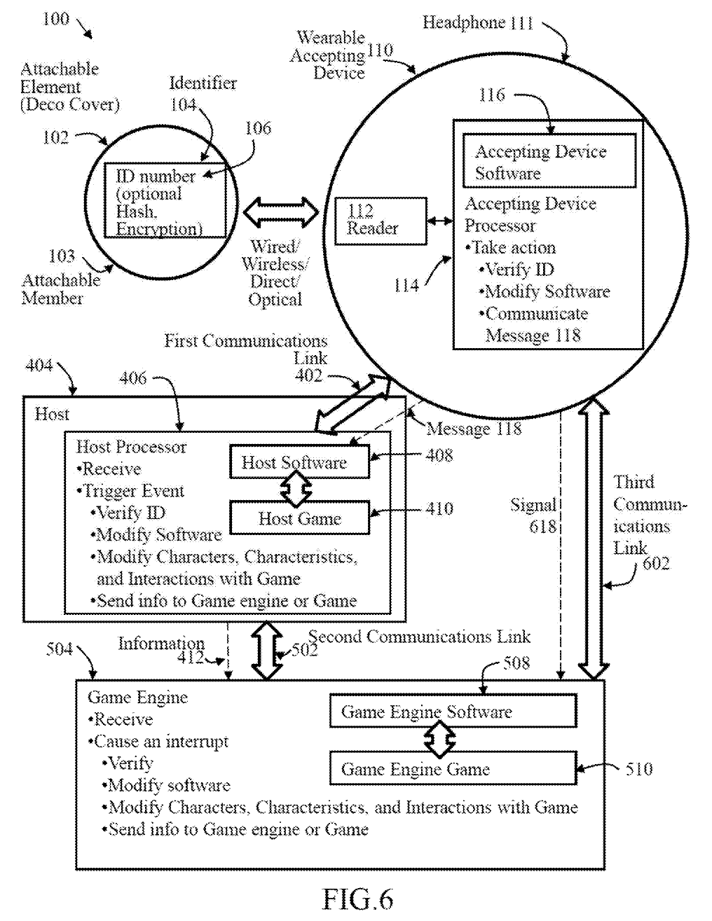

FIG. 6 shows system 100 including the block diagram of FIG. 5 in which the wearable accepting device 110 as well as headphone 111 are now further directly or indirectly connected to game engine 504 over third communications link 602 with signal 618. Here, taking the action in the wearable accepting device 110 or headphone 111 includes sending signal 618 corresponding to ID number 106 from the wearable accepting device 110 or headphone 111 to game engine 504 over third communications link 602, and wherein game engine 504 is configured for receiving signal 618 corresponding to ID number 106 and causing the interrupt in game engine 504 based on information corresponding to ID number 106.

In FIG. 6, causing the interrupt in game engine 504 based on signal 618 corresponding to ID number 106 includes verifying validity of ID number 106 in game engine 504 based on signal 618 corresponding to ID number 106.

Further in FIG. 6, causing the interrupt in game engine 504 based on signal 618 corresponding to ID number 106 comprises modifying game engine software 508 in game engine 504 in a manner that is correlated to ID number 106, modifying game engine software 508 that changes characteristics of game engine game 510 in correlation to ID number 106. Further in FIG. 6, changes characteristics of game engine game 510 is at least one of changing characters in game engine game 510, changing characters’ characteristics in game engine game 510, granting powers, giving equipment, providing resources, providing capabilities, providing assets, providing weapons, improving speed, providing special movements, increasing skills, creating invisibility, enabling enhanced senses, enabling access to other player information, modifying interactions, modifying interactions with other players, changing game dynamics, and increasing physical capabilities in game engine 504 or game engine game 510.

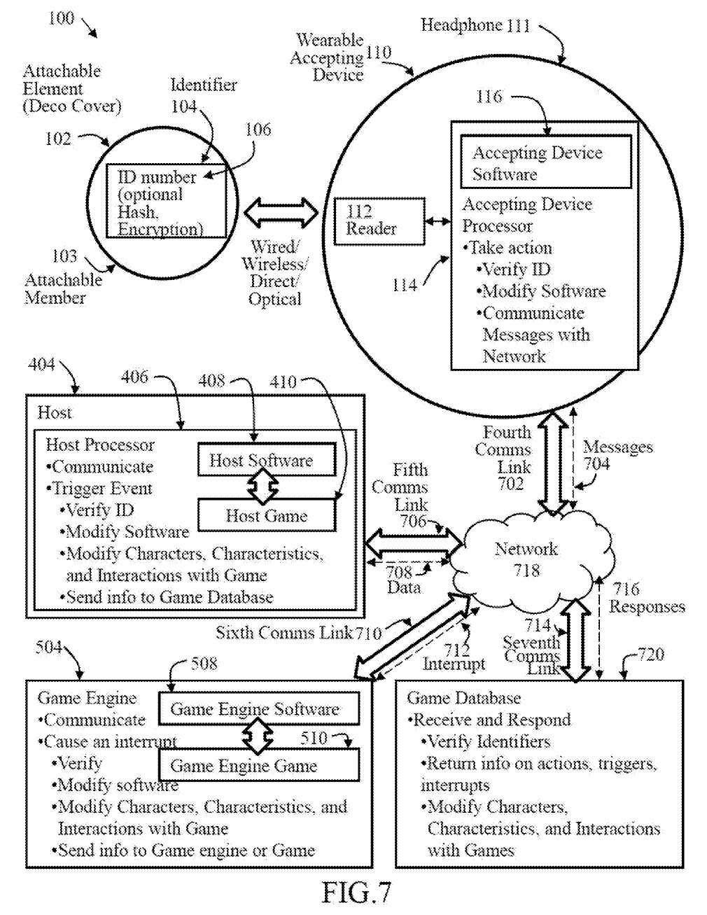

FIG. 7 shows the block diagram of network 718 through which the wearable accepting device 110 or corresponding headphone 111, host 404, game engine 504, and game database 720 are all connected through network 718. In FIG. 7, any one of the communication devices comprising attachable element 102, wearable accepting device 110 and corresponding headphone 111, host 404, game engine 504, and game database 720 communicates with any of the other communication devices comprising attachable element 102, wearable accepting device 110 and corresponding headphone 111, host 404, game engine 504, and game database 720 through network 718.

In FIG. 7, taking the action in the wearable accepting device 110 or headphone 111 comprises verifying validity of ID number 106 over fourth comms link 702 with messages 704 through network 718 and over seventh comms link 714 to game database 720, wherein game database 720, is configured to receive and respond to communications back to the wearable accepting device 110 with responses 716 including at least one of verifying identifiers, returning info on actions, interactions, triggers, interrupts, and signals to the wearable accepting device 110 and modifying characters, characteristics, and interactions with games in game database 720. Examples of game databases include commercial servers which provide games over a network.

In FIG. 7, taking the action in the wearable accepting device 110 or headphone 111 includes sending messages to external devices over communications links and receiving responses from external devices over communications links causing taking a subsequent action in the wearable accepting device 110 or headphone 111. In this disclosure external devices comprise host 404, game engine 504, and game database 720. In FIG. 7, taking the action in the wearable accepting device 110 or headphone 111 includes communicating with external devices over communications links causing actions in external devices, including receiving communications from the headphone 111, verifying validity of the ID number 106 of the attachable element 102, modifying software in the external device, and receiving responses from external devices. In FIG. 7, taking the action in the wearable accepting device 110 or headphone 111 includes communicating over communications links with external devices which are games, including causing modifications of software in games based on the ID number 106.

In FIG. 7, taking the action in the wearable accepting device 110 or headphone 111 comprises verifying validity of ID number 106 over fourth comms link 702 with messages 704 through network 718 to host 404 by communicating over fifth comms link 706 with data 708 through network 718 and responding back from host 404 to any other communications device connected to network 718 including attachable element 102, wearable accepting device 110 and corresponding headphone 111, game engine 504, and game database 720. Responses comprise at least one of verifying identifiers, returning info on actions, interactions, triggers, interrupts, and signals to the wearable accepting device 110 and modifying characters, characteristics, and interactions with games attached to network 718, including modifying characteristics of games dynamically for specific time periods and durations.

In FIG. 7, taking the action in the headphone 111 includes communicating over communications links with external devices which are games, including at least one of changing characters in games, changing characters’ characteristics in games, granting special powers, giving special equipment, providing more resources, providing more capabilities, providing more assets, providing more weapons, improving speed, providing special movements, increasing skills, creating invisibility, enabling more acute senses, enabling access to other player information, modifying interactions with games, modifying interactions with other players, and increasing physical capabilities.

In FIG. 7, taking the action in the wearable accepting device 110 or headphone 111 comprises verifying validity of ID number 106 over fourth comms link 702 with messages 704 through network 718 to game engine 504 by communicating over sixth comms link 710 with interrupts 712 through network 718 and responding back from game engine 504 to any other communications device connected to network 718 including attachable element 102, wearable accepting device 110 and corresponding headphone 111, host 404, and game database 720. Responses comprise at least one of verifying identifiers, returning info on actions, interactions, triggers, interrupts, and signals to the wearable accepting device 110 and modifying characters, characteristics, and interactions with games attached to network 718, including modifying characteristics of games dynamically for specific time periods and durations through network 718.

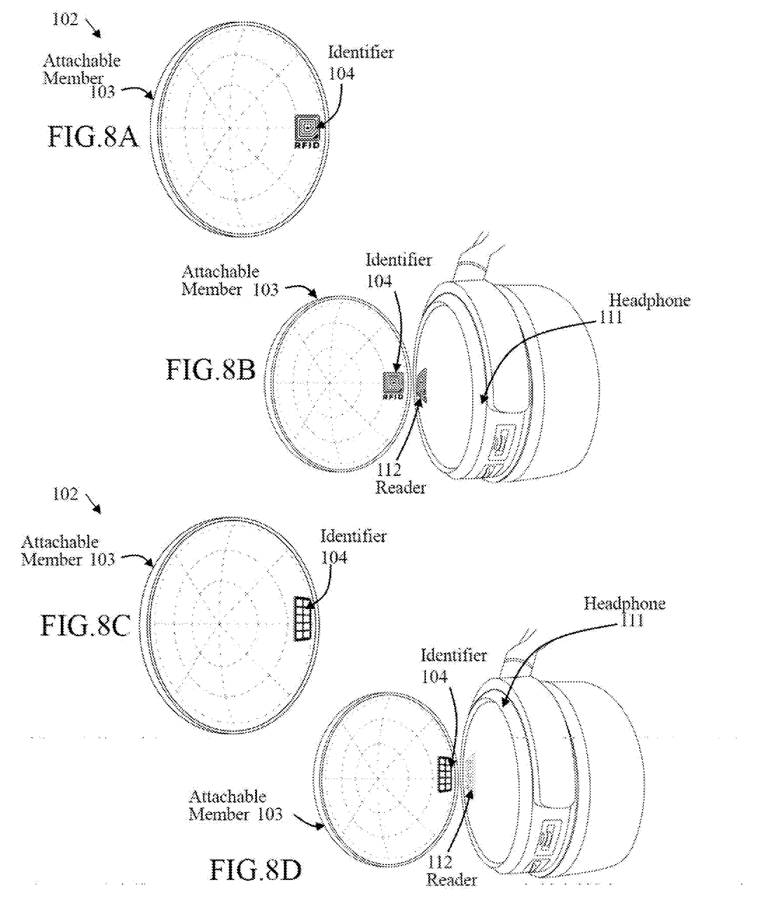

In FIGS. 8A, 8B, 8C, and 8D, attachable elements 102 and attachable members 103 carry identifier 104. In FIGS. 8A, 8B, 8C, and 8D, the identifier 104 is at least one of: affixed to, adhered to, attached to, embedded in, or embedded within, the attachable member 103. In FIGS. 8A, 8B, 8C, and 8D, the identifier 104 is at least one of a single unique identifier, one of a group of unique identifiers, or a non-unique identifier. In FIGS. 8A, 8B, 8C, and 8D, the identifier 104 comprises an unencrypted identifier, encrypted identifier, hashed identifier, RFID (Radio Frequency Identification) tag, direct connect identifier, Electronic Product Code (EPC), electronic circuit, microchip, integrated circuit, antenna, substrate, active identifier, semi-passive identifier, passive identifier, or inductively coupled identifier.

FIG. 8A shows an attachable element 102 with an isometric view of attachable member 103 with an RFID identifier 104.

FIG. 8B shows a headphone 111 with an isometric view of an attachable member 103 carrying an RFID identifier 104 next to the headphone 111 carrying an RFID reader 112.

FIG. 8C shows an attachable element 102 with an isometric view of an attachable member 103 carrying a direct connection identifier 104.

FIG. 8D shows a headphone 111 with an isometric view of an attachable member 103 carrying a direct connection identifier 104 next to the headphone 111 carrying a direct connection reader 112 which comprises physical, mechanical, magnetic, or electrical contacts.

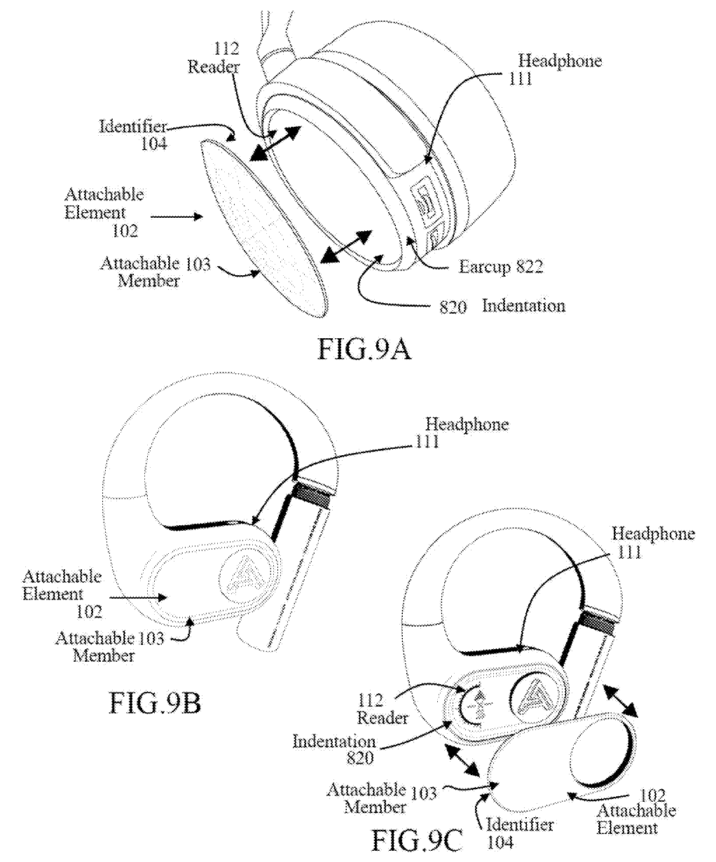

FIG. 9A shows an isometric view of a headphone 111 carrying a reader 112 with an earcup 822 having an indentation 820 in the earcup 822 so that the attachable element 102 with the attachable member 103 carrying the identifier 104 can be inserted into the indentation 820 and removed from the indentation 820. Further, but not shown in FIG. 9A, is that the attachable member 103 carrying the identifier 104 further carries at least one of a decoration, decal, emblem, design, label, sticker, sign, symbol, character, tag, marker, indicator, figure, figurine, statuette, ornamentation, embellishment, enhancement, adornment, pattern, advertisement, announcement, notice, information, movie, music, media figure, picture, image, photograph, logo, insignia, sports teams logos, sports team players, musicians, game characters, or 3D representation. Further, in FIG. 9A, the attachable element 102 and attachable member 103 carrying the identifier 104 attaches to the headphone 111 by at least one of magnetic force, mechanical force, press-fitting into an indentation, screwing in, unscrewing out, screwing on, unscrewing off, adhesive substances, fastening tabs, fastening clips, or electrostatic force.

FIG. 9B shows an isometric view of an exemplary air bud headphone 111 with examples of in-ear, over-the-ear, or hang-from-the-ear headphones and attachable element 102 having an attachable member 103.

FIG. 9C shows an isometric view of an exemplary air bud headphone 111 with in-ear, over-the-ear, or hang-from-the-ear headphone style, a reader 112, and an indentation 820 where an attachable element 102 having an attachable member 103 carrying an identifier 104 can be inserted into the indentation 820 or released from the indentation 820. Further, but not shown in FIG. 9C, is that the attachable member 103 carrying the identifier 104 further carries at least one of a decoration, decal, emblem, design, label, sticker, sign, symbol, character, tag, marker, indicator, figure, figurine, statuette, ornamentation, embellishment, enhancement, adornment, pattern, advertisement, announcement, notice, information, movie, music, media figure, picture, image, photograph, logo, insignia, sports teams logos, sports team players, musicians, game characters, or 3D representation. Further, in FIG. 9C, the attachable element 102 and attachable member 103 carrying the identifier 104 attaches to the headphone 111 by at least one of magnetic force, mechanical force, press-fitting into an indentation, screwing in, unscrewing out, screwing on, unscrewing off, adhesive substances, fastening tabs, fastening clips, or electrostatic force.

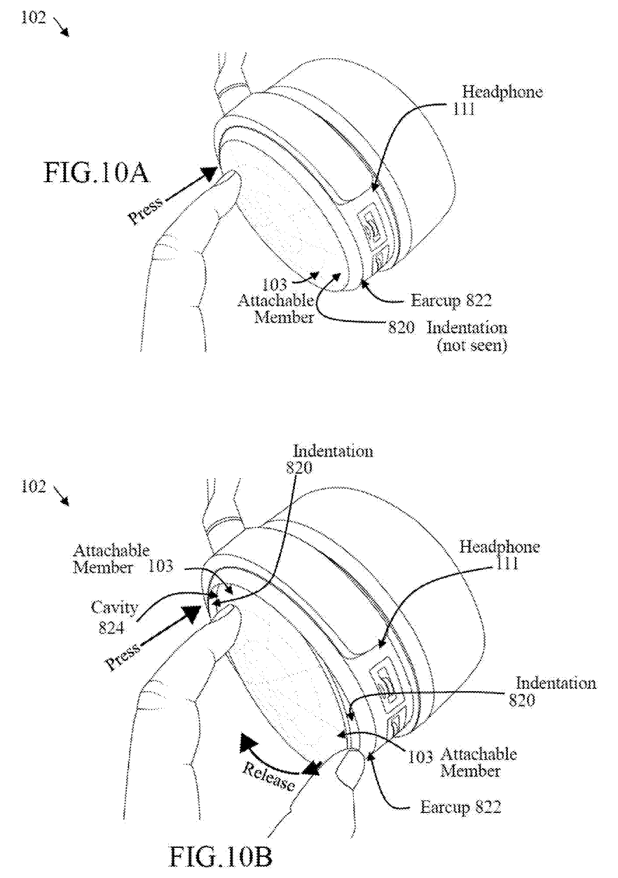

FIG. 10A shows an isometric view of a headphone 111 with an earcup 822 having an indentation 820 (not seen) in the earcup so that the attachable member 103 can be inserted into the indentation 820. FIG. 10A shows a finger pressing the attachable member 103 into the indentation in the earcup so that the attachable member 103 fits snugly in the indentation. This snug fit is further enhanced by at least one of magnetic force, mechanical force, press-fitting into an indentation, adhesive substances, fastening tabs, fastening clips, or electrostatic force.

FIG. 10B shows an isometric view of the same headphone 111 as FIG. 10A with an earcup 822 having an indentation 820 in the earcup 822 and a cavity 824 (not seen) further in the indentation 820 so that the attachable member 103 can be popped out or released out of the indentation by pressing the attachable member 103 into the cavity 824 in the indentation 820 of the earcup 822. FIG. 10B shows a finger pressing the attachable member 103 into the cavity 824 in the indentation 820 of the earcup 822 which causes the opposite edge of the attachable member 103 from the cavity to release itself from the indentation in the earcup on that edge of the attachable member 103. The attachable member 103 is then easy to remove.

Further, but not shown in FIG. 10B, is that the attachable member 103 carrying the identifier 104 may carry at least one of a decoration, decal, emblem, design, label, sticker, sign, symbol, character, tag, marker, indicator, figure, figurine, statuette, ornamentation, embellishment, enhancement, adornment, pattern, advertisement, announcement, notice, information, movie, music, media figure, picture, image, photograph, logo, insignia, sports teams logos, sports team players, musicians, game characters, or 3D representation. Further, in FIG. 10B, the attachable element 102 and attachable member 103 carrying the identifier 104 may attach to the headphone 111 by at least one of magnetic force, mechanical force, press-fitting into an indentation, adhesive substances, fastening tabs, fastening clips, or electrostatic force.

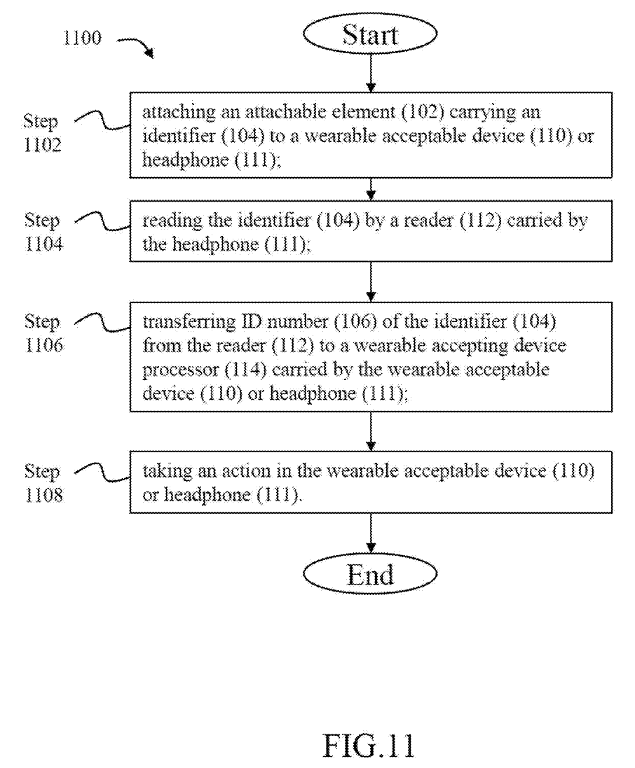

FIG. 11 is a flowchart of a process or method 1100 in accordance with examples of the disclosure. The process or method is implemented in the system 100 shown in FIGS. 1 and FIG. 2A comprising the attachable element 102, attachable member 103, identifier 104, ID number 106, wearable accepting device 110 or correlative headphone 111, reader 112, wearable accepting device processor 114, wearable accepting device software 116, and wired, wireless, direct contact, or optical communications between the attachable element 102 and the wearable acceptable device 110 or corresponding headphone 111.

In FIG. 11, the process or method 1100 starts with the first step 1102, of attaching an attachable element 102 carrying an identifier 104 to a headphone 111. The process or method 1100 continues with the next step 1104 of reading the identifier 104 by a reader 112 carried by the headphone 111. The process or method 1100 continues with the third step 1106 of transferring ID number 106 of the identifier 104 from the reader 112 to a wearable accepting device processor 114 carried by the wearable acceptable device 110 or headphone 111. The process or method 1100 continues with the last step 1108 of taking an action in the wearable acceptable device 110 or headphone 111.

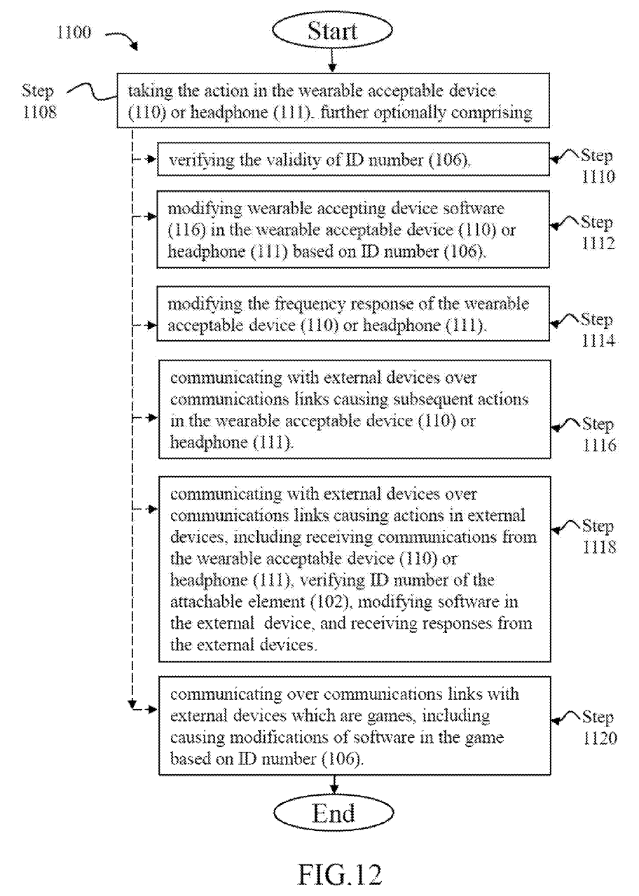

FIG. 12 is a flowchart of a process or method 1100 in accordance with examples of the disclosure. The process or method is implemented in the system 100 shown in FIGS. 1 and FIG. 2A comprising the attachable element 102, attachable member 103, identifier 104, ID number 106, wearable accepting device 110 or correlative headphone 111, reader 112, wearable accepting device processor 114, wearable accepting device software 116, and wired, wireless, direct contact, or optical communications between the attachable element 102 and the wearable acceptable device 110 or corresponding headphone 111. The process or method 1100 is further implemented in the system 100 shown in FIGS. 1, FIG. 2A, FIG. 4, FIG. 5, FIG. 6, and FIG. 7 which show communications from the wearable accepting device 110 or corresponding headphone 111 with other devices such as host 404, game engine 504, and game database 720, over various communications links and network 718.

In FIG. 12, the process or method 1100 starts with the first step, which is the last step 1108 of FIG. 11, that of taking the action in the wearable acceptable device 110 or headphone 111, and further optionally comprising steps that could be implemented following step 1108. Further following step 1108, the process or method 1100 continues optionally comprising the next step 1110 of verifying validity of ID number 106. Further following step 1108, the process or method 1100 continues optionally comprising the next step 1112 of modifying wearable accepting device software 116 in the wearable acceptable device 110 or headphone 111 based on ID number 106. Further following step 1108, the process or method 1100 continues optionally comprising the next step 1114 of modifying frequency response of the wearable acceptable device 110 or headphone 111.

In FIG. 12, further following step 1108, the process or method 1100 continues optionally comprising the next step 1116 of communicating with external devices over communications links causing subsequent actions in the wearable acceptable device 110 or headphone 111. Here and elsewhere in this disclosure, external device and external devices comprise host 404, game engine 504, and game database 720. Further following step 1108, the process or method 1100 continues optionally comprising the next step 1118 of communicating with external devices over communications links causing actions in external devices, including receiving communications from the wearable acceptable device 110 or headphone 111, verifying ID number of the attachable element 102, modifying software in the external device, and receiving responses from external devices. Further following step 1108, the process or method 1100 continues optionally comprising the next step 1120 of communicating over communications links with external devices which are games, including causing modifications of software in games based on ID number 106.

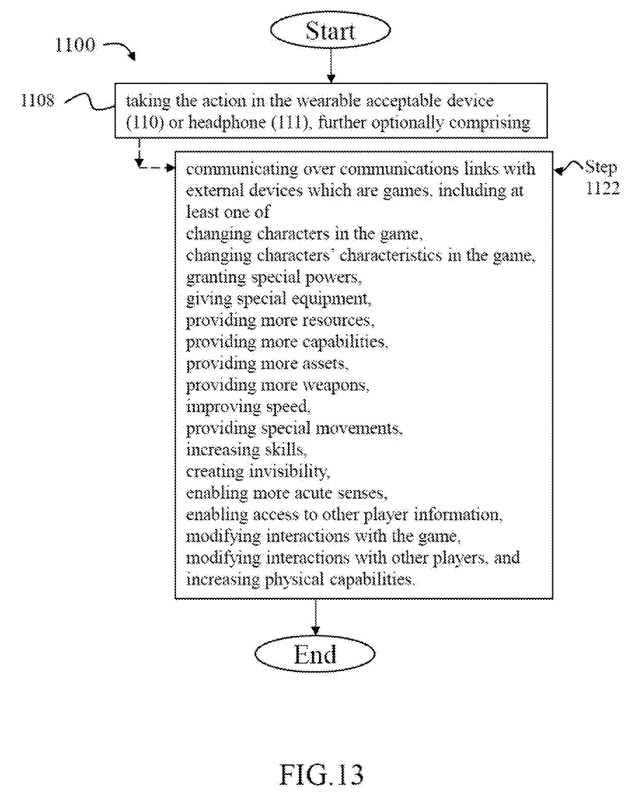

FIG. 13 is a flowchart of a process or method 1100 in accordance with examples of the disclosure. The process or method is implemented in the system 100 shown in FIGS. 1 and FIG. 2A comprising the attachable element 102, attachable member 103, identifier 104, ID number 106, wearable accepting device 110 or correlative headphone 111, reader 112, wearable accepting device processor 114, wearable accepting device software 116, and wired, wireless, direct contact, or optical communications between the attachable element 102 and the wearable acceptable device 110 or corresponding headphone 111. The process or method is further implemented in the system 100 shown in FIGS. 1, FIG. 2A, FIG. 4, FIG. 5, FIG. 6, and FIG. 7, which show communications from the wearable accepting device 110 or corresponding headphone 111 with other devices such as host 404, game engine 504, and game database 720, over various communications links and network 718.

In FIG. 13, the process or method 1100 starts with the first step 1108, which is the ending step of FIG. 11, that of taking the action in the wearable acceptable device 110 or headphone 111, and further optionally comprising steps that could be implemented following step 1108. Further following step 1108, the process or method 1100 continues optionally comprising the next step 1122 of communicating over communications links with external devices which are games, including at least one of changing characters in games, changing characters’ characteristics in games, granting powers, giving equipment, providing resources, providing capabilities, providing assets, providing weapons, improving speed, providing special movements, increasing skills, creating invisibility, enabling enhanced senses, enabling access to other player information, modifying interactions, modifying interactions with other players, and increasing physical capabilities.

According to various embodiments, a wearable device is an example of a peripheral device. Whereas a “wearable device” may be worn by a user, a “peripheral” device may or may not be worn by a user. A headphone is an example of a peripheral device that is wearable. All embodiments described herein in connection with a headphone or a wearable device are equivalently applicable to a peripheral device. Generally, a peripheral device, whether being a wearable device or a non-wearable device, can communicate with a user device in support of input and/or output operations, or some other operations, of the user device. This peripheral device can also interface (wirelessly, inductively, optically, or in a wired manner) with an attachable element that stores and identifier. Based on the identifier, at least one of the operations supported by the peripheral device and/or the user device can be modified according to embodiments of the present disclosure.

Furthermore, the attachable element is an example of a hardware element that stores an identifier usable by a peripheral device to effectuate an operation modification. Whereas an “attachable” may be attached to the peripheral device, a “hardware” element may or may not be attachable to the peripheral device. An earcup is an example of a hardware element that is attachable. All embodiments described herein in connection with an earcup or an attachable element are equivalently applicable to a hardware element that stores an identifier usable to effectuate an operation of a peripheral device interfacing with the hardware element or an operation of a user device communicatively coupled with the peripheral device. Generally, a hardware element may interface with the peripheral device such as being attached to it mechanically or being in proximity thereto to interface with it wirelessly, inductively, optically, or in a wired manner. The hardware element may include a set of covers (which may form a housing for other components), a first coupling interface to enable the communicative coupling with the peripheral device, and, optionally, a second coupling interface to enable the mechanical coupling with the peripheral device. The first coupling interface may be a wireless, inductive, optical, magnetic, capacitive, or any other interface that enables the communicative coupling such that the identifier stored at the hardware element can be provided to the peripheral device. The second coupling interface may be mechanical interface (including press fit), magnetic, etc.) or any other interface that enables the hardware element to attach to the peripheral device. The hardware element may also include an identifier element that stores the identifier. This identifier element can take the form of any storage for storing information that represents the identifier including a memory, an RFID chip, etc.

According to some embodiments, the peripheral device includes one or more memories storing instructions and one or more processors that, upon execution of the instructions, causes the peripheral device, or elements thereof, to perform various operations. For example, the peripheral device may receive an identifier from a hardware element that stores the identifier. The identifier may be received upon the peripheral device and the hardware element interfacing with each other as described herein via a coupling interface. In some embodiments, the coupling interface may be mechanical, such as via touching the identifier of the hardware element to a corresponding reader of the peripheral device. The coupling interface may include a magnetic coupling mechanism. In other embodiments, the coupling interface may include interfacing via RF based on proximity. In other embodiments, the coupling interface may include optical interfacing between the identifier and a reader. A reader of the peripheral device and the hardware element may establish a communication channel upon coupling the hardware element to the peripheral device. The communication channel is compliant with a short range communication protocol.

In some embodiments, in response to interfacing the peripheral device and the hardware element, the identifier may be determined to be valid or invalid. For example, the identifier may be subject to an authentication otherwise security-based check to determine that the identifier is valid or invalid. If the identifier is determined to be valid, there may be a change to an application. In at least some embodiments, the application is a video game or the like. The application may be executing locally on a user device (e.g., a mobile device, a video game console, etc.) or remotely via a server/cloud-based system. The change may include changing a characteristic of in-game character (e.g., an avatar) and/or an environment within the game, for example. An output of the execution of the application is presented at a user device with which the peripheral device is communicatively coupled.

In further embodiments, the hardware element further may include an output interface; one or more memories storing instructions and one or more processors that, upon execution of the instructions, configure the hardware element to present, via the output interface, information based on the identifier. The output interface may include a speaker, a small display such as an LED screen, etc., or any combination thereof. In some embodiments, the identifier itself may be displayed on the output interface to the user and/or a plurality of users. For example, the identifier may be output to a team of players that the identifier belongs to such that game scores about the user (e.g., some trophies they won) may be visible to team members with the same identifier. The hardware element may further store, by at least replacing the identifier, a different identifier in the identifier element. This type of identifier storage can support dynamic changes to identifiers.

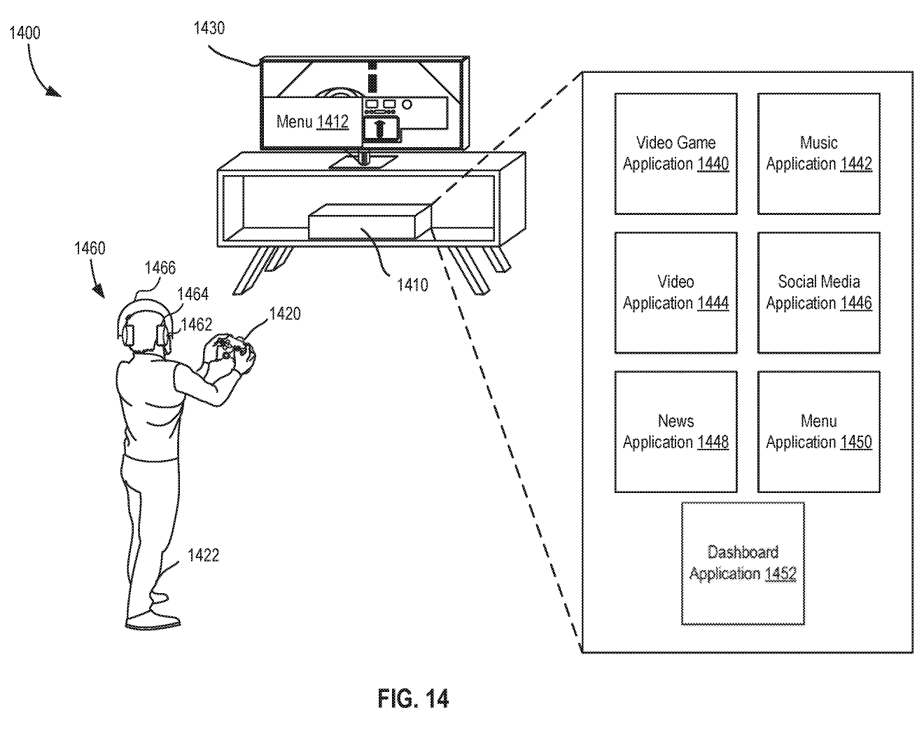

FIG. 14 illustrates a computer system, according to an embodiment of the present disclosure. As illustrated, the computer system 1400 includes a video game console 1410, a video game controller 1420, and a display 1430. The computer system 1400 may further include a wearable device 1460 having an attachable element 1462 removably coupled thereto. The wearable device 1460 may include any of a headset, headphones, earphones, etc., as described with respect to other figures. Further, the attachable element 1462 may include a removable ear cup or wearable device accessory as described with respect to other figures. The wearable device 1460 may include one or more attachable elements 1462, for example, one attachable element 1462 may be coupled to each ear cup 1464 of the wearable device 1460. In other embodiments, the attachable element 1462 may be removably coupled to other parts of the wearable device 1460 such as a head band 1466. Here, a wearable device 1460 is an example of a peripheral device that interfaces with another device in support of some functionalities of another user device, such as the video game console 1410. A peripheral device can be wearable or non-wearable. For example, a headset, a headphone with a microphone provides audio inputs/outputs to and/from a device, such as the video game console 1410 and is wearable. A combination of a standalone microphone and a standalone speaker or an audio system is another example of a peripheral device that provides that same functionalities, but may not be wearable. In another example, the video game controller 1420 is a peripheral device, where it can provide an input to control the execution of the video game application 1440 and can provide haptic feedback from the video game console 1410 about this execution. The video game controller 1420 may not be a wearable device. Other examples of peripheral devices to which the embodiments of the present disclosure similarly and equivalently apply include a virtual reality headset, an augmented reality headset, a mixed reality headset, a smart phone, a smartwatch or any other device that can provide input and/or receive an output of another device in support of one or more of functionalities of such a peripheral device. Accordingly, any of the embodiments as described with respect to FIGS. 1-13 may be implemented into the environment of FIG. 14 and the computer system 1400.

Although not shown, the computer system 1400 may also include a backend system, such as a set of cloud servers, that is communicatively coupled with the video game console 1410. The video game console 1410 is communicatively coupled with the video game controller 1420 and the wearable device 1460 (e.g., over a wireless network) and with the display 1430 (e.g., over a communications bus). A user 1422 operates the video game controller 1420 to interact with the video game console 1410. The user 1422 may further attach one or more attachable elements 1462 to the wearable device 1460 for interacting with the video game console 1410 and modifying aspects of the video game according to embodiments as further described herein. These interactions may include playing a video game presented on the display 1430, interacting with a menu 1412 presented on the display 1430, and interacting with other applications of the video game console 1410 (e.g., with media applications to stream media from an online content source or to play a media file from the local storage of the video game console 1410).

The video game console 1410 includes a processor and a memory (e.g., a non-transitory computer-readable storage medium) storing computer-readable instructions that can be executed by the processor and that, upon execution by the processor, cause the video game console 1410 to perform operations related to various applications. In particular, the computer-readable instructions can correspond to program codes for the various applications of the video game console 1410 including video game application 1440, music application 1442, video application 1444, social media application 1446, and news application 1448. A video game application, such as video game application 1440, generally represents a computer application executable to present video game content, receive user interaction with the video game content, and accordingly update the video game content. A media application, such as music application 1442, video application 1444, social media application 1446, and news application 1448, generally represents a computer application executable to present media content including audio, video, and/or other media types, receive user interaction with the media content, and accordingly update the media content. The media content can be streamed from a remote content source or can be presented form local storage of the video game console 1410. Further, other applications can be likewise included in the video game console 1410, such as a chat application. The availability of a video game application, media application, and/or other type of computer application to the user 1422 via the video game console 1410 can depend on a user identifier of the user 1422 (e.g., upon a login to the video game console 1410, the availability of the computer applications can depend on the user identifier used in the login). In addition, the video game console 1410 includes a menu application 1450, and a dashboard application 1452. The menu application 1450 can present a home user interface (UI) in a GUI of the display 1430. The dashboard application 1452 can present an arrangement of interactive UI widgets in a dashboard page on the GUI.

The video game controller 1420 is an example of an input device. Similarly, the wearable device 1460 and the attachable element 1462 may be an input device. The video game controller 1420 and the wearable device 1460 may allow the user 1422 to interact with one or more GUIs presented by the video game console 1410 on the display 1430. For example, using one or more directional control inputs (e.g., a joystick and/or a directional pad) the user can navigate to and within various menus, dashboards, and UI elements. Other types of the input device are possible including, the attachable element 1462 a keyboard, a touchscreen, a touchpad, a mouse, an optical system, a microphone, a camera, or other user devices suitable for receiving input of a user. For example, a microphone may allow the user 1422 to interact with the GUIs using various voice commands. As another example, a camera may allow the user 1422 to interact with the GUIs using various gesture commands. According to one embodiment, an attachable element device includes a cover portion, such as a decorative cover 102 as shown at least in FIG. 2B. The attachable element may include a first surface and a second surface opposite the first surface. In various embodiments, the first surface may be an outer surface that faces toward the environment for decoration and/or identification purposes. The second surface may be an interface surface that interfaces with and couples to a peripheral device. An identifier element, such as identifier 104, may store an identifier and be coupled to or integrated with the second surface as shown at least with respect to FIG. 2B. The second surface may be an inner surface opposite of the first surface and facing toward the peripheral device when the attachable element is coupled thereto. For example, the first surface may be the outer surface of the decorative cover 102 shown at least in FIG. 3A. The identifier element communicatively couples to a corresponding reader, such as reader 112, of a peripheral device. The attachable element may further include a coupling interface configured to removably couple the attachable element device to the peripheral device. The coupling interface may include one or more of a magnet, a press-fit indentation, or a fastener.

Upon an execution of the video game application 1440 by the video game console 1410, a rendering process of the video game console 1410 presents video game content (e.g., illustrated as a car race video game content) on the display 1430. Upon user input from the video game controller 1420 (e.g., a user push of a particular key or button), the rendering process also presents the menu 1412. Additionally, or alternatively, the menu 1412 may be presented as an initial landing page in response to a user powering-on the video game console 1410 and/or waking the video game console 1410 from a suspended state. Depending on the user input, the menu 1412 corresponds to the home UI page, a landing page, or the like. The menu 1412 can be presented in a layer over the video game content.

Upon the presentation of the menu 1412, the user control changes from the video game application 1440 to the menu application 1450. Upon receiving a user input from the video game controller 1420 requesting interactions with the menu 1412, an underlying application (e.g., the menu application 1450, or the dashboard application 152, as applicable) supports such interactions by updating the menu 1412 and launching any relevant application in the background or foreground. The user 1422 can exit the menu 1412 or automatically dismiss the menu 1412 upon the launching of an application in the background or foreground. Upon exiting the menu 1412 or the dismissal based on a background application launch, the user control changes from the underlying application to the video game application 1440.

As described in more detail below, the dashboard application 1452, when executed, may generate a dashboard (e.g., a “widget menu,” “landing page,” and/or “explore page”) configured to present information from applications and services available to the video game console 1410 as interactive UI widgets. The term “widget” is used herein as an example of an interactive UI element generated and/or presented by the dashboard application 1452 and corresponding to an application or service of the computer system. Other implementations to present a UI element are possible, including any type of icon, whether a widget, a tile, a thumbnail, a text description, a multiple column element with textual or graphical description in each column, and the like. As described further, below, widgets may be presented with application information and/or dynamic content presented with the widget in a media library. For example, the dashboard application 1452 may generate and/or present widgets associated with media applications, system applications and/or services, video game applications, or the like.

As described in more detail below, the dashboard application 1452 may be executed via multiple avenues of ingress. For example, the dashboard application 1452 may be executed by a pre-defined user interaction (e.g., via controller 1420, via the wearable device 1460 in combination with the attachable element 1462, a voice command from the user 1422, activating and/or powering-on the video game console 1410 etc.) and/or by navigating one or more menus and/or sub-menus of the video game console 1410 (e.g., menu 1412).

Although FIG. 14 illustrates that the different applications are executed on the video game console 1410, the embodiments of the present disclosure are not limited as such. Instead, the applications can be executed on the backend system (e.g., the cloud servers) and/or their execution can be distributed between the video game console 1410 and the backend system. In some examples, the video game application 1440 may be an instance of a video game application executing on the backend system. When a video game input is received at the video game controller 1420, the video game console 1410 may send the video game input from the video game controller 1420 to the backend system. In turn, a video game stream responsive to the video game input is sent to the video game console 1410 for presentation as part of the video game application 1440.

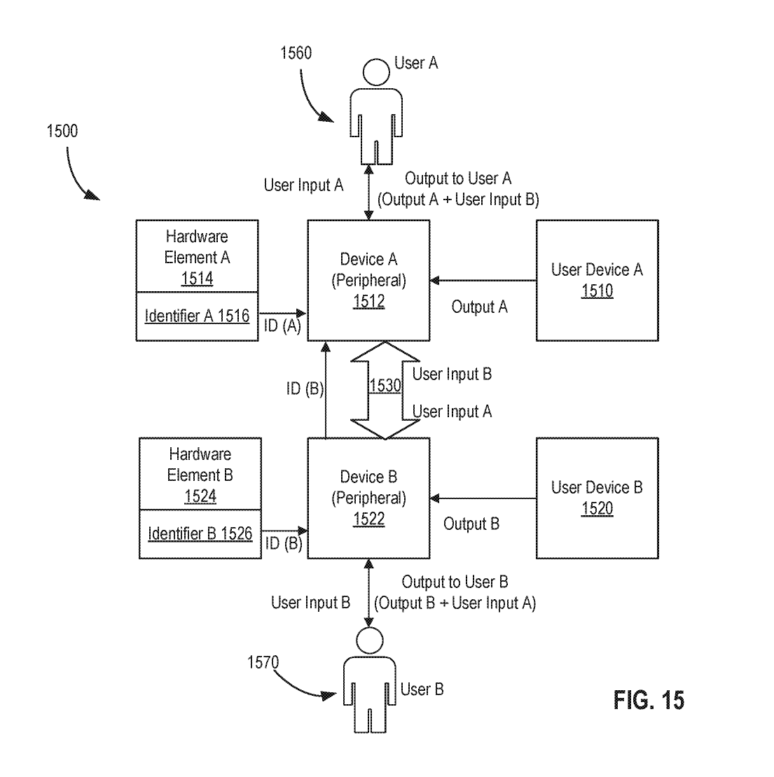

FIG. 15 is a block diagram of a communication system 1500, according to an embodiment of the present disclosure. The communication system 1500 may perform automatic communication between peripheral devices based on identifiers stored on corresponding hardware elements. As illustrated, the communication system 1500 includes a user device 1510 (User Device A). The communication system 1500 may further include a user device 1520 (User Device B). In some examples, the user devices 1510 and 1520 may be any of a video game console, a computer device, a mobile device, a home or personal entertainment device, etc. At least a portion of the communication system 1500 is an example of a computer system 1400. For example, each of the user devices 1510 and 1520 may be devices such as host 404 or game engine 504 of FIGS. 1 and 4-7, or a video game console 1410 of FIG. 14.

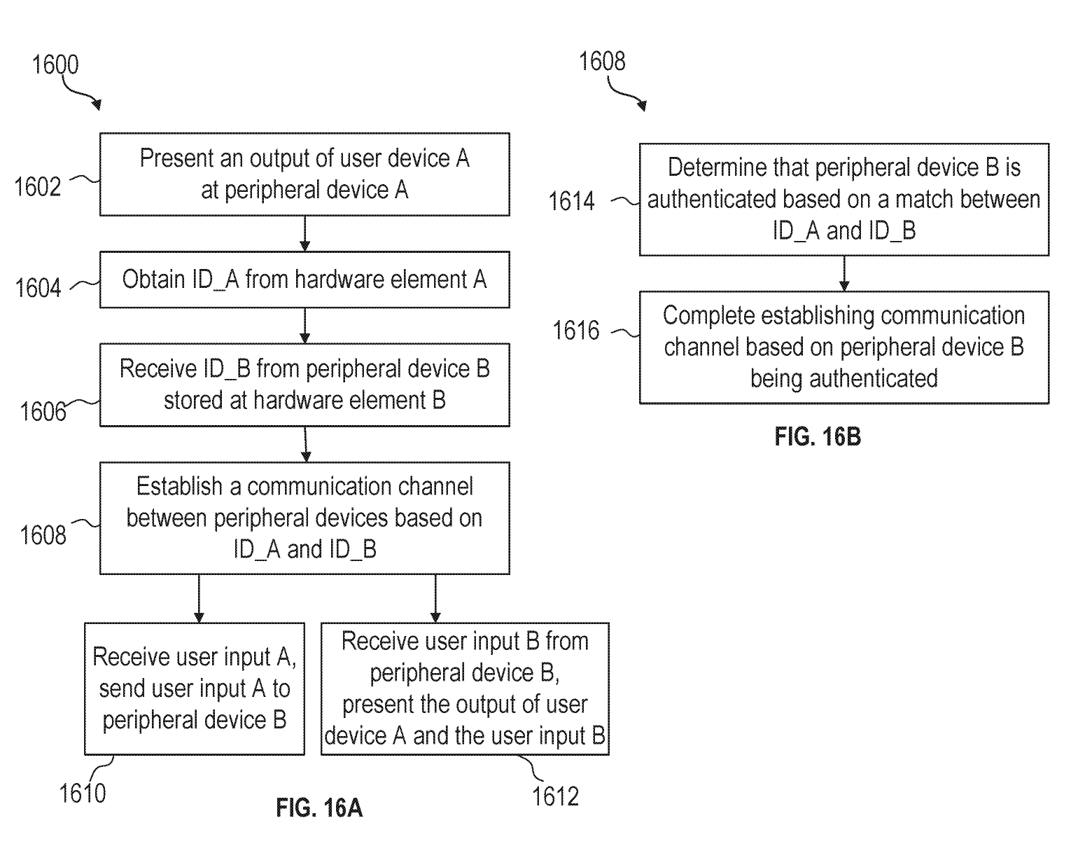

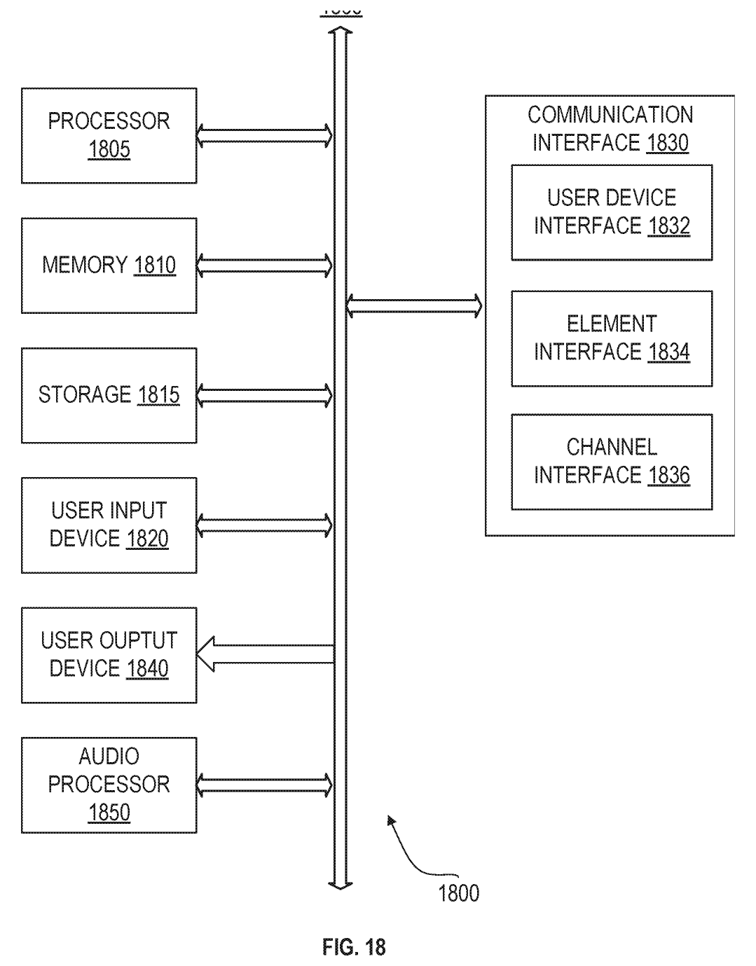

The communication system 1500 may include a plurality of peripheral devices, including a peripheral device 1512 (Device A) and a peripheral device 1522 (Device B). While FIG. 15 includes two peripheral devices as examples, a number of peripheral devices may be any, not limited to two. In some examples, each of the peripheral device 1512 and the peripheral device 1522 includes one or more computers, such as a computer system implemented as shown in FIG. 18. For example, the system may include one or more processors and memory as can be implemented in hardware (e.g., a processor, computer circuitry, and the like), software, or a combination thereof. In some implementations, although not shown, the system can include one or more processors and one or more memories. The one or more processors can read one or more programs from the one or more memories and execute them to implement the system 100. Each processor of the one or more processors can be of any type of processor. Examples of each processor include, but are not limited to, microprocessor, microcontroller, central processor unit (CPU), digital signal processors (DSP), application-specific integrated circuit (ASIC), field programmable gate array (FPGA), or any combination thereof. Additionally, each processor of the one or more processors can include audio processors, arrays, coprocessors, local cache memory layers, and the like. Each memory of the one or more memories can be non-volatile and can include any type of memory or memory device that retains stored information, such as identifiers, when powered off. At least one memory of the one or more memories can include a non-transitory computer-readable storage medium from which the one or more processors can read instructions. Examples of memories, memory devices, computer-readable storage media include, but are not limited to, include electrically erasable and programmable read-only memory (PROM), flash memory, magnetic disks, memory chips, read-only memory (ROM), random access memory (RAM), ASIC, a configured processor, optical storage, and the like. The one or more processors, either individually or collectively, can execute programs stored in the one or more memories to perform the operations and/or methods, including parts thereof, described throughout. For example, the one or more processors can execute programs stored in the one or more memories to perform functions of the system to perform flows described herein with reference to FIGS. 16A and 16B. In some examples, each of the peripheral device 1512 and the peripheral device 1522 may be a wearable device. In some examples, any of the peripheral device 1512 or the peripheral device 1522 may include any of a headset, headphones, earphones, a head-mount display (HMD), etc., as described with respect to other figures. In some examples, any of the peripheral device 1512 or the peripheral device 1522 may include an input device, such as a video game controller, a microphone, a camera, a mouse, a keyboard, a touch pen, a touch pad, a touch screen etc. In some examples, any of the peripheral device 1512 or the peripheral device 1522 may provide output, such as one or more speakers that provide audio output, a display which provides video output, or a wearable device, such as a video game controller, a head-mount display, a smart watch, etc., that may provide a display and/or a tactile output. The wearable accepting device 110 or corresponding headphone 111 in FIGS. 1, 2A, and 4-7 may be examples of each of the peripheral device 1512 and the peripheral device 1522.

In some examples, the peripheral device 1512 (Device A) is communicably coupled with the user device 1510 and the peripheral device 1522 (Device B) is communicably coupled with the user device 1520. Each of a combination of the peripheral device 1512 and the user device 1510, or a combination of the peripheral device 1522 and the user device 1520 may perform wired or wireless communication. In some examples, the communication is via direct connection, near-field communications (NFC), Bluetooth, Internet, optical, inductively coupled, magnetic field induction, electromagnetic, capacitively coupled, etc. In some examples, when the user device 1510 provides an output (Output A) to the peripheral device 1512, the peripheral device 1512 may present the output (Output A) of the user device 1510 to a user 1560. Similarly, when the user device 1520 provides an output (Output B) to the peripheral device 1522, the peripheral device 1522 may present the output (Output B) of the user device 1510 to a user 1570.

A communication channel 1530 may support bi-directional or uni-directional data transfer, enabling chat, broadcast, or other context-specific information from/to a peripheral device. Establishing a communication channel 1530 between peripheral devices for automatic communication is based on identifiers stored in hardware elements communicably coupled to the peripheral devices. As described herein with regards to FIGS. 1, 2A, 4-7, and 11-14, the identifiers may encode user, group, team, game, language, or other contextual information relevant to establishing communication. In some examples, the identifiers may include one or more of a user ID, a group ID, a player ID, a team ID in sport, a game ID, a language ID, a sound effect selection ID, a program subscription ID, a cup design ID, etc. In some examples, the communication system 1500 may include a hardware element 1514 (Hardware Element A) that interfaces the peripheral device 1512. The hardware element 1514 may be communicably coupled with the peripheral device 1512. In some examples, the hardware element 1514 may be releasably attachable to the peripheral device 1512. Similarly, the communication system 1500 may also include a hardware element 1524 (Hardware Element B) that interfaces the peripheral device 1522. The hardware element 1524 may be communicably coupled with the peripheral device 1522. In some examples, the hardware element 1524 may be releasably attachable to the peripheral device 1522. In some examples, the hardware element 1514 and the hardware element 1524 may store an identifier A 1516 (ID (A)) and an identifier B 1526 (ID (B)), respectively. In some examples, any of the hardware element 1514 or the hardware element 1524 may include a device that electronically stores the corresponding identifier, including electronic circuit, microchip storage, integrated circuit, antenna, substrate, active identifier, semi-passive identifier, passive identifier, or inductively coupled identifier, such as a RFID (Radio Frequency Identification) tag storing a code. In some examples, any of the hardware element 1514 or the hardware element 1524 may include a visible code, such as a barcode, including Universal Product Code (UPC), or a quick response (QR) code that may present an unencrypted identifier, an encrypted identifier, a hashed identifier as the corresponding identifier, that may be readable by the peripheral device 1512 or the peripheral device 1514, respectively.

The peripheral device 1512 may obtain the identifier A 1516 from the hardware element 1514 using any of the techniques described herein above. Similarly, the peripheral device 1522 may obtain the identifier B 1526 from the hardware element 1524. In some examples, each of the peripheral devices 1512 and 1522 may obtain the corresponding identifier electronically, via direct connection, near-field communications (NFC), Bluetooth, Internet, optical, inductively coupled, magnetic field induction, electromagnetic, capacitively coupled, etc. In some examples, each of the peripheral devices 1512 and 1522 may include a camera or optical sensors and obtain the corresponding identifier by reading (e.g., scanning) the visible code.

The peripheral device 1522 provides the identifier B 1526 to the peripheral device 1512, and the peripheral device 1512 may receive the identifier B 1526 from the peripheral device 1522. In some examples, the peripheral device 1512 may receive the identifier B 1526 from the peripheral device 1522 electronically, via direct connection, near-field communications (NFC), Bluetooth, Internet, optical, inductively coupled, magnetic field induction, electromagnetic, capacitively coupled, etc. In some examples, the electronic communication to receive the identifier B 1526. Based on the identifier A 1516 and the received identifier B 1526, a communication channel 1530 between the peripheral device 1512 and the peripheral device 1522 may be established. In some examples, the peripheral device 1512 may determine that the peripheral device 1522 is authenticated based on a match between the identifier A 1516 and the identifier B 1526. In some examples, the match between identifiers may be determined by comparing the entire identifier values, specific segments or digits, or by evaluating computational or logical results derived from the identifiers. For example, the match between the identifier A 1516 and the identifier B 1526 may be compared to determine whether the identifier A 1516 and the identifier B 1526 are identical. In some examples, the match between the identifier A 1516 and the identifier B 1526 may be performed based on a portion of the identifier A 1516 and the identifier B 1526, such as an upper portion, a middle portion, or a lower portion, or predetermined digits (e.g., left most predetermined digits or right most predetermined digits, from n to n + x digits) of the identifier A 1516 and the identifier B 1526 to determine whether the extracted digits are identical or relevant. a computation of the identifier A 1516 and the identifier B 1526 may be evaluated to determine a match if a result is as expected, such as the result shows a predetermined value, or a logical computation result showing the match, etc. In some examples, above authentication based on the match may be performed by the peripheral device 1512. Upon determining that the peripheral device 1522 is authenticated, the peripheral device 1512 may complete establishing the communication channel based on the second device being authenticated.

Once the communication channel 1530 is established, the peripheral device 1512 and the peripheral device 1522 can send and receive data, such as audio data, text data, or video data. The communication channel 1530 may perform electronic communication using direct connection, or wireless connection, such as near-field communications (NFC), Bluetooth, Wi-Fi, Internet, optical, inductively coupled, magnetic field induction, electromagnetic, capacitively coupled, infrared (IrDA), Ultra Wideband (UWB), etc. In some examples, the communication channel 1530 may be compliant with a short range communication protocol, including NFC, Bluetooth, Wi-Fi, UWB, etc. The peripheral device 1512 may receive a user input from either the user device A 1510 or at the peripheral device 1512 while the output from the user device A 1510 is being presented to the user 1560. In FIG. 15, a user input A is accepted at the peripheral device 1512 or at the user device A 1510 or another peripheral device communicably coupled to the user device A 1510. For example, the peripheral device 1512 or the user device A 1510 may include a microphone, and the user input may be audio data representing a sound around the microphone, such as a voice of the user A 1560 uttering speech and/or a background sound of the user A. When the peripheral device 1512 or the user device A 1510 includes or has access to keypads, a keyboard, a mouse, an electronic pen, a touch pad, etc., then the user input may be text data. When the peripheral device 1512 or the user device A 1510 includes or has access to a camera, then the user input may be video data.

The communication channel may be either bi-directional or uni-directional. The communication channel is established while the first user device and a second user device communicably coupled to the second peripheral device are executing instances of a same video game. In some examples, the peripheral device 1512 may send the user input A to the peripheral device 1522 over the communication channel 1530. In some examples, the peripheral device 1512 may receive a user input B to the peripheral device 1522 over the communication channel 1530. The peripheral device 1512 may present the output (Output A) of the user device A 1510 and the user input B from the peripheral device 1522 to the user A 1560. In some examples, the peripheral device 1512 may be a headphone including one or more speakers, and the peripheral device 1512 may receive the user input B which is audio data, and the peripheral device 1512 may present audio data from the user device 1510 and the audio data from the peripheral device 1522 together. Then, the user A 1560 may be presented content sound from the user device A 1510 and a voice representing a chat or a command from the peripheral device 1522. In some examples, the peripheral device 1512 may be a headset further including a microphone, and the peripheral device 1512 may receive the user input A which is audio data, and provide the audio data to the peripheral device 1522. In some examples, the peripheral device 1512 may be a display and the peripheral device 1512 may receive the user input B which may be video data or text data, and the peripheral device 1512 may present video data from the user device 1510 with the video data or the text data from the peripheral device 1522 after converting the video data or the text data into image data and overlaying the converted image data on the video data. In some examples, the communication channel 1530 may provide a bi-directional communication, such as audio chat, video chat or text chat. In some examples, such chat may be in-game chat between the users 1560 and 1570 performing a same video game when the user devices 1510 and 1520 are executing instances of the same video game. For example, when the authentication is based on a team ID, then the established channel is for a team indicated by the team ID in a video game, and the peripheral device 1512 may receive and send the audio, video, or text chat communicated among peripheral devices associated with the identifier A 1516 that indicates the team ID used by teammate users in the same video game. In some examples, the communication channel 1530 may provide a uni-directional communication, such as audio, video, or text broadcast based on the identifiers. For example, when the authentication is based on a team ID, then the established channel is for broadcast to a team indicated by the team ID in a video game, and the peripheral device 1512 may receive the audio, video, or text data broadcasted for peripheral devices used by teammate users including the user 1560 in the same video game. When the authentication is based on a language ID, then the peripheral device 1512 may receive the audio, video, or text broadcast data in a language represented by the language ID in the identifier A 1516.

An effect associated with the identifier A 1516 provided to a peripheral device 1512 may persist while the Hardware Element A 1514 is coupled to the peripheral device 1512. For example, an audio, video, or text broadcast data is provided by a system device, such as User Device A 1510, to the peripheral device 1512 in response to a continued authentication indicating the Hardware Element A 1514 remains coupled to the peripheral device 1512, such as by a heartbeat connection protocol or other periodic signal indicative of continued connection. In other examples, an effect associated with the identifier A 1516 provided to a peripheral device 1512 may persist after the Hardware Element A 1514 is removed from the peripheral device 1512. Such persisted effect may be maintained for a threshold time, such as in accordance with a timeout policy. A persisted effect may be maintained until another hardware element associated with a different identifier is coupled to the peripheral device 1512. For example, disconnecting Hardware Element A 1514 from the peripheral device 1512 may maintain an English language audio, video, or text broadcast of data until another hardware element with an identifier associated with another language, such as Spanish, is coupled to the peripheral device 1512. In some examples, an effect associated with the identifier A 1516 may correspond to an in-game action or modification in a video game.

In some examples, the identifiers may be used for audio control based on game progress. The user device 1510 may provide a control signal based on the first identifier to mute or attenuate audio input to the peripheral device 1512, either from the user device 1510 or the peripheral device 1522. For example, when the identifier 1516 is a character ID indicative of a character who is not in a game unit (e.g., a player’s car fails and the player quitted for the rest of the car race) or paused for a portion of a game unit (e.g., a player is not a starting member in a sport game) in the video game, the entire audio inputs, regardless of sources of the audio inputs, may be muted at the peripheral device 1512. When the identifier 1516 is a team ID indicative of a team which lost in a game unit of the video game, all the peripheral devices that obtained the same team ID may have their audio be attenuated or muted for the rest of the game unit. For example, when the user device 1510 identifies that a player controlled is paused for the rest of the game, the user device sends out control commands “mute audio input” and “attenuate audio output” with an identifier having the character ID to the peripheral device 1512. The peripheral device 1512, upon receipt of the commands with the identifier, verifies whether the identifier 1516 matches the identifier with the commands. If the identifier 1516 matches the identifier with the commands, the peripheral device 1512 may perform functions corresponding with the commands “mute audio input” and “attenuate audio output” for example, attenuating audio output to the user 1560 and muting user audio input by a microphone. In another example, when the user device 1510 identifies that a team in which a player controlled is lost, the user device sends out a control command “mute audio input and output” with an identifier having the team ID to the peripheral device 1512. The peripheral device 1512, upon receipt of the command the identifier, verifies whether the identifier 1516 matches the identifier with the command. If the identifier 1516 matches the identifier with the command, the peripheral device 1512 may perform a function corresponding with the command “mute audio input and output,” for example, muting the audio output and the user audio input both. In yet another example, when the user device 1510 identifies that a player is out of a game, the user device sends out a control command “quit a channel” with an identifier having the character ID to the peripheral device 1512. The peripheral device 1512, upon receipt of the command the identifier, verifies whether the identifier 1516 matches the identifier with the command. If the identifier 1516 matches the identifier with the command, the peripheral device 1512 may perform a function corresponding with the command “quit a channel,” for example, terminating automatic access to the communication channel. In another example, the peripheral device 1512 may obtain a plurality types of identifiers, such as a character ID and a team ID from the hardware element 1514 or a plurality of hardware element. In some examples, the plurality types of identifiers may be stored as one identifier. In some examples, a type of identifier may be included in another type of identifier (e.g., a character ID’s leftmost digits indicate aa team ID, etc.). Then the peripheral device 1512 may handle both scenarios above, when a command from the user device 1510 is with either the character ID or the team ID. In yet another example, the user device 1510 identifies that a character handled by the user device 1520 changed a role from an ally to an enemy, the user device 1510 may send a command “cancel a channel” with an identifier having the character ID of the user device 1520. When the peripheral device 1512 verifies that the character ID matches the identifier 1526 from the peripheral device 1522, the peripheral device 1512 may terminate the communication channel 1530 established with the peripheral device 1522.

In some examples, the identifiers of a game status may be used for user interface control based on game progress. For example, the user device 1510 may provide game event information available from a game application executed thereon to the peripheral device 1512. The game event information may include participant status or game status. In some examples, the participant status may indicate a list of team IDs, character IDs, or player IDs granted access to the game event. The peripheral device 1512 may check if the identifier 1516 received from the hardware element 1514 may match the IDs in the list, and if the identifier 1516 matches none of the IDs in the list, the user inputs (e.g., a user’s voice input, a user’s controller button/knob entries, etc.) may be disabled at the peripheral device 1512. Alternatively, if the identifier 1526 received from the peripheral device 1522 matches any of the IDs in the list, input while the identifier 1516 matches none, communication from the peripheral device 1522 may be received but communication from the peripheral device 1512 may be disabled. In some examples, the game status may include new event information with multiple pieces of channel access information of the event for corresponding multiple user groups. The peripheral device 1512 may check in the new event information to verify if the identifier 1516 received from the hardware element 1514 may match a group ID corresponding to any user group included in the new event information. If there is a group ID that matches with the identifier 1516, then the peripheral device 1512 may join a communication channel using the event channel access information. In another example, the game status merely includes an event ID. The peripheral device 1512 may store a corresponding table listing multiple event IDs, each event ID listed with its corresponding channel access information. Based on the event ID and the identifier match, the event ID’s corresponding channel access information is used for accessing the communication channel associated with the event.

Thus, based on identifiers in hardware elements communicably coupled with peripheral devices, a communication channel may be established and the peripheral devices may automatically join the communication channel to participate in the bi-directional or uni-directional communication. Furthermore, identifier-based channel control may be performed for video games.

FIG. 16A is a flowchart illustrating an example method 1600 for identifier-based automatic communication according to an embodiment of the present disclosure. The method may be implemented using a communication system 1500 of FIG. 15. In some examples, the method 1600 may be performed by a peripheral device A, such as the peripheral device 1512 of FIG. 15. Thus, explanations of peripheral devices, user devices and hardware elements are not repeated for the sake of brevity.

In operation 1602, an output of a user device A may be presented at a peripheral device A. In some examples, the user device A may be the user device 1510. In some examples, the user device A may be a game console and the peripheral device may be a headset. In some examples, the output of the user device A may be in-game audio components of a video game executed by the user device A played by a user, such as the user 1560. In some examples, the in-game audio components, such as dialogue, sound effects, background noise within the video game may be pre-recorded or pre-produced.

In operation 1604, an identifier A (ID_A) may be obtained from a hardware element A that interfaces the peripheral device A In some examples, the hardware element A and the identifier A may be the hardware element 1514 and the identifier A 1516 of FIG. 15, respectively. In operation 1606, an identifier B (ID_B) which was obtained by a peripheral device B from a hardware element B, may be received at the peripheral device A. In some examples, the peripheral device B, the hardware element B and the identifier B may be the peripheral device 1522, the hardware element 1524 and the identifier B 1526 of FIG. 15, respectively.

In operation 1608, a communication channel between the peripheral device A and the peripheral device B may be established based on the identifier A and the identifier B. In some examples, the communication channel is established according to a short range communication protocol and is either bi-directional or uni-directional. The peripheral device A and the peripheral device B may be within a range of short range communication. Based on identifiers, the peripheral device A and the peripheral device B may be automatically start accessing communication of the communication channel. In some examples, the communication channel is established while the user device A and a user device B, such as the user device 1520 of FIG, 15 communicably coupled to the peripheral device B, are executing instances of a same video game. In some examples, establishing the communication channel starts upon obtaining the identifier in the operation 1606. In some examples, each peripheral device may send out the obtained identifier and receive one or more identifiers from other devices. For example, the peripheral device A may send out the identifier A (ID_A) and receive identifiers from other peripheral devices, including the identifier B (ID_B) from the peripheral device B. Similarly, the peripheral device B may send out identifier B (ID_B) and receive identifiers from other peripheral devices, including the identifier A (ID_A) from the peripheral device A. Then the peripheral device A may evaluate whether the identifier A and the identifier B match. If the identifier A and the identifier B match, then the peripheral device A may determine to contact the peripheral B for pairing, if other requirements by a protocol employed by the communication channel (e.g., Bluetooth, NFC). The same evaluation may be performed for the other identifiers that the peripheral device A receives from the other devices. Similarly, the peripheral device B may evaluate whether the identifier B and the identifier A match. If the identifier A and the identifier B match, then the peripheral device B may determine to contact the peripheral A for pairing, if other requirements by a protocol employed by the communication channel (e.g., Bluetooth, NFC), such as security information, is met. In some examples, the peripheral device A may be an initiator who initiates a pairing request to the peripheral device B which is a responder, or vice versa. If the peripheral device B responds with an acceptance, then they proceed with the pairing. The peripheral device A and the peripheral device B may exchange authentication data, such as cryptographic keys associated with the identifiers for decrypting the authentication data or data in packets transmitted on the communication channel may be used for securing the connection. If the authentication fails, the communication channel establishment process may be aborted. Upon successful pairing and authentication, the initiator and responder establish a Bluetooth logical link, such as an Asynchronous Connection-Less (ACL) link. The peripheral devices may negotiate and agree upon supported Bluetooth profiles (e.g., Serial Port Profile (SPP), Advanced Audio Distribution Profile (A2DP), Headset Profile (HSP)), which define the types of data and services to be exchanged over the connection. The connection is confirmed, and both peripheral devices signal readiness to send and/or receive user or application data. At this stage, the communication channel is open, and data such as audio streams, control signals, chat messages, or other application-level information may be transmitted in accordance with the agreed profiles and protocols. Connection parameters, such as latency, throughput, and quality of service, may be dynamically negotiated and adjusted as required by the devices or applications. The initiator peripheral device may select a communication channel (e.g., what frequency band/frequency to use for the communication). In some examples, the channel may be selected based on the identifiers. In some examples, the channel may be selected based on a purpose and/or required bandwidth suitable for the purpose (e.g., broadcast, video/voice/text chat, etc.). In some examples, each peripheral device may store a table listing what channels can be used for particular identifiers or an initiator peripheral device may allocate channel distribution to identifiers agnostically of what the actual identifiers are). The established channel may be terminated based on a user status per above, the video game application stops, the team associated with the channel lost, etc. In some examples, the user device A may send a game status updated or a control signal to the peripheral device, A then the peripheral device A may use the game status or the control signal to determine termination of the channel. Then the peripheral device A may send out a termination request of the communication channel to a paired counterpart, the peripheral device A. Similarly, the peripheral device B may send out a termination request of the communication channel to the peripheral device A. Alternatively, the channel may be terminated upon detection of certain error conditions (e.g., devices moving out of range, timeouts, or explicit disconnect commands).

Once the communication channel is established, the peripheral device A may perform at least one of operations 1610 and 1612. In some examples, the operations 1610 and 1612 may be performed in any order, in parallel, or selectively, depending on the configuration of the communication channel, (e.g., bi-directional or uni-directional) and the nature of the application (e.g., real-time chat, push-to-talk, or broadcast). In the operation 1610, the peripheral device A may receive user input A from a user A, and send user input A to peripheral device B. In case of voice chat or talk for broadcast, a user input A may be a voice of a user A received at a microphone coupled to or integrated into the peripheral device A. In case of text chat or text for broadcast, a user input A may be text entry using an input device or voice input at a microphone coupled to or integrated into the peripheral device A, and converted into text using speech recognition by the peripheral device A. In some examples, the peripheral device A may use a speech engine or a machine learning model internally or externally to perform speech recognition. In case of a video chat, a user input A may be a video captured by a camera coupled to or integrated to the peripheral device A. In operation 1612, the peripheral device A may receive user input B from peripheral device B and present the output of user device A and the user input B. In case of voice chat or talk for broadcast, a user input B may be a voice of a user B. In case of text chat or text for broadcast, a user input B may be text entry using an input device or voice input at a microphone converted into text using speech recognition. In case of a video chat, a user input B may be a video captured by a camera coupled to or integrated to the peripheral device B. When the user device A is a game console, the peripheral device A may output game audio, such as the in-game audio components of the video game, and audio input from the peripheral device B at the one or more speakers. At least one of the operation 1610, receiving user input A, sending user input A to peripheral device B and the operation 1612, receiving user input B from peripheral device B and presenting the output of user device A and the user input B may be performed concurrently or independently, supporting both chat and broadcast scenarios.

When the communication is bi-directional, such as a voice chat, a text chat, or video chat within a game or group, or team, the peripheral device A may perform operations 1610 and 1612, and the chat is facilitated on the communication channel. When the communication is uni-directional and the peripheral device A is broadcasting, the peripheral device A may perform the operation 1610. When the communication is uni-directional and the peripheral device A is receiving broadcast from the peripheral device B, the peripheral device A may perform the operation 1612.

FIG. 16B is a flowchart illustrating an example of an operation 1608 of the method 1600 for establishing identifier-based communication channel according to an embodiment of the present disclosure.

In sub-operation 1614, the peripheral device A may determine that peripheral device B is authenticated based on a match between the identifiers A and B. In some examples, the peripheral device A may perform match-based authentication to authenticate the peripheral device B. In some examples, another device, such as an external authentication server or terminal may perform match-based authentication to authenticate the peripheral device B. In some examples, the match between the first identifier and the second identifier is performed based on at least a portion of the first identifier and a portion of the second identifier. In some examples, a result of the match between the identifier A and the identifier B may be positive when the identifier A and the identifier B are identical. In some examples, the match may be full, partial, or computational, and may be performed by a peripheral device or an external server. In some examples, the match between the identifier A and the identifier B may be performed based on a portion of the identifier A and a portion of the identifier B, such as an upper portion, a middle portion, or a lower portion, or predetermined digits (e.g., left most predetermined digits or right most predetermined digits, from n to n + x digit, where n and x are natural numbers) of the identifier A and the identifier B to determine whether the extracted digits are identical or relevant. In some examples, a computation of the identifier A and the identifier B may be performed to determine a match if a result is as expected, such as the result shows a predetermined value, or a logical computation result showing the match, etc. In sub-operation 1616, upon determining that the peripheral device B is authenticated, the peripheral device A may complete establishing the communication channel based on the peripheral device B being authenticated.

Using the identifier based automatic connection between devices, such as peripheral devices, various applications may be implemented. In some examples, the identifiers may include one or more of a user ID, a group ID, a player ID, a team ID in sport, a game ID, a language ID, a sound effect selection ID, a program subscription ID, a cup design ID, etc. In some examples, the identifier may include multiple types of identifiers (e.g., a player ID, a team ID, and a game ID). In some examples, a type of identifier may be included in another type of identifier (e.g., a player ID’s leftmost digits may be allocated for a game ID, and the player ID’s following digits may be allocated for a team ID, etc.). A portion of the identifiers may be matched for comparison of the digits allocated for a specific type of ID. Any of the identifiers described herein with regards to FIG. 15 and here may be used for automatic connection.

In one example, user A and user B may be students from a same school Y playing sport X in a sport event where multiple games of multiple sports are participated by students from multiple schools. A hardware element, such as a card given to user A to be inserted into a slot of a sport X helmet worn by user A incorporating a headset may be showing a logo of school Y. In some examples, a group ID indicative of school Y may be obtained from the hardware element, and a sport ID indicative of sport X may be obtained from the helmet worn by user A. Similarly, a group ID indicative of school Y may be obtained from the hardware element, and a sport ID indicative of sport X may be obtained from the helmet worn by user B. Using the match of the group ID indicative of school Y and the sport ID indicative of sport X, the headphone of user A and the headphone of user B may be granted access to one communication channel dedicated for school Y teammates for sport X. However, another user C having a card showing a logo of school P, or another user D having a card showing a logo of school Y but wearing a wristband indicative of sport Q may not be granted access to the same communication channel. As shown here, an identifier may also be included in a peripheral device, and combined with an identifier from the hardware element to be used for identifier based automatic communication.

In another example, user A and user B are attending a hackathon and assigned to group Z and user A speaks language A and user B speaks language B. An attachable element given to user A to attach to a headphone may be showing a logo of group Z in language A, and having one or more identifiers indicative of group Z and language A, either individually or combined. An attachable element given to user B to attach to a headphone may be showing a logo of group Z in language B, and having one or more identifiers indicative of group Z and language B, either individually or combined. Using the match of group ID indicative group Z, the headphone of user A and the headphone of user B may be granted access to one communication channel dedicated for group Z; however, based on different language IDs, a language interpreter engine may be launched at each peripheral device or at a remote device communicatively coupled with the peripheral devices for interpretation. Upon receiving the language ID indicative of language B from the headphone of user B, user A’s headphone may start interpreting the user input (e.g., text, voice) of user B on the communication channel for group Z into language A. Upon receiving the language ID indicative of language A from the headphone of user A, user B’s headphone may start interpreting the user input (e.g., text, voice) of user A on the communication channel for group Z into language B.

In some examples, an identifier accessible to a peripheral device may change. For example, a ground crew arriving at an airport may be provided an earcup storing a first ground crew ID which is attachable to a headphone. The first ground crew ID can be used for access to communication channels only available at a land-side area. When the ground crew attaches the earcup to the headphone, the headphone reads the first ground crew ID on the earcup. The headphone may receive the first ground crew ID from a land-side channel server (e.g., another headset in a land-side area used by a communication controller) that serves a land-side communication channel at the airport. Upon the match of the first ground crew ID, the headphone may initiate a pairing request for access to the land-side communication channel to the land-side channel server. The land-side channel server may grant the request to the land-side communication channel based on the first ground crew ID. Once the land-side channel server grants the request, the headphone starts participating in communication (e.g., audio communication) on the land-side communication channel.

In some examples, an identifier accessible to a peripheral device may change by detaching the hardware element and attaching a new hardware element. For example, in case of the ground crew, once the ground crew passes the security point, the ground crew may detach the earcup from the headphone and return the earcup. Responsive to the detachment of the earcup, the headphone may terminate access to the land-side communication channel. The ground crew may be provided a new earcup attachable to the headphone after passing the security point. The new earcup stores a second ground crew ID that can be used for access to communication channels only available at an air-side area inside the security point. When the ground crew attaches the new earcup to the headphone, the headphone reads the second ground crew ID on the new earcup. The headphone may receive the second ground crew ID from an air-side channel server (e.g., another headset in an air-side area used by a communication controller) that serves an air-side communication channel at the airport. Upon the match of the second ground crew ID, the headphone may initiate a pairing request for access to the air-side communication channel to the air-side channel server. The air-side channel server may grant the request to the air-side communication channel based on the second ground crew ID. Once the air-side channel server grants the request, the headphone starts participating in communication (e.g., audio communication) on the air-side communication channel.

In another example, an identifier stored on a hardware element may change by electronic communication, by a physical contact or a short range communication. For example, in case of the ground crew, once the ground crew passes the security point, an identifier manager server at the security point may communicate with the earcup using a short range communication, such as NFC or Bluetooth, to update the first ground crew ID stored on the earcup to the second ground crew ID that indicates that the headphone with the earcup attached has access to communication channels available to an air-side area inside the security point. In some examples, the earcup may provide an ID update notification that the second ground crew ID is a new identifier. In some examples, the headphone may be polling the identifier at a predetermined period and update an identifier for communication to the second ground crew ID upon reading the second ground crew ID. After the update, the headphone may terminate access to the land-side communication channel. The headphone may receive the second ground crew ID from an air-side channel server (e.g., another headset in a land-side area used by a communication controller) that serves an air-side communication channel at the airport. Upon determining the match of the second ground crew ID, the headphone may initiate a pairing request for access to the air-side communication channel to the air-side channel server. The air-side channel server may grant the request to the air-side communication channel based on the second ground crew ID. Once the air-side channel server grants the request, the headphone starts participating in communication (e.g., audio communication) on the air-side communication channel. However, if the same communication channel (e.g., physical connection setting) may be associated with different identifiers depending on the areas, and the air-side channel server sends the second ground crew ID on the same communication channel, the transition may be seamless without termination.

In another example, an identifier stored on a hardware element may continue to be the same, but the communication pairing may change. For example, in case of the ground crew, another ground crew approaches, and the headphone may receive the first ground crew ID with a pairing request from a headphone worn by another ground crew. Upon determining the match of the first ground crew ID, the headphone of the ground crew may accept the pairing request and grant access to the land-side communication channel to the headphone of the other ground crew. Then the headphone of the other ground crew may start communication on the land-side communication channel.

In another example, an access status of the communication channel may change. For example, in case of the ground crew, once the ground crew’s allocated time for a flight is over (e.g., the flight is departed), a channel server may terminate the granted access to a communication channel once given to the headphones attached to the earcup storing the first or second ground crew ID associated with ground crew members supporting the flight. The channel server may send a message indicative of expiration of the communication channel associated with the ID, and stops broadcasting the first or second ground crew ID. In an example, the channel server may terminate the communication channel. In another example, the channel server may allocate the communication channel for another team or members (e.g., ground crew members supporting another flight) having headphones being attached with ear cups that store a third ground crew ID). Then the channel server starts sending the third ground crew ID. Thus, the headphones may automatically access, or may be denied access a communication channel using the ID stored in the earcup.

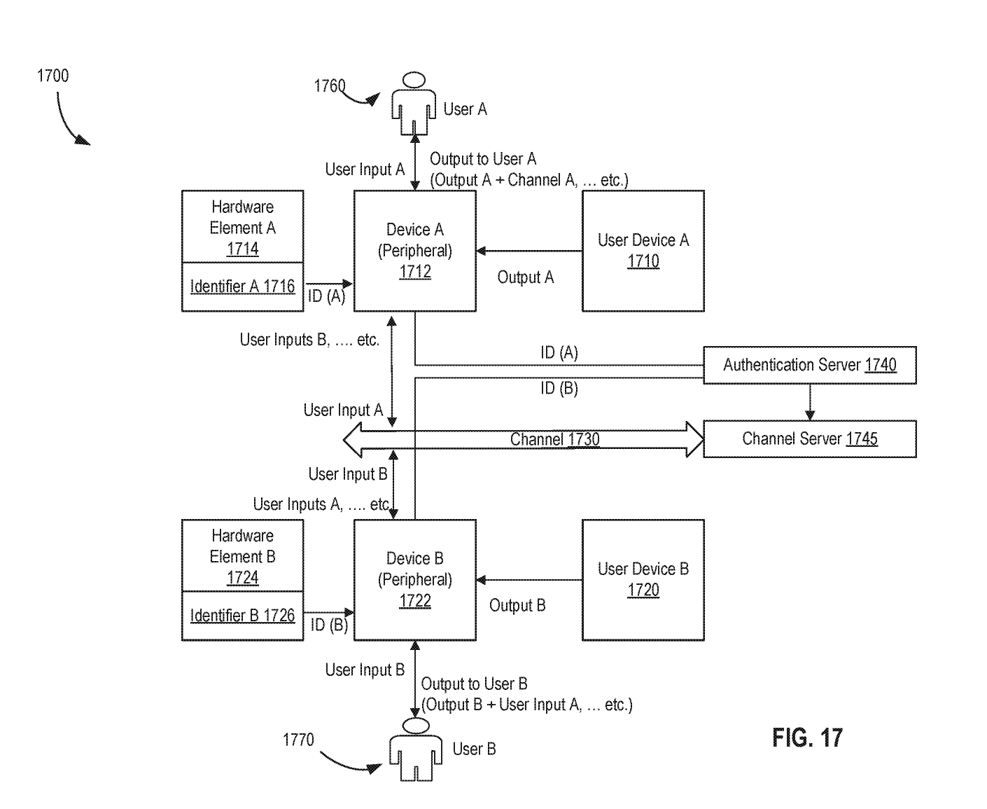

FIG. 17 is a block diagram of a communication system 1700, according to an embodiment of the present disclosure. Similarly to FIG. 15, a communication system 1700 is described as performing operations FIGS. 16A and 16B. In addition, some of the hardware elements and devices across the two example communication systems 1500 and 1700 are similar. Such similarities are not repeated herein in the interest of clarity of explanation.

The communication system 1700 may include an authentication server 1740. The authentication server 1740 may receive identifier A 1716 and identifier B 1726 stored in hardware element 1714 and hardware 1724 from the peripheral devices 1712 and 1722, respectively. The authentication server 1740 may authenticate each of the peripheral device 1712 and the peripheral device 1722 based on the received identifiers 1716 and 1726 individually. In some examples, the authentication server 1740 may notify a combination of an authenticated peripheral device and corresponding identifier to a channel server 1745. Based on the authentication, the channel server 1745 may provide a communication channel 1730 for access to the peripheral devices 1712 and 1722 individually, based on their identifiers. Thus, the peripheral device 1712 and the peripheral device 1722 may be granted access to the communication channel 1730, and can send and receive data, such as audio data, text data, or video data.

FIG. 18 is a block diagram of an example of a hardware system 1800 suitable for implementing a peripheral device, according to embodiments of the present disclosure. The computer system 1800 represents, for example, a peripheral device (e.g., a wearable device, a headphone, a headset, a video game controller, or any other device described herein, above) communicably coupled to a video game console or system, and further to a backend set of servers, or other types of a computer system as well as a hardware element. In some examples, the hardware system 1800 may be included in a headphone, a headset, an HMD, and the like. The computer system 1800 includes a central processing unit (CPU) 1805 for running software applications and optionally an operating system. The CPU 1805 may be made up of one or more homogeneous or heterogeneous processing cores. Memory 1810 stores applications and data for use by the CPU 1805 (including possible any program codes of applications described herein above). Storage 1815 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media (and may store any of the training data and/or user data described herein). User input devices 1820 communicate user inputs from one or more users to the computer system 1800, examples of which may include keyboards, mice, joysticks, touch pads, touch screens, still or video cameras, and/or microphones. Communication interface 1830 allows the computer system 1800 to communicate with other devices. The communication interface 1830 may include user device interface 1832, element interface 1834, and channel interface 1836. The user device interface 1832 may perform communication with a user device, such a video game console or a video game system and may include wired or wireless communication over local area networks. The element interface 1834 may perform communication with a hardware element, storing an identifier for automatic connection to a communication channel. The element interface 1834 may perform wired connection or wireless connection (e.g., NFC, Bluetooth) to receive an identifier from a hardware element, or a camera, a scanner, or a reader that electronically or optically obtains an identifier by reading or scanning. The channel interface 1836 may perform bi-directional or uni-directional communication via a communication channel, such as short range communication protocol compliant channel. An audio processor 1850 is adapted to generate analog or digital audio output from instructions and/or data provided by the CPU 1805, memory 1810, storage 1815, and/or communication interface 1830. User output devices 1840 provide outputs to one or more users, examples of which may include speakers, a display, or a tactile output. In some examples, one or more of the user input devices 1820 and one or more of the user output devices 1840 may be integrated (e.g., a touch display). The components of computer system 1800, including the CPU 1805, memory 1810, data storage 1815, user input devices 1820, communication interface 1830, user output devices 1840 and audio processor 1855 are connected via one or more data buses 1860.

In accordance with various embodiments, the CPU 1805 is one or more general-purpose microprocessors having one or more processing cores. Further embodiments can be implemented using one or more CPUs 1805 with microprocessor architectures specifically adapted for highly parallel and peripheral applications, such as media and interactive bidirectional communication applications.

The components of a system of the present disclosure can be connected via a network, which can be any combination of the following: the Internet, an IP network, an intranet, a wide-area network (WAN), a local-area network (LAN), a virtual private network (VPN), the Public Switched Telephone Network (PSTN), or any other type of network supporting data communication between devices described herein, in different embodiments. A network can include both wired and wireless connections, including optical links. Many other examples are possible and apparent to those skilled in the art in light of this disclosure. In the discussion herein, a network can or cannot be noted specifically.

Computer programs incorporating features of the present disclosure that can be implemented using program code can be encoded and stored on various computer readable storage media; suitable media include magnetic disk or tape, optical storage media such as compact disk (CD) or DVD, flash memory, and other non-transitory media. It is understood that “storage” of data is distinct from propagation of data using transitory media such as carrier waves. Computer readable media encoded with the program code can include an internal storage medium of a compatible electronic device and/or external storage media readable by the electronic device that can execute the code. In some instances, program code can be supplied to the electronic device via Internet download or other transmission paths.

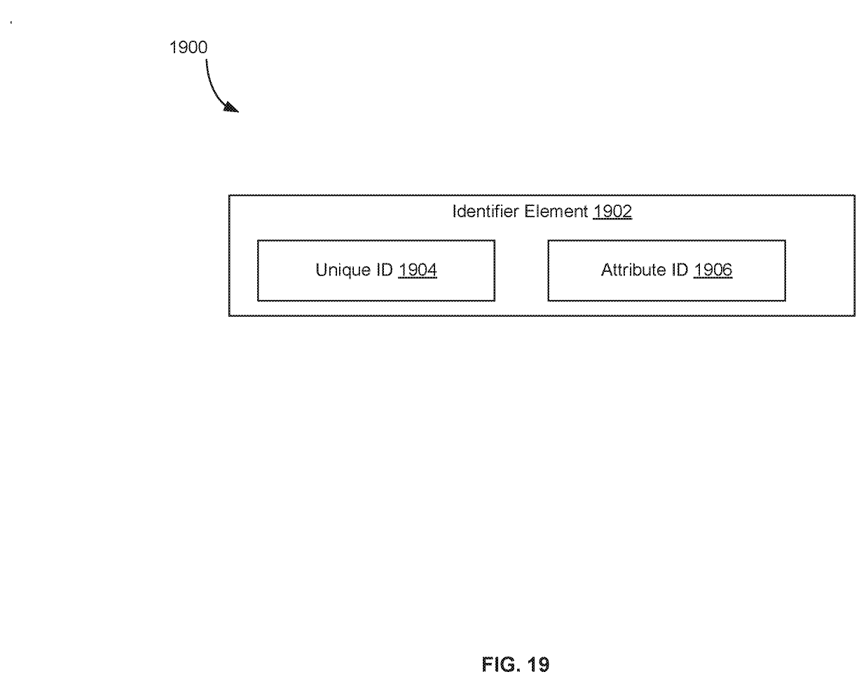

FIG. 19 is a block diagram of an identifier system 1900, according to an embodiment of the present disclosure. Similarly to FIGS. 15-8 with a peripheral device. Identifier system 1900 includes, as illustrated in FIG. 19, identifier element 1902. Identifier element 1902 may store one or more identifiers (IDs) usable as described herein above. Identifier element 192 may be a chip, such as an RFID chip, an NFC tag, a microprocessor chip, a memory or any other type of storage device that can store information that represents the one or more identifiers.

Identifier system 1900 describes an identifier architecture for attachable elements used in customizable, networked, or wearable device systems. Identifier system 1900 may enable precise distinction, tracking, and feature association for a given attachable element, supporting authentication, personalization, and dynamic control. Identifier system 1900 may be configured to associate an individual hardware element with a discrete identifier element 1902.

Identifier element 1902 may represent a digital or physical identifier structure associated with a hardware element, such as an earcup, decorative cover, or a smart accessory. In one example, identifier element 1902 may be an NFC tag embedded in a headphone earcup, holding both a unique serial number and a data field specifying a team or channel assignment for a multiplayer game. In a second example, identifier element 1902 may encode a QR code on a collectible keychain, where the code includes both uniqueness and attributes such as in-game power or cosmetic features. The information stored by identifier element 1902 may include multiple subfields. For example, identifier element 1902 may store a unique code, e.g. unique ID 1904. Additionally for example, identifier element 1902 may store an attribute ID 1906.

Unique ID 1904 may be distinguishable from other identifying codes that may be used among a plurality of elements. For example, unique ID 1904 corresponds to an individual player configuration distinct from other player configurations participating in a video game, such as for a personalized gaming experience. In some examples, unique ID 1904 represents a field within identifier element 1902 that encodes a globally or system-wide unique value. For example, unique ID 1904 corresponds to a team identifier organizing a subset of players from other players participating in a video game.

Unique ID 1904 may serve as a serial number, cryptographic hash, or manufacturer-issued code, ensuring that each physical or virtual element is individually distinguishable. In one example, unique ID 1904 may correspond to a manufacturer-assigned NFC chip ID, ensuring that each associated attachable element is identifiable by a distinct identifier for anti-counterfeiting and inventory purposes. In a second example, unique ID 1904 may be a blockchain-linked asset ID, enabling two or more users to trade or verify ownership of limited-edition in-game items through a distributed ledger.

Attribute ID 1906 may be configured as an attribute identifier. Attribute ID 1906 may represent a field within identifier element 1902 that encodes descriptive or functional characteristics of the element. Attribute ID 1906 may affect in-game controls, such as visual (cosmetics of a character), logical (e.g., some additional mobility or functionality of a character), or experiential (e.g., audible characteristics of how a character speaks or how auditory output of a user device, such as a video game console, is processed). Attribute ID 1906 may be a player specific ID (for personalized gaming, such as an individual, customized, or collectible attribute), a team ID (a shared attribute, such as in a multi-player scenario), a subscription specific ID (e.g., an application or in-game attribute accessible to a player as a result of a corresponding user being subscribed to a service, such as additional extra game features or controls), or a game ID (e.g., a trigger for a user device to initiate or launch a particular video game or feature). For example, attribute ID 1906 may specify team membership, color, feature set, or other properties relevant to device operation or user experience. In a subscription model, attribute ID 1906 may be provided by a peripheral device to a service provider via a user device to facilitate authentication of an active or valid subscription of the user with the service provider. Attribute ID 1906 may function as a trigger or otherwise cause a system to reconfigure one or more parameters of a user experience.

A user experience may include an experience delivered by a peripheral device (e.g. a gamepad, video game controller, headphones, speakers, a microphone, a camera, a mouse, a keyboard, a touch pen, a touch pad, a touch screen, an augmented/virtual reality headset, etc.) and/or a user device (e.g. a gaming console or other computing system). For example, attribute ID 1906 may indicate a feature to be changed for a player, such as adding, removing, or modifying a color, item, sprite, animation, sound, nonplayer character (NPC) companion, or other cosmetic associated with the player. Additionally for example, attribute ID 1906 may indicate one or more user preferences, such as indicating a configured audio equilibrium EQ setting, accessibility settings, a player character to be used in gameplay, etc.

In some examples, attribute ID 1906 may store a team assignment, such as “Team Blue” or “Team Red,” allowing multiple peripherals (such as communication devices including headphones with different earcups) to group into communication channels, such as for an esports event. Attribute ID 1906 may define access permissions, such as “VIP Access” to a selective user experience.

In some examples, a user may attach, reattach, or remove an attachable element including attribute ID 1906 to trigger an event. Trigger an event may be context specific. For example, a user with attribute ID 1906 may be associated with a specific team while attribute ID 1906 is attached to a peripheral device associated with the user. If the user is not active on the team, such as due to being eliminated from participating in a video game instance, tournament, or a period of inactivity, such as from not making any audio transmissions or not participating in a game, the user access, such as to audio communications, may be modified. For example, a change from active to inactive status, such as associated with disconnecting an attachable element, may result in the peripheral device disconnecting from or leaving a communication network. Such communication network may be associated with a video game instance. A user may also self-identify as inactive by removing an attachable element including attribute ID 1906. Such removal of the attachable element indicates to a peripheral device that attribute ID 1906 ceased being attached. Inactive status may modify access of a user to public audio stream, such as that of all users participating in a video game instance or tournament. Inactive status may prevent the user from transmitting an input, such as by causing the peripheral device to deactivate a microphone or chat function, or otherwise mute audio transmitted by the user. Inactive status may prevent the user from receiving outputs from other users within their group, such as by causing the peripheral device to deactivate a speaker or chat function, or otherwise mute audio transmitted by other users. Inactive status may selectively prevent the user from transmitting an input to members of a team of which the user was previously associated, such as within a time limit of having an attribute ID 1906 attached to a peripheral device. Inactive status may be triggered by an event transmitted by a user device, such as a gaming console, computing device, or mobile device.

An effect of an event triggered by attribute ID 1906 may persist while a user system reads the attribute ID 1906 as being active. For example, an added, removed, or modified color, item, sprite, animation, sound, NPC companion, or some cosmetic associated with the player or character provided execution of video game data is maintained in-game in response to a continued authentication indicating the attribute ID 1906 remains active, such as being coupled to a peripheral device. In some examples, an effect associated with attribute ID 1906 remains active in-game after an attachable element including attribute ID 1906 is removed from a peripheral device. Such persisted effect may be maintained for a threshold time, such as in accordance with a timeout policy. A persisted effect may be maintained until another hardware element, such as associated with a different identifier, is coupled to a peripheral device. For example, attribute ID 1906 remains active until another attribute ID is read by a user system.

In another example, a user device may trigger a modification of peripheral settings or parameters based on context information from the user device and a grouping associated with attribute ID 1906. For example, settings or parameters may include output characteristics of the peripheral, such as audio EQ, volume, relative 3D audio spatial position, etc. In some instances, the modification may selectively affect peripherals of other users sharing attribute ID 1906 based on the status of the user. For example, a user character within a video game instance and participating in a group based on attribute ID 1906 may be low on a particular resource (e.g., health, fuel, etc.), and as a result, their audio transmissions from a peripheral attached to attribute ID 1906 may be presented to other users in the group relatively increased volume.

In some examples, a user removing and reattaching a physical attachable element containing attribute ID 1906 may be a trigger to cause the user to shift positions within a 3D spatial network. For example, if the user was previously designated as a leader among other users within their group based on attribute ID 1906, removing and reattaching the associated attachable element containing attribute ID 1906 may demote the user from being a leader, promote another user as leader, and cause the user to be orientated within a 3D organization relative to the newly promoted leader and/or other users within the group.

In some examples, attribute ID 1906 may correspond to one or more setting or preferences associated with a user experience. Such a preference may indicate a particular channel to receive from a plurality of available audio channels, such as a team-specific channel where multiple teams may be communicating. A user preference associated with attribute ID 1906 may also indicate a language stream, such as where a multiplicity of users are within a shared space (e.g. a movie theater or museum) and capable of receiving audio in a variety of languages, attribute ID 1906 of identifier element 1902 within an attachable element attached to a device would indicate a discrete language selection for the device to receive. In an example, physically swapping an attachable element containing attribute ID 1906, e.g. attachable element 102, for another attachable element with a different attribute ID to a device, e.g. headphone 111, would result in a different audio stream being received at the device. An effect of an attachable element 102, such as a language selection to be streamed to a peripheral device or in-game action or modification, may persist conditionally on being coupled to a peripheral device, such as headphone 111. For example, an effect, such as a language stream, would be provided to headphone 111 by a broadcast device or user device in response to a periodic authentication or other provided indication of the attachable element 102 being coupled with headphone 111. An effect may persist after the attachable element 102 containing attribute ID 1906 is removed from a peripheral device, such as headphone 111. Such persisted or maintained may remain active for a threshold time, such as in accordance with a timeout policy. A persisted effect may be maintained until another hardware element associated with a different identifier is coupled to the peripheral device. For example, disconnecting attachable element 102 from the headphone 111 may maintain an English language audio, video, or text broadcast of data associated with an identifier of attachable element 102 until another attachable element with a different identifier, such as associated with another language, e.g., Spanish, is coupled to the peripheral device. In some examples, an effect associated with attribute ID 1906 within attachable element 102 may correspond to an in-game action or modification in a video game.

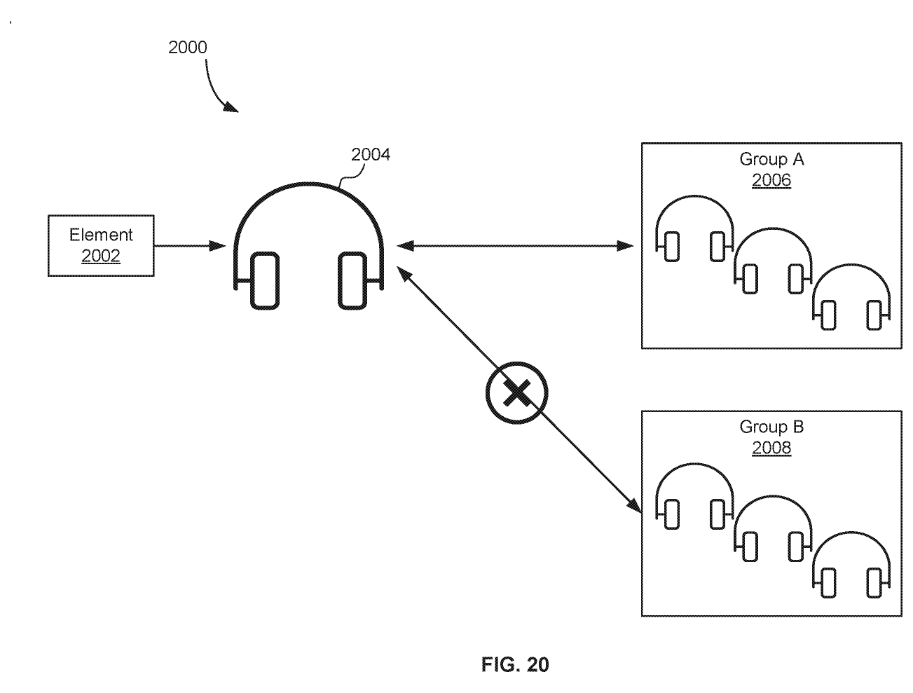

FIG. 20 is a block diagram of a grouping system 2000, according to an embodiment of the present disclosure. Similarly to FIGS. 15-19, grouping system 2000 includes an identifier element, such as element 2002. Element 2002 may be configured to store an identifier or “ID” as described in FIGS. 15-19.

Grouping system 2000 describes a group association and team assignment architecture for two or more peripheral devices. Such peripheral devices may utilize attachable elements for dynamic group configuration. Element 2002 may be an attachable element, such as to interface with a peripheral device. A peripheral device may be a wearable device, such as a headphone, to determine or control group membership among multiple devices in a network or event setting. Grouping system 2000 may support automated or user-driven assignment of one or more devices to groups, such as teams or communication channels, based on the properties or identifiers of the attached elements.

Grouping system 2000 represents an improvement to computing technology by enabling elements, e.g., element 2002, to encode attributes that may be used to quickly associate a peripheral device of a user with a discrete team of other users as distinguishable from one or more other teams of additional users. Element 2002 may be an attachable element to a peripheral device. Accordingly grouping system 2000 may enable a seamless, user-friendly experience for forming and modifying groups of devices, and their associated users, such as gaming headsets or audio receivers, by leveraging attachable elements that encode group or team attributes. This capability may underpin use cases in esports, collaborative environments, language-based channel assignments, or any domain where group membership needs to be rapidly and reliably determined by physical interaction with a wearable device. For example, an element 2002 may be associated with an English language audio stream and swapping for another element associated with another language, e.g., Spanish, attached to a peripheral would result in the different language stream being transmitted to the peripheral device.

Element 2002 may comprise a physical or digital accessory such as an attachable earcup, cover, badge, or NFC/RFID-tagged marker. Element 2002 may store or encode group membership, role, or feature attributes that determine how a wearable device interacts with other devices or networks. In one example, Element 2002 may be an NFC-enabled decorative earcup that encodes a “Team A” identifier, allowing a user to join a specific team or group by attaching the element to their headphones. In a second example, element 2002 may be a color-coded badge that encodes access to a specific audio channel or VIP group during a live event, with the group assignment determined by the embedded attribute.

Peripheral 2004 may comprise a wearable device, such as a gaming headset, audio receiver, or headphone. Peripheral 2004 may read group or attribute information from element 2002 and use that information to determine group membership or device behavior. In one example, peripheral 2004 may be equipped with an NFC reader that detects a group identifier, e.g., Group A 2006, from an attached earcup and automatically configures itself to communicate only with other devices in that group. In a second example, peripheral 2004 may reject or ignore group association if the attached element does not match a pre-approved configuration, ensuring that only authorized users join a private communication group. For example, a maximum number of users may be configured for a group based on information received from a user device, such as a gaming console or computing system.

Group A 2006 may comprise a logical or physical collection of two or more wearable devices, such as headsets, that have been assigned to the same group based on information received from their respective attached elements. Group A 2006 may support coordinated actions, communication, or privileges restricted to its members. In one example, Group A 2006 may represent a team in an esports tournament, where all members are automatically joined to the same in-game voice chat upon attachment of elements indicative of a Group A attribute to their headsets. In a second example, Group A 2006 may represent an audience subgroup in a theater, where all headphones in the group receive the same translated audio stream based on element-assigned language attributes.

Group B 2008 may comprise a separate logical or physical collection of two or more wearable devices, distinct from Group A 2006, with membership determined by the attributes of their attached elements. Group B 2008 may support independent communication channels, privileges, or experiences. In one example, Group B 2008 may represent an opposing team in a multiplayer video game instance, where attachment of a Group B element causes the headset to join a different communication channel or receive different audio cues in contrast to a Group A element. In a second example, Group B 2008 may represent another language group in a conference, where all devices in Group B 2008 receive a separate simultaneous interpretation stream.

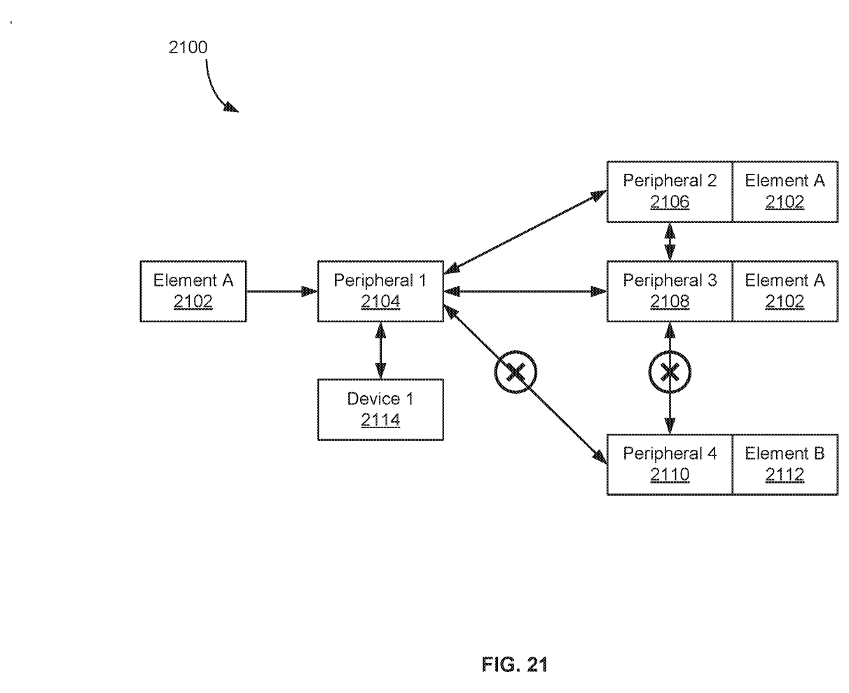

FIG. 21 is a block diagram of a network 2100, according to an embodiment of the present disclosure. Similarly to FIGS. 15-21, network 2100 maybe a mesh network or any other type of network that includes multiple devices communicating with each other. Communication between at least two devices of the network 2100 or setting up the network 2100 can be at least in part on an element A 2102. Element A 2102 may be an example of a hardware element (e.g., attachable element) that interfaces with a peripheral device of the network 2100 and configured to store identifier or “ID” as described in FIGS. 15-20.

Network 2100 describes a peer-based association and validation architecture for multiple peripherals and/or devices. Each peripheral may utilize one or more attachable elements for dynamic, decentralized group formation or access control. Each peripheral may receive element information from surrounding peripherals within a proximity. Each peripheral may receive network information based on information of one or more attachable elements within a proximity. Each peripheral may validate or reject group membership by comparing the identifiers of attached elements and the associated one or more groupings. For example, a peripheral may include logic to compare stored valid identifiers or format of identifiers with identifier information received by one or more elements. Network 2100 may support robust, real-time team configuration, channel joining, or access restriction by ensuring that only peripherals with matching identifiers are grouped together.

Network 2100 may be applied in a variety of use cases, such as rapid team assignment in eSports, secure access to language channels in event environments, and dynamic content customization for collaborative or competitive applications. The networked system may scale to support two or more peripherals, each associated with distinct devices and elements, enabling flexible, attribute-driven group control and validation.

Network 2100 may include two or more peripheral devices communicating directly with one another. Network 2100 may not rely on a central hub, router, or network switch to facilitate communications between two or more peripheral devices. Within network 2100, connected devices may each act as a relay, passing information from one device to another. In some examples, if one device connected to network 2100 is removed or fails, network 2100 may continue to function for other devices by routing information through other connected devices. Network 2100 may dynamically add or remove devices without disrupting overall connectivity. Devices in network 2100 may share information such as device identifiers, operational parameters, or user commands. Devices carrying network 2100 may be used to form groups, control access, or synchronize features among multiple devices. In some examples, each device of network 2100 may compare information received from other devices to determine eligibility for group membership of other devices.

Element A 2102 may comprise a physical or digital accessory capable of interfacing with a peripheral device. For example, Element A 2102 may be included in an attachable element such as an attachable earcup, smart badge, or NFC/RFID-tagged marker, designed to interface with an appropriate receptacle of a peripheral for identification or group assignment purposes. Element A 2102 may encode group membership, attribute, or role information that is interpreted by a peripheral device to determine eligibility for joining with other devices. In one example, Element A 2102 may be an NFC-enabled decorative earcup that encodes a “Team A” identifier, allowing any headset with this cup to join a designated Team A channel. In a second example, Element A 2102 may be a conference badge with an embedded RFID that grants VIP access to select audio streams or event areas.

For example, a person may be presenting a lecture in English and network A is broadcasting an audio stream corresponding to the lecture. Element A may be associated with an identifier to broadcast English audio to a coupled peripheral device, such as a headphone. In another example, Element A is associated with an identifier to broadcast a translation, e.g., Spanish, of the English lecture to a coupled peripheral device.

Peripheral 12104 may comprise a wearable accepting device, such as a gaming headset, VR receiver, or smart headphone, capable of reading and processing identifier elements from attached elements. Peripheral 1 2104 may compare its local identifier information with other peripherals to determine group membership or to establish or deny connections. In one example, Peripheral 1 2104 may be a gaming headset with an NFC reader that auto-joins a team channel upon detection of a matching identifier from Element A 2102. In a second example, Peripheral 1 2104 may refuse to synchronize or communicate with another peripheral if their attached identifier elements do not match, thus enforcing group exclusivity.

Device 12104 may comprise a host computing resource, such as a game console, PC, or mobile device, that interacts with Peripheral 12104 to provide application control, process identifier information, or manage group assignments. Device 1 2104 may receive user input/output and may coordinate group logic in conjunction with attached peripherals. In one example, Device 1 2104 may be a gaming console that uses identifier information from a connected headset to auto-assign players to a multiplayer team. In a second example, Device 1 2104 may be a mobile phone that receives group assignment data from a VR receiver and configures the application environment accordingly.

Peripheral 22106 may comprise an additional wearable accepting device, such as a second gaming headset or audio receiver, that also receives information from an attached Element A 2102. Peripheral 2 2106 may establish a valid communication or group association with Peripheral 12104 when their identifiers match. In one example, Peripheral 2 2106 may be another gaming headset that, after reading a matching team identifier from Element A 2102, joins the same team communication channel as Peripheral 12104. In a second example, Peripheral 2 2106 may be a language headset that allows pairing with other headsets sharing the same language identifier, enabling group translation or interpretation. For example, Peripheral 1 2104 receives an English language broadcast of a presentation while Peripheral 22106 receives a Spanish translation of the presentation.

Peripheral 32108 may comprise yet another wearable accepting device, which also receives information from an attached Element A 2102. Peripheral 3 2108 may be validated as eligible for group membership with Peripheral 12104 if their attached elements share the same identifier. In one example, Peripheral 32108 may be a third gaming headset, joining the same team as Peripheral 12104 and Peripheral 22106 upon matching identifiers. In a second example, Peripheral 3 2108 may enable classroom groupings, where students’ headphones with matching identifiers are allowed to join a collaborative audio session.

Peripheral 42110 may comprise a wearable accepting device that receives information from an attached Element B 2112, which encodes a different identifier than Element A 2102. Peripheral 4 2110 may be denied group association with Peripheral 1 2104, Peripheral 22106, or Peripheral 32108 due to identifier mismatch. In one example, Peripheral 4 2110 may be a gaming headset with a “Team B” identifier, excluded from “Team A” communications or privileges. In a second example, Peripheral 4 2110 may be an interpretation headset for a different language group, ensuring that only users with matching Element B 2112 receive the appropriate audio stream. Element B 2112 may comprise an accessory similar to Element A 2102, but with a different encoded identifier, such as a different team, language, or privilege group. Element B 2112 may be attached to Peripheral 4 2110 to enforce separation from peripherals with Element A 2102. In one example, Element B 2112 may be an NFC-enabled earcup labeled “Team B,” ensuring only headsets with this element can join Team B communications.

Based on sharing an attached Element A 2102 identifier, Peripheral 1 may create or join a group comprising Peripheral 2 and Peripheral 3. For example, Peripheral 1 may be the first to receive an Element A 2102 identifier and then, based on stored logic, be configured to create and broadcast a grouping identifier, such as Group A 2006. Consequently, Peripherals 2 and 3, based on also having an Element A 2102 identifier, may be configured to join the group created by Peripheral 1. In some examples, the peripheral that creates a grouping may indicate such to a device, such as device 1 2104, and such device may select a player character associated with peripheral 1 as the leader of the group.

In some examples, one or more audio equilibrium (EQ) settings of a peripheral device may be modified based on Element A 2102. For example, a first Element A 2102 to be used by a peripheral to create a group may be designated as a leader and/or assigned a central virtual position within a 3D spatial audio configuration. Subsequent peripherals to join the group based on having a shared attribute, e.g. Elemental A 2102, may be assigned discrete positions around the leader.

For example, Peripheral 22106 may be assigned a position that results in audio transmitted by Peripheral 22106 seeming to be from the right of a user associated with Peripheral 12104. Additionally, Peripheral 3 2108 may be assigned a position that results in audio transmitted by Peripheral 32108 seeming to be from the left of the user associated with Peripheral 12104. In such an example, audio received by Peripheral 3 from Peripherals 1 and 2 may seem to be from the right of the user associated with Peripheral 3 if peripherals are assigned according to a linear configuration. Alternatively, audio received by Peripheral 3 from Peripheral 1 may seem to be from the right of the user associated with Peripheral 3 while audio received by Peripheral 3 from Peripheral 2 may seem to be from the left of the user associated with Peripheral 3 if peripherals are assigned according to a circular or spherical configuration. Additional peripherals may be configured to seem as though they are oriented above or below, further left or right, or a combination thereof relative to a user of another peripheral.

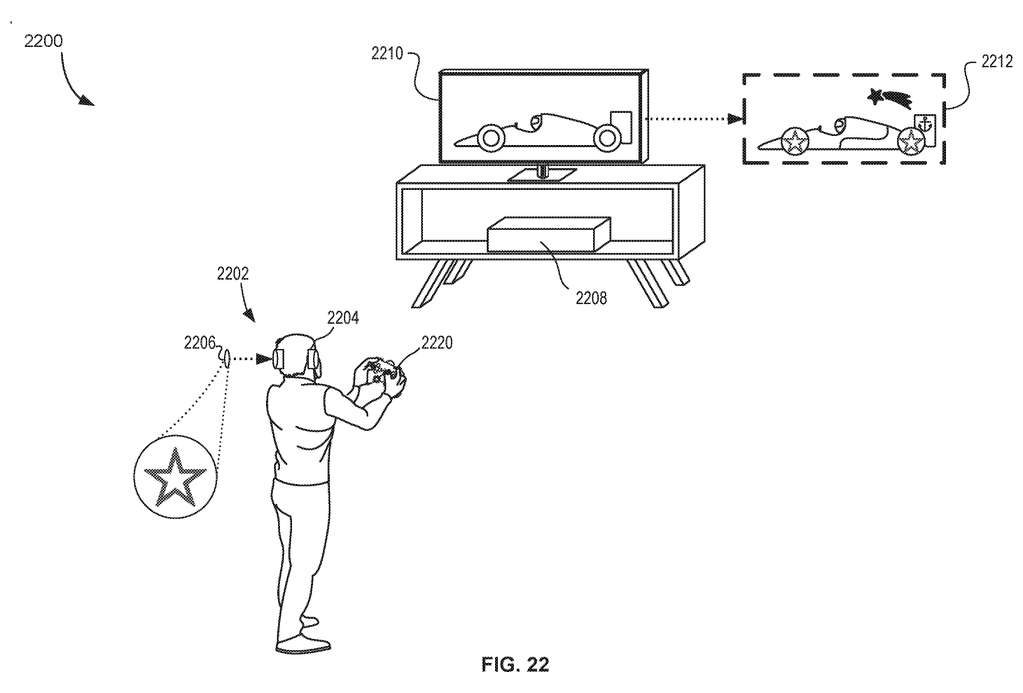

FIG. 22 illustrates a computer system 2200, according to an embodiment of the present disclosure. As illustrated, computer system 2200 includes a video game console 2208, a video game controller 2220, and a display 2210. Computer system 2200 may further include a peripheral device 2204 having an attachable element 2206 removably coupled thereto. One or more elements of FIG. 22 may be similarly configured to elements of shared characteristics described in FIG. 14.

Peripheral device 2204 may be a wearable device as otherwise described herein. Peripheral device 2204 may include any of a headset, headphones, earphones, other communication device, user interface device, etc., as described with respect to other figures. Further, attachable element 2206 may include a removable ear cup or wearable device accessory as described with respect to other figures. Peripheral device 2204 may include one or more attachable elements 2206, for example, one attachable element may be coupled to each ear cup of a wearable device. In other embodiments, attachable element 2206 may be removably coupled to other parts of peripheral device 2204.

Peripheral device 2204 may be an example of a device that interfaces with another device in support of some functionalities of another user device, such as video game console 2208. Peripheral device 2204 may be wearable or non-wearable. For example, a headset, a headphone with a microphone provides audio inputs/outputs to and/from a device, such as the video game console 2208 and is wearable. A combination of a standalone microphone and a standalone speaker or an audio system is another example of a peripheral device that provides the same functionalities but may not be wearable. In another example, video game controller 2220 is a peripheral device, where it can provide an input to control the execution of a video game application or video game instance, and can provide haptic feedback from the video game console 1410 about this execution. The video game controller 2220 may not be a wearable device. Other examples of peripheral devices to which the embodiments of the present disclosure similarly and equivalently apply include a virtual reality headset, an augmented reality headset, a mixed reality headset, a smart phone, a smartwatch or any other device that can provide input and/or receive an output of another device in support of one or more of functionalities of such a peripheral device. Accordingly, any of the embodiments as described with respect to FIGS. 1-14 may be implemented into an environment of FIG. 22 and computer system 2200.

In an embodiment, computer system 2200 describes an environment enabling selective bidirectional information flow based on physical objects and digital data, specifically leveraging peripheral devices configured to receive attachable elements bearing embedded identifiers. In an example, a user 2202 may attach an attachable element 2206 to a peripheral device 2204 associated with the user 2202. Attachable element 2206 may be a decorative earcup with an embedded identifier, such as an NFC tag, that is configured to interface with a peripheral device 2204, such as a headphone. When attachable element 2206 is in a proximity to peripheral device 2204, and peripheral device is in communication with a video game console 2208, an identifier obtained by peripheral device 2204 from attachable 2206 causes a video game application or instance executed by video game console 2208 to modify video game data. For example, video game data may present a display 2210 of an avatar to user 2202 and when attachable element 2206 becomes within a proximity to peripheral device 2204, video game data may be modified to present a modified display 2212 of the avatar with different attributes. Other examples of modified video game data to which the embodiments of the present disclosure similarly and equivalently apply include adding, removing, or modifying a color, item, sprite, animation, sound, nonplayer character (NPC) companion, or some cosmetic associated with the player. Additional examples of modified video game data to which the embodiments of the present disclosure similarly and equivalently apply include changed in-game resources, equipment, powers, capabilities, speed, special movements, abilities, skills, visibility, senses, or other performance characteristics of a player character or relative to other player characters in a video game application or instance.

Modified game data as a result of a coupled attachable element 2206 may persist while the attachable element 2206 is coupled to the peripheral device 2204. For example, an added, removed, or modified color, item, sprite, animation, sound, NPC companion, or some cosmetic associated with the player or character provided execution of video game data is in response to a continued authentication indicating the attachable element 2206 remains coupled to the peripheral device 2204, such as by a heartbeat connection protocol or other periodic signal indicative of continued connection. In other examples, an effect associated attachable element 2206 may persist in-game after the attachable element 2206 is removed from the peripheral device 2204. Such persisted effect may be maintained for a threshold time, such as in accordance with a timeout policy. A persisted effect may be maintained until another hardware element, such as associated with a different identifier, is coupled to the peripheral device 2204. For example, disconnecting attachable element 2206 from the peripheral device 2204 may maintain a player character selection until another hardware element with a different identifier associated with another character is coupled to the peripheral device 2204.

In an embodiment, a user 2202 may use attachable element 2206 to configure local network channels for coordinated team communication. For example, a team of users may use similar attachable elements, such as shared attribute identifiers, to quickly configure local network channels for selective communication among each other. Additionally for example, the attribute identifier may indicate one or more user preferences, such as indicating an audio equilibrium EQ setting, 3D spatial audio setting relative to one or more other users, accessibility setting, etc.

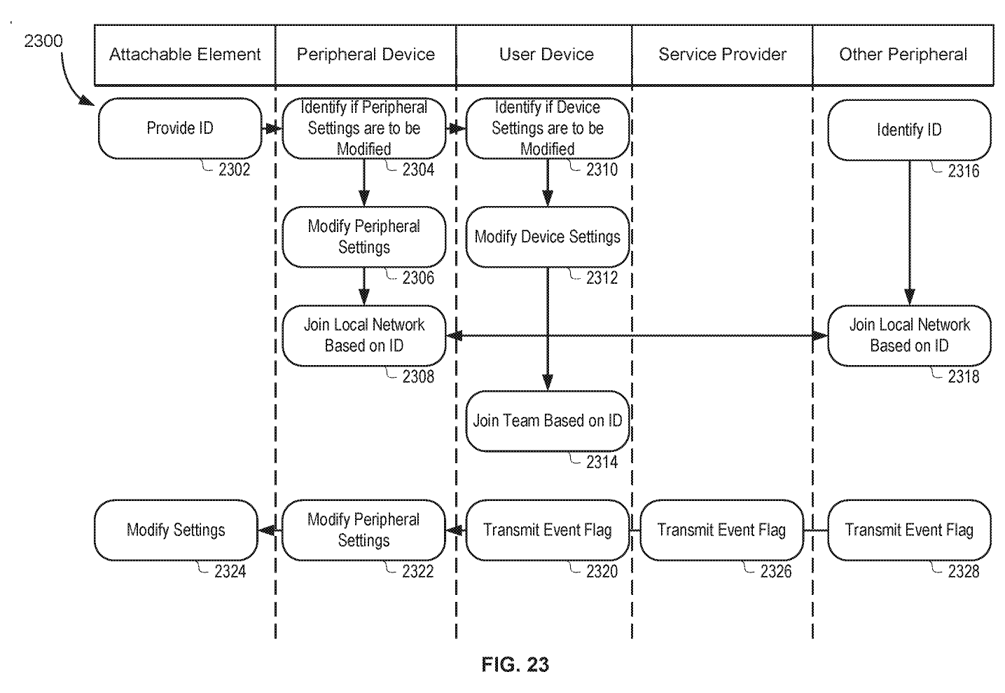

FIG. 23 illustrates a process 2300, according to an embodiment of the present disclosure. Process 2300 illustrates a method of dynamically modifying peripheral, device, and network states based on information provided by an attachable element in a networked interactive environment. Process 2300 may enable quick configuration of hardware and software for team-based communication, device personalization, and event-driven actions in entertainment, gaming, or professional contexts where peripheral devices are utilized, such as for audio communications. Process 2300 may involve a sequence of operations conducted across one or more attachable elements, peripherals (e.g., headphones), devices (e.g., video gaming consoles, computers, application host devices), service providers (e.g., cloud servers or game engines), and additional peripherals (e.g., as used by game teammates). Process 2300 describes a distributed workflow in which data originating from an attachable element triggers a series of detection, identification, and action steps across multiple system components.

In an embodiment, a peripheral device receives an identifier provided 2302 by an attachable element. An attachable element may supply an identifier to a connected peripheral or system, either physically or by a near-field proximity communication, such as a contactless short-range wireless technology. An attachable element may utilize embedded hardware such as an NFC tag or microchip to provide this identifier. In the context of the attached documents, the identifier may represent a team designation, user profile, or device attribute. In one example, provide ID 2302 occurs when an earcup with a unique NFC tag is snapped onto a headphone, instantly presenting the identifier to the peripheral. In another example, two or more attachable elements each provide unique identifiers to respective peripherals, enabling differentiated customization or grouping for multiple users.

In an embodiment, an attachable element may be configurable to receive instructions from a connected peripheral device to modify one or more features of the attachable element. For example, attachable element includes logic to pair with a peripheral device and receive information from the peripheral device, such as to configure one or more changeable elements on the attachable device. For example, a peripheral device may include one or more lights or displays, such as configurable RGB LEDs, and based upon one or more instructions from a peripheral device, adjust such changeable elements.

Based on an event flag, a peripheral device may modify settings of the peripheral device 2322. In some embodiments, a device may transmit an event flag 2320 to a peripheral device. For example, a video game application or instance may obtain or generate updated information related to gameplay experienced by a user that causes such an event flag. Updated information may indicate a changed status to gameplay, such as an indication of low resources, termination from a video game tournament, termination from a team, etc. Such modified peripheral device settings may include modifying audio EQ, volume, 3D audio spatial position relative to one or more other users, etc. In an embodiment, gameplay resulting in a user’s player having low or depleted health causes audio transmissions to and/or from the player to be muted relative to other users on the user’s team or otherwise participating or spectating gameplay.

In an embodiment, a peripheral device identifies whether peripheral settings are to be modified 2304 based on information obtained by an attachable element. A peripheral device, such as a headphone, may identify whether received information from the attachable element indicates changes to its own configuration. This identification may involve reading the identifier and referencing a mapping of valid configuration commands. For example, such mapping may be stored on the peripheral device, or need the peripheral device to communicate with a user device, service provider, or other peripheral device to establish any implicated changes. In one example, a headphone detects that an attribute ID from an attachable device corresponds to a specific equalization setting and causes an adjustment to audio output settings. In another example, two or more headphones identify that the same team ID has been provided, prompting simultaneous preparation by one or more peripheral devices for group communication settings, such as selecting an audio channel for team communications and broadcasting such information.

In an embodiment, a peripheral device modifies peripheral settings 2306, such as in response to a recognized identifier. Hardware of a peripheral device may include processors and memory resources capable of updating device parameters. In an example, a peripheral device as a headphone may change EQ presets, enabling or disabling noise cancellation, or changing LED states. Modifying peripheral settings 2306 may be switching a headphone into a gaming mode with spatial audio enabled. In another example, two or more peripherals update their color scheme or LED status to match a team designation for a live event or tournament. Two or more peripherals may propagate event flags for synchronized behavior in a multi-user environment. A peripheral device may begin initiating and begin broadcasting a network based on an attribute identifier obtained from an attachable element.

In an embodiment, a peripheral device may join a local network based on an ID 2308 obtained from an attachable element. A peripheral device may, after reading an identifier from an attachable element, connect to a specific local communication network or channel based on the identifier. A peripheral device may utilize hardware, such as Bluetooth, Wi-Fi, or other communication modules capable of dynamic pairing or group formation to join a local communication network. As such, a peripheral device enabled by an identifier from an attachable element may be able to rapidly form a team of users or select a channel for the team without a need for manual peripheral device configuration via a user device. For example, a headphone joins a “Team Red” local network, not dependent on a user device such as acting as a host device for executing a game play instance and chat broker, for voice chat upon detecting a red earcup. In another example, two or more peripherals simultaneously join a local network to receive synchronized audio or commands during a live event.

In an embodiment, a user device identifies if one or more device settings are to be modified 2310. A user device may be a video game console, computing device, or mobile device including logic to identify if information received, via a wired or wirelessly connected peripheral device, should trigger changes to a user device system-level configuration or to attributes of a video game application or instance. For example, a user device identifies that the provided ID should modify or otherwise alter a language setting related to audio generated by a video game application, such as switching from a default language setting, e.g., English to Spanish. In another example, two or more devices recognize a group-based identifier, prompting system-wide configuration for all members of a team or session based on an identifier provided by one or more attachable elements to respective one or more peripheral devices of one or more users on the team or in the session.

In an embodiment, a user device modifies one or more device settings 2312 based on configuration changes identified 2310 by the user device. A user device may update user, network, or application states in response to identified changes based on an identifier from an attachable element. For example, a user device may modify communication settings, user interface themes, or application launch or run parameters. In an example, a user device modifies device settings 2312 to change a user’s in-game settings to match a team loadout. In another example, two or more user devices update their display configuration to highlight currently active team members corresponding to other users with respective peripheral devices connected to attachable elements of shared attribute identifiers.

In an embodiment, a user device may join a team based on an ID 2314 obtained from an attachable element via a peripheral device. A user device may, after reading an identifier from an attachable element, cause a video game application or instance to associate an account or profile of a respective user with a team or group of the video game application or instance. As a result of being associated with a team, a respective user of the user device may receive or send communications, by a peripheral device of the user, with other user devices associated with the team. In an example, a user device enabled by an identifier from an attachable element provided via a peripheral device may be able to rapidly form a team of users or select a channel for the team without a need for manual peripheral device configuration via a user device. For example, a headphone joins a “Team Red” network for in-game voice chat upon detecting a red earcup.

In an embodiment, based on an attribute identifier via a peripheral device, another peripheral device of another user may identify the attribute identifier 2316. The other peripheral device may detect the attribute identifier, or an indication of the identifier, as being broadcast over a local network, such as enabled by a wired channel, a direct connection, a near-field communication channel, a Bluetooth channel, WiFi, or an over Internet connection. The other peripheral device may modify one or more device settings. For example, the other peripheral device joins a local network based on an identifier 2318. The other peripheral device may modify one or more device settings in response to joining the local network 2318, such as configuring a 3D spatial audio assignment for each team member on the local network. For example, the other peripheral device may configure 3D spatial audio received from a team leader as seeming to originate above the other user while other team members may be arranged to sound as if originating from below the other user and/or to the user’s left or right by varying degrees.

In an embodiment, a peripheral device may modify one or more peripheral settings 2322. Modifying peripheral settings 2322 may include an operation in which a peripheral device, having joined a network or been assigned a team, adjusts its configuration to reflect new group parameters. Such adjustments may involve changes to audio mixing, input/output behavior, or device locking. In one example, a headphone as a peripheral device of a team member who is not the leader increases the team leader’s audio volume. Based on an event, such as a team member status dropping below a threshold (e.g. player resources such as health drops below a threshold), audio transmission from that team member may be increased relative to other team members. In another example, two or more peripheral devices of two or more respective users activate a synchronized light pattern or color to visually represent team status. When one user’s gameplay resources (e.g. health, asset quantities, etc.) become depleted, an event flag may be transmitted from a user device 2320, service provider 2326, or another user’s peripheral device 2328 that modifies the user’s peripheral device settings, such as to activate or deactivate a synchronized light pattern or color shared by the other user’s peripheral devices.

In an embodiment, a peripheral device may provide instructions to modify settings of an attachable element 2324. For example, one or more lights on an attachable element may be caused to change their color or pattern, such as by logic or a processing unit executing instructions including within the attachable element. Such instructions may be obtained as a result of transmitted event flags from a user device 2320, service provider 2326, or another user’s peripheral device 2328.

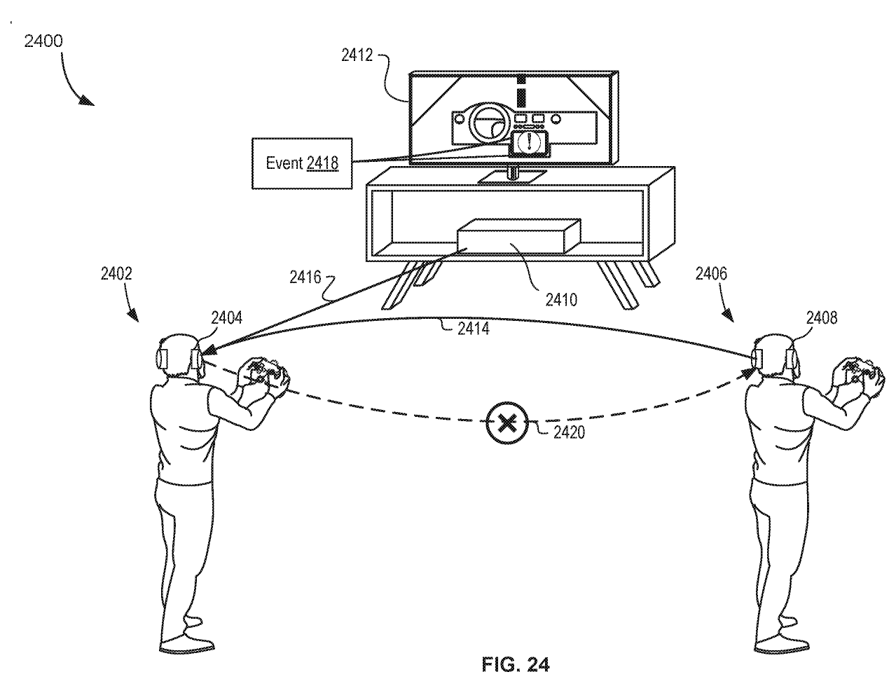

FIG. 24 illustrates a computer system 2400, according to an embodiment of the present disclosure. As illustrated, computer system 2400 includes a video game console 2408, a display 2410, a first peripheral device 2404 of a first user 2402, and a second peripheral device 2408 of a second user 2406. In some embodiments, first peripheral device 2405 and second peripheral device 2408 include an attachable element removably coupled thereto configured with an identifier. One or more elements of FIG. 24 may be similarly configured to elements of shared characteristics described in FIGS. 1-24.

Computer system 2400 illustrates a multi-user, networked interactive environment in which two or more users may utilize peripheral devices to participate in a shared experience via one or more video game consoles or computing devices. A shared experience may be provided by one user device, such as a video game console or computing device, shared by two or more users. In other examples, a shared experience is provided via multiple networked user devices corresponding to different users or groups of users. Computer system 2400 may include multiple user stations, one or more host consoles, and one or more display resources, all arranged to support synchronized gameplay, communication, or collaborative activities. Computer system 2400 may incorporate information transfer and event-driven interactions between users, peripherals, and host devices.

In an embodiment, computer system 2400 describes a scenario in which users interact with a shared application or game, and in which actions, events, or states may affect the connectivity or behavior of individual participants. Computer system 2400 may include a network by which peripheral devices are able to communicate with each other, such as via a video game console 2408 or other computing device. In some embodiments, peripheral devices may be part of a local network, such as by a wired channel, a direct connection, a near-field communication channel, a Bluetooth channel, WiFi, or an over Internet connection, facilitating direct communication between peripheral devices. For example, peripheral devices may be headphones configured to transmit and receive audio signals directly with other local headphones. In some embodiments, a networked event triggered in gameplay may mute or disconnect a user’s audio feed relative to other users, such as when a specific in-game outcome occurs. Such event may effectively change a bi-directional audio stream to one directional for one users or a group of users. In another example, a team-based event may propagate information to multiple users’ peripheral devices, causing synchronized feedback or status changes, which may result in modifications to audio settings of one or more peripheral devices.

A first peripheral device 2404 may be a communication device, such as wearable device, e.g., a headphone or headset worn by first user 2402. First peripheral device 2404 may be configured to receive attachable elements, read embedded identifiers, and exchange knowledge with other devices or a host console. First peripheral device 2404 may enable team-based communication with other peripheral devices within a proximity or otherwise part of a local network. First peripheral device may receive event-driven notifications or real-time status updates from a video game console 2408 or other computing device. A second peripheral device 2408 may be a similar device as first peripheral device 2404, or other communication device, such as accessibility communication devices, e.g., a speech-to-text display and keyboard.

Video game console 2408 describes a host computing resource that may execute an application game, or software. Video game console 2408 may execute shared application, game, or collaborative software for multiple users in one session and/or communicate with other video game consoles. Video game console 2408 may transmit updates to one or more peripheral devices, such as first peripheral 2404. Video game console 2408 may manage event detection of an executing application, status propagation among one or more peripheral devices, and update distribution across connected devices.

Display 2413 describes a visual output resource, such as a television or monitor, configured to present shared application, game, or event content. Display 2412 may be communicatively coupled to video game console 2410 and may update its output based on user actions, peripheral states, or detected events. In one example, Display 2412 visually indicates when a user is muted or disconnected due to an in-game event 2416. In another example, two or more displays present synchronized content in a multi-room or multi-user environment.

In an embodiment, first user 2402 interacts with physical and digital elements to influence the gameplay or collaborative environment. First user 2402 may participate in a multiplayer game hosted by video game console 2410 and communicate with other team members, e.g. second user 2406, through a local audio network, such as communication channel 2414. In an example, video game console 2408 detects an event 2416, such as a player account associated with first user 2402 being eliminated from a game, and triggers a mute event 2420 for audio transmissions from first user 2402. Such mute event may change an otherwise bi-directional audio stream to one directional.

Communication channel 2414 may include a data link or path between first peripheral device 2404 and second peripheral device 2408. Communication channel 2414 may support the transfer of identifiers, control signals, audio, or event information. In one example, Communication channel 2414 links auditory (e.g., microphone audio) transmissions between first peripheral device 2404 and second peripheral device 2408 for team chat.

Event 2418 may indicate a digital or physical occurrence recognized by Computer System 2400 that may trigger changes in user device, peripheral device, and/or application state. Event 2418 may be detected by video game console 2410, generated by a user action, or received from an external service. For example, event 2418 may correspond to an in-game occurrence, such as a player’s virtual elimination, a team achievement, or lack thereof, or a system-level notification. In an example, event 2418 interrupts transmissions from first peripheral device 2404 to second peripheral device 2408 as a result of first user 2404 being “out” in a game. Such interrupt may cause first peripheral device 2404 to mute a microphone or disable transmissions to one or more other peripheral devices. In an example, video game console 2410 detects an event 2418 and transmits an indication of event 2418 to first peripheral device 2404, where in response, first peripheral device 2404 modifies its settings, such as to mute a microphone or otherwise disable 2420 providing transmissions from first peripheral device 2404 to other users or team members.

Second peripheral device 2408 may receive event-driven information or status updates from video game console 2410 or from other users’ devices, such as first peripheral device 2404. In an example, video game console 2410 detects an event 2416 and transmits an indication of event 2418 to second peripheral device 2408, where in response, second peripheral device 2408 modifies its settings, such as to disable 2420 or mute received transmissions from first user 2402 and respective first peripheral device 2404.

Event 2418 may enable first user 2404 to continue receiving transmissions by communication channel 2414 from second user 2406 user despite being unable to provide their own transmissions. In another example, two or more events are triggered in response to collaborative tasks, resulting in group rewards or penalties. For example, one or more peripheral devices may be muted in response to their respective failing a task while subsequently succeeding at another task may then unmute the one or more peripheral devices.

Modified communication channel 2420 illustrates a modified, interrupted, or disabled peer-to-peer data path or link between peripheral devices in response to an event. In some examples, modified communication channel 2420 prevents two-way audio, chat, or other communicative coordination between users. In some examples, modified communication channel 2420 prevents one-way communications. For example, while modified communication channel 2420 interrupts or disables communication transmitted by peripheral device 2404 in response to an event 2418, peripheral device 2404 may continue to receive transmissions from other users, such as by communication channel 2414. In an embodiment, modified communication channel 2420 does not break or fully disconnect a peripheral device from a previously connected network, e.g. communication channel 2414. For example, modified communication channel 2420 represents that first user 2402 is effectively muted for second user 2406 as a result of an event 2418 of being “out,” but upon a character of first user 2402 being restored or revived triggering another event indicated by video console 2410, first user 2402 would no longer be muted. In another example, two or more communication channel links among users are dynamically managed by a lead peripheral device to support team-based or competitive scenarios, such as to modify EQ or 3D audio spatial settings of supporting users’ peripheral devices.

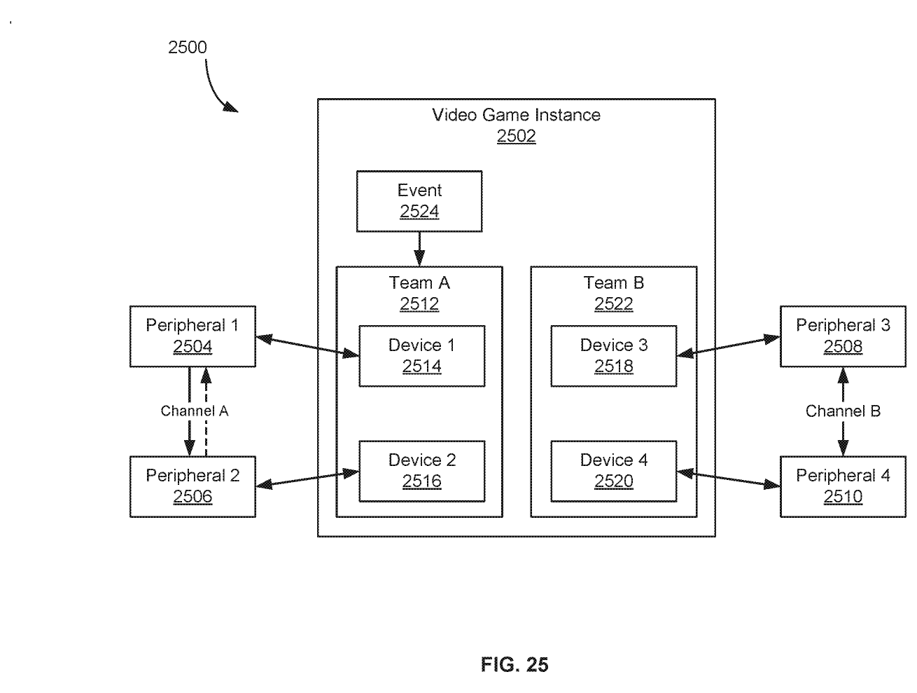

FIG. 25 is a block diagram of a communication system 2500, according to an embodiment of the present disclosure. Communication system 2500 may include a video game instance 2502 and two or more peripheral devices, such as peripherals 1-4, respectively 2504, 2506, 2508, and 2510. Communication system 2500 may be configured as a multi-team, multi-device networked environment in which peripherals and computing devices are organized into distinct teams of respective users, each team associated with a unique communication channel, based on a shared video game instance. Computer system 2500 may include several peripherals, one or more networked devices, and a centralized video game instance 2502 that manages team assignments, event triggers, and data routing among user devices and peripheral devices. Communication system 2500 may support dynamic reconfiguration of teams and channels based on in-game events or real-time user actions detected by one or more user devices based on video game instance 2502.

Computer system 2500 may be configured such that one or more peripherals are logically assigned to teams and channels through a video game instance, and in which devices may respond to or propagate in-game events to affect the behavior or connectivity of associated peripherals. In one example, an in-game event occurring within video game instance 2502, e.g. event 2524, may result in an instruction being transmitted to one or more devices of a team, e.g. device 2514 or device 2516 of team A 2512, to cause one or more peripheral devices, e.g. peripheral 1 1964 or peripheral 2 2506, to modify an audio output characteristic of a user. Such event may be the result of a user being eliminated from a match. As a result of an event, a peripheral device of an affected user may have their audio muted. In another example, two or more teams may be dynamically rebalanced or regrouped by the video game instance in response to a rule change or event, causing their associated peripherals to switch channels, update communication links, and/or modify EQ or 3D spatial audio settings.

In an embodiment, video game instance 2502 refers to a shared gaming environment or application executed by a processor of a computing resource based on one or more instructions stored in non-transitory memory. Video game instance 2502 may manage team assignments, event detection, and information flow between devices and peripherals. Video game instance 2502 may coordinate how team-based events affect each participant’s hardware, communication channel, and/or peripheral device. In one example, video game instance 2502 assigns new players to teams and configures their associated peripherals to join respective team audio channels. In another example, two or more video game instances synchronize their state across a distributed server environment to support multi-region tournaments.

Peripheral 12504 may be a hardware accessory such as a headphone, headset, or controller that is associated with a user. Peripheral 1 2504 may be capable of real-time communication with a device, e.g. Device 1 2514, or another peripheral. Peripheral 1 may be configured to join a specific channel, e.g., Channel A, for team communication. Peripheral 1 2504 may receive configuration or event information from Device 12514. Peripheral 1 2504 may relay a player’s status or team affiliation by a communication channel, e.g. Channel A, to other peripheral devices, e.g. Peripheral 2 2506, associated with the player’s team, e.g. Team A 2512. In one example, Peripheral 1 2504 automatically joins Channel A for Team A e.g. Peripheral 2 2506 voice communication. Peripheral 1 2504 and Peripheral 2 2506 may include similar attachable elements removably coupled thereto configured with an identifier to enable a shared communication channel, e.g. Channel A. In another example, two or more peripherals are configured to trigger synchronized LED effects when a team event occurs.

Peripheral 22506 refers to a second hardware accessory, similar to Peripheral 12504, associated with another user, capable of joining the same channel as Peripheral 12504 for intra-team communication, e.g., via Channel A for Team A 2512 shared data link. Peripheral 2 may receive information from Device 2 2516 and may be dynamically reconfigured by the game instance. In one example, Peripheral 2 2506 receives a modification command when its associated player experiences an in-game event, e.g., event 2524. Peripheral 2 2506 may be instructed by Device 2 2516 to mute audio transmitted by its associated player as a result of the player being eliminated from a match. In another example, Peripheral 2 2506 may be instructed by Peripheral 1 2504 to adjust EQ or 3D spatial audio settings received by Peripheral 1 2504 and/or transmitted by Peripheral 22506 to Peripheral 12504.

Peripheral 32508 may be a third hardware accessory, similar to Peripheral 12504, and assigned to a different team or otherwise connected to a separate channel, e.g., Channel B. Peripheral 3 may reflect its team membership via audio settings, visual status indicators, or connection to Device 3 2518. In one example, Peripheral 3 is configured to play only Team B 2522 communication audio. In another example, two or more peripherals on Channel B are muted simultaneously by a collective event such as a round-ending scenario.

Peripheral 42510 may be a fourth hardware accessory, similar to Peripheral 12504, paired with another user on Team B 2522, and connected to Channel B for team-specific communication. Peripheral 4 2510 may receive event or configuration information from Device 4 2520 and/or Peripheral 32508. In one example, lights of Peripheral 4 may be instructed to flash a warning indicator when Team B is at risk of losing, e.g. as a result of Device 4 2520 detecting changed resources associated with a player of a user of peripheral 2510. Changed resources, equipment, powers, capabilities, speed, special movements, abilities, skills, visibility, senses, or other performance characteristics experienced by a player during game play may function as a triggering event. In another example, two or more peripherals on Channel B are set to a “spectator” mode where their respective users can hear but not speak based on a game event.

Team A 2512 represents a logical grouping of devices and peripherals associated with a specific group of users within video game instance 2502. Team A 2512 may be dynamically created, modified, or disbanded based on user actions or events. Team A 2512 may include multiple devices that coordinate audio, visual, or control states for a shared objective. In one example, peripheral devices associated with Team A 2512 exchanged data such as user audio to enable strategic communication. In another example, two or more teams are merged or split as new players join or leave the game as indicated by a user’s respective peripheral device being powered on, including an identifier, etc.

Team B 2522 describes another logical group of devices and peripherals, similar but distinct from Team A 2512, within the same video game instance. Team B 2522 may operate on a separate channel and receive team-specific configuration or event data. Team B 2522 may be subject to different rules or events than Team A 2512. In one example, Team B receives a power-up event in a video game instance affecting only its members’ peripherals. In another example, two or more teams compete in a tournament, with Team B’s peripheral devices automatically switching to a new or exclusive channel upon players of Team B advancement to a new round, such as instructed by a user device, e.g. device 3 2518 or device 4 2520.

Device 12514 may be a computing device, such as a video game console, personal computing device, or mobile device, associated with a participant on Team A 2512. Device 1 2514 may manage the configuration, communication, and status of Peripheral 1. In some embodiments, device 1 2514 may additionally manage other peripheral devices of teammates, e.g. Peripheral 2 2506. Device 1 2514 may receive information from video game instance 2502 and propagate commands or events to associated one or more peripheral devices. In one example, Device 1 2514 processes a mute command for Peripheral 22506 relative to teammates including Peripheral 12504 when an event 2524 occurs. In another example, two or more devices coordinate to synchronize settings across team members. Device 2 2516 may be similarly configured as Device 1 2514. Device 2 2516 may manage Peripheral 2 2506 and relay team- or event-specific commands from video game instance 2502. In one example, Device 2 2506 signals Peripheral 2 to join or leave Channel A when a team change is triggered. In another example, two or more devices on Team A update their peripherals to reflect a new team color or insignia in response to a game event. For example, a device disables one or more microphones or speakers of one or more respective connected peripheral devices as a result of a penalty for members of the associated team.

Event 2524 describes a digital or physical occurrence detectable by video game instance 2502. Event 2524 may trigger changes in configuration, connectivity, or status for one or more teams, devices, or peripherals. Event 2524 may represent a player elimination, team penalty, power-up, or other significant game milestone. Event 2524 may be generated by user actions, system logic, or external inputs. In one example, Event 2524 mutes all peripherals on Team A when a time-out is called. In another example, two or more events trigger a channel swap for both Team A and Team B to mix up team composition for a new game round, such as triggered by changed attachable elements on respective peripheral devices.

In an embodiment, Event 2524 indicates an update to a player status causing an output characteristic of a peripheral device to be changed. For example, a depletion of an amount of a resource by user 1 may indicate a proportional decrease in output volume of user 1 that Peripheral 22506 presents to user 2. Event 2524 may indicate an environmental change within a video game instance. For example, as a result of a user navigating a corresponding character, avatar, or vehicle into a particular region or condition of a game play environment triggering Event 2524, such as entering a danger zone or water environment, settings of a peripheral, e.g. volume, EQ, etc., are adjusted. Adjustments may include a microphone input being muted, muffled, or garbled when presented to a video game instance or other connected peripheral device of another user. Event 2524 may cause audio from a first peripheral device to be presented as text to a game play instance or other peripheral device, such as consistent with an accessibility setting of a user who cannot hear, and vice versa.

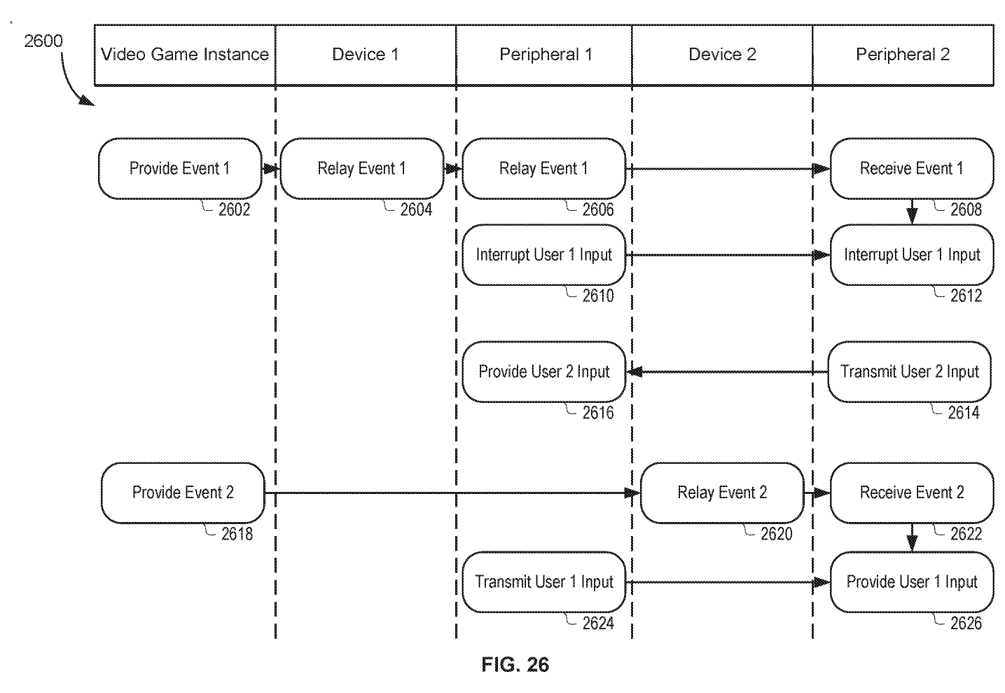

FIG. 26 illustrates a process 2600, according to an embodiment of the present disclosure. Process 2600 may include a method of dynamically modifying peripheral device states based on information indicated by a video game instance event in a networked environment. Process 2600 may enable quick configuration of hardware and software for dynamic team-based communication, device personalization, and event-driven actions in entertainment, gaming, or professional contexts where peripheral devices are utilized, such as for audio communications. Process 2600 may involve a sequence of operations conducted across one or more attachable elements, peripherals (e.g., headphones), devices (e.g., video gaming consoles, computers, application host devices), service providers (e.g., cloud servers or game engines), and additional peripherals (e.g., as used by game teammates). Process 2600 may enable a distributed workflow for processing effects of an event at peripheral devices. Process 2600 may orchestrate the detection, relay, and response to events and user inputs across a networked environment, supporting real-time interactivity, event-driven behavior, and synchronized user experiences. Process 2600 may include a video game instance, multiple user devices, and associated peripherals, each participating in event propagation and input handling.

In an embodiment, process 2600 includes a method by which a video game or compute instance generates events, which are relayed by user devices and peripherals, and in which peripherals may interrupt or process user input or output based on received events. In one example, a video game server generates an in-game event that causes a player’s microphone to be muted, with the event relayed through a user’s device to their peripheral, e.g., headphone, which interrupts an input audio stream.

In an embodiment, a video game instance provides 2602 Event 1 to a user device, e.g. device 1. A video game instance may be executing a local application or utilize a server or cloud-based game engine from which an in-game event triggers providing 2602 Event 1. A compute instance may comprise one or more processors, memory modules, and network interfaces capable of generating event notifications based on real-time application logic or user actions. An event may be a player elimination or team achievement affecting features of peripheral devices during subsequent gameplay and as such needs to be propagated to such peripherals. In one example, an event causes an instruction to one or more peripheral devices to mute a specific user’s audio stream after a player is out in a game while maintaining a connection to the specific user’s peripheral via the communication channel. In another example, one or more events are generated to trigger team-wide actions or rewards during collaborative gameplay, such as selecting enabling communications for a duration or period of time, modifying EQ settings (e.g., voice modulation effects), and/or modifying 3D spatial audio settings (e.g., modifying audio from one or more other players to seem directional).

A user device, e.g. Device 1, may relay 2604 Event 1 to a peripheral device. Device 1 may be a user device such as a console, PC, or mobile device, which receives Event 1 from a video game instance and relays the event to a corresponding peripheral associated with a user. Device 1 may include network interfaces and processing logic to interpret event messages and forward them to connected peripherals.

In an embodiment, Peripheral 1 relays 2606 Event 1 to another peripheral device, e.g., Peripheral 2. Peripheral 1 may be a wearable device such as a headphone or headset. Peripheral 1 may comprise processors, memory, and communication modules to receive, process, and broadcast event messages. Peripheral 1 may act on or propagate received events for local or networked processing. In one example, Peripheral 1 activates a local indicator (e.g., LED or haptic feedback) in response to a mute event, such as a mute event of a user associated with Peripheral 1 or a mute event for another user of another peripheral device. In some examples, two or more peripherals relay received events between connected team peripheral devices to ensure all team members receive synchronized instructions or status changes.

In an embodiment, Peripheral 2 receives 2608 Event 1. Peripheral 2 may receive 2608 Event 1 either directly from a user device executing a video game instance, or through peer-to-peer communication. Peripheral 2 may be a headphone, controller, or similar accessory equipped to process event data. Peripheral 2 may react to received events by altering its operational state. In one example, Peripheral 2 receives a command to mute its microphone as part of a player penalty. In another example, Peripheral 2 receives a command to mute its speaker as part of a team penalty. In another example, two or more peripherals receive and process the same event for consistent peripheral state management of respective team members across a team. In such an example, when Peripheral 1 receives an event indicating user 1 is to be muted, such event also causes Peripheral 2 to disable providing any audio received from user 1 to user 2.

In an embodiment, Peripheral 1 interrupts 2610 a transmission of user 1 input sent to Peripheral 2 of user 2. Input from user 1 may be user-generated input (e.g., audio, button presses, sensor data), such as obtained by input sensors, microphones, or control interfaces to capture and transmit user actions. As a result of Event 1, Peripheral 1 may mute its microphone to disable audio communications from user 1 to their team, e.g. including user 2.

In an embodiment, Peripheral 1 attempts to transmit user 1 input to Peripheral 2 of user 2 after Event 1, such as due to an error or hardware fault, and Peripheral 2 interrupts 2612 user 1 input delivery to user 2. Peripheral 2 may include logic to mute, filter, or adjust incoming data based on event-driven triggers. For example, Peripheral 2 disabled speaker output from transmissions received from user 1 as a result of Event 1.

In an embodiment, Event 1 dynamically affects peripheral devices implicated, such as muting all user inputs to peripheral devices associated with a team due to a penalty event. In another example, Event 1 selectively affects one user. For example, while Event 1 disabled user 1 inputs to Peripheral 2, user 2 transmits 2614 input by Peripheral 2 to Peripheral 1 and Peripheral 1 provides 2616 such user 2 input to user 1.

In an embodiment, an event triggering an instruction to modify or disable a communication stream between peripheral devices is self-canceling. For example, a self-canceling event may include an expiration time. In another example, effects of Event 1 are cancelled by a subsequent event, such as Event 2. Examples of Event 2 include a team reassignment, in-game bonuses granted to, or actions by, user 1 or teammates, e.g. user 2, detected by a video game instance. As such, the video game instance provides 2618 Event 2 to one or more user devices to propagate to one or more peripheral devices. Event 2 may also be triggered by a passphrase input by user 1 or teammates to the shared channel, etc. For example, Device 2 forwards an input from Peripheral 2 to the video game instance triggering Event 2.

In an embodiment, Device 2 relays 2620 Event 2 to Peripheral 2. In some examples, Peripheral 2 receives an indication of Event 2 by Device 1 or Peripheral 1. Device 2 may process, format, and distribute Event 2 data or information indicative of Event 2 data according to system protocols. In the context of the disclosure, this maintains system-wide synchronization.

In an embodiment, Peripheral 2 receives 2622 Event 2. Peripheral 2 may update its internal state or user interface respective of user 1 inputs in response to Event 2. Peripheral 2 may activate an audio effect upon receiving Event 2. When user 1 transmits 2624 input to Peripheral 2, Peripheral 2 provides 2626 such input to user 2. For example, Peripheral 2 may enable audio inputs received from user 1 to be provided to user 2 via speakers. Peripheral 1 may include logic to resume or modify input transmission as system states change, such as in response to Event 2. In one example, Peripheral 1 resumes voice chat after being unmuted by a system event.

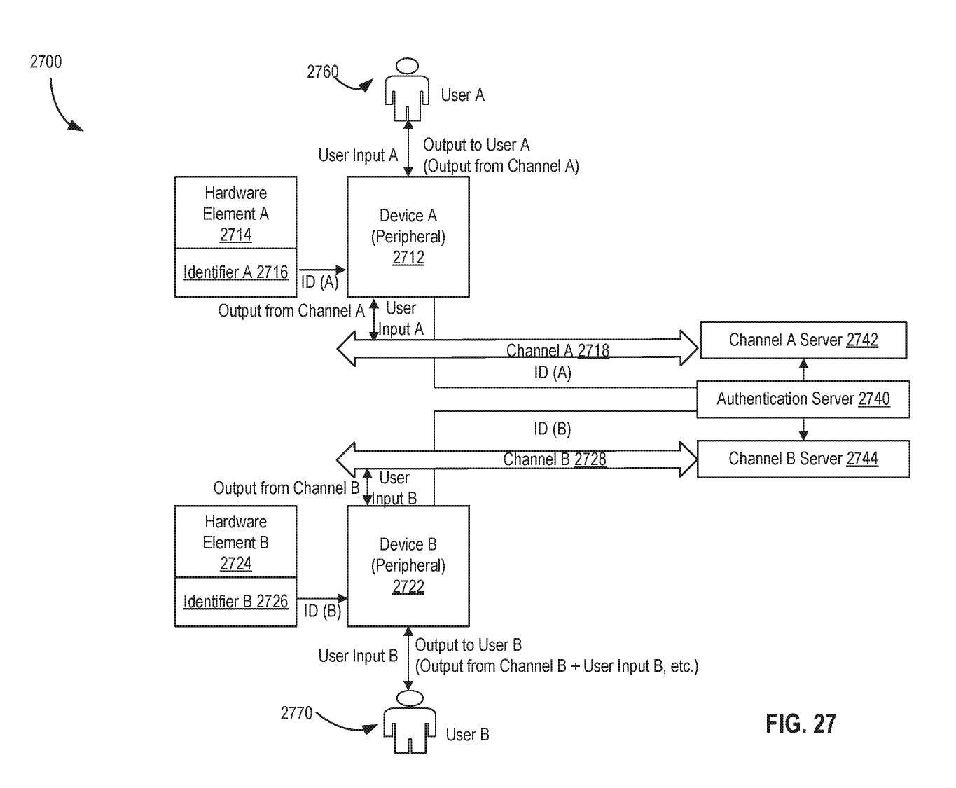

FIG. 27 is a block diagram of a communication system 2700, according to an embodiment of the present disclosure. Similarly to FIGS. 15 and FIG. 17, a communication system 2700 is described as performing operations FIGS. 16A and 16B. In addition, some of the hardware elements and devices across the two example communication systems 1500, 1700 and 2700 are similar. Such similarities are not repeated herein in the interest of clarity of explanation.

The communication system 2700 may include an authentication server 2740. The authentication server 2740 may receive identifier A 2716 and identifier B 2726 stored in hardware element 2714 and hardware element 2724 from the peripheral devices 2712 and 2722, respectively. The authentication server 2740 may authenticate each of the peripheral device 2712 and the peripheral device 2722 based on the received identifier 2716 indicative of Channel A and identifier 2726 indicative of Channel B individually. In some examples, the authentication server 2740 may notify a combination of an identifier of the authenticated peripheral device 2712 and corresponding identifier 2716 to a channel server 2742 that provides transmissions on a communication channel 2718 (Channel A). Based on the authentication, the channel server 2742 may provide the communication channel 2718 for access to the peripheral device 2712, based on the identifier 2716 indicative of Channel A. Similarly, the authentication server 2740 may notify a combination of an identifier of the authenticated peripheral device 2722 and corresponding identifier 2726 to a channel server 2744 that provides transmissions on a communication channel 2728 (Channel B). Based on the authentication, the channel server 2744 may provide the communication channel 2728 for access to the peripheral device 2722, based on the identifier 2726 indicative of Channel B. Thus, the peripheral device 2712 and the peripheral device 2722 may be granted access to respective communication channels 2718 and 2728, and can send and receive respective sets of data, such as audio data, text data, or video data. Thus, when the hardware 2714 is attached to the peripheral device 2712, upon the above authentication based on the identifier 2716, the peripheral device 2712 may be granted access to communications on the communication channel 2718, and when the hardware 2724 is attached to the peripheral device 2722, upon the above authentication based on the identifier 2726, the peripheral device 2722 may be granted access to communications on the communication channel 2728. For example, the communication channel 2718 (Channel A) may be provided for communication in English and communication channel 2728 (Channel B) may be provided for communication in Spanish. For example, when a user A 2760 attaches the hardware element 2714 to the peripheral device 2712, the user 2760 can participate in audio, text, or video communications in English using the peripheral device 2712 to receive and send data communication on the communication channel 2718, and when a user B 2770 attaches the hardware element 2724 to the peripheral device 2722, the user 2770 can participate in audio, text, or video communications in Spanish using the peripheral device 2722 to receive and send data communication on the communication channel 2728.

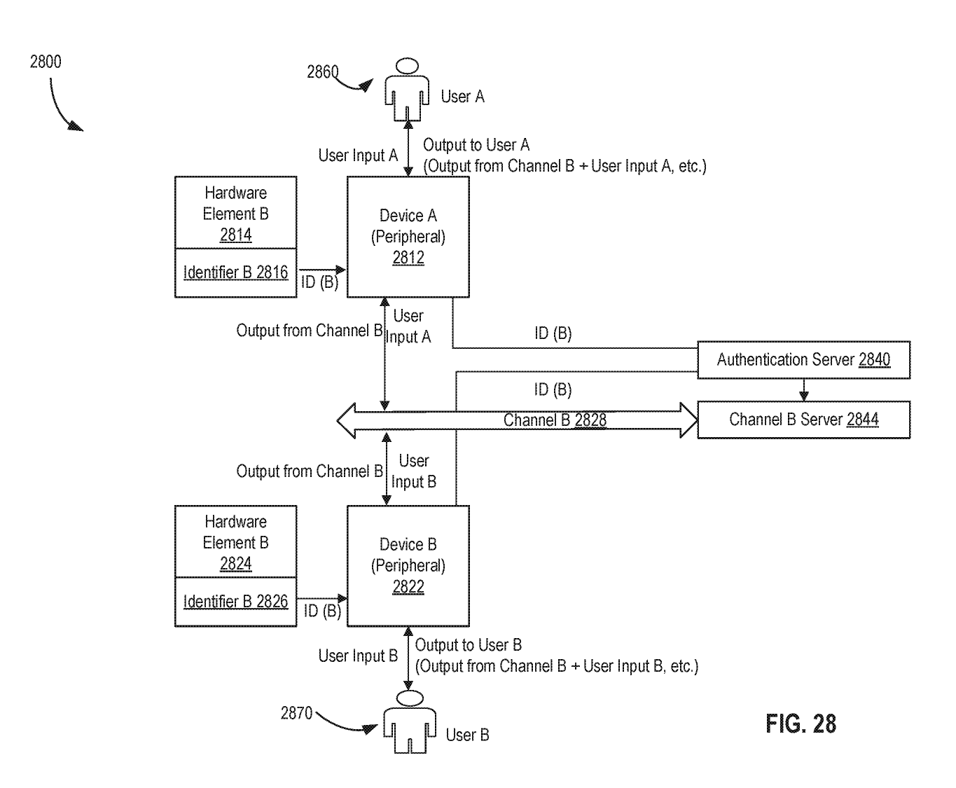

FIG. 28 is a block diagram of a communication system 2800, according to an embodiment of the present disclosure. Similarly to FIG. 27, a communication system 2800 is described as performing operations FIGS. 16A and 16B. In addition, some of the hardware elements and devices across the two example communication systems 1500, 1700, 2700 and 2800 are similar. Such similarities are not repeated herein in the interest of clarity of explanation.

The communication system 2800 may include an authentication server 2840. The authentication server 2840 may receive identifier A 2816 and identifier B 2826 stored in hardware element 2814 and hardware element 2824 from the peripheral devices 2812 and 2822, respectively. The authentication server 2840 may authenticate each of the peripheral device 2812 and the peripheral device 2822 based on the received identifiers 2816 and 2826, both indicative of Channel B individually. In some examples, the authentication server 2840 may notify a combination of an identifier of an authenticated peripheral device 2812 and corresponding identifier 2816 to a channel server 2844 that provides transmissions on a communication channel 2828 (Channel B). Based on the authentication, the channel server 2844 may provide the communication channel 2828 for access to the peripheral device 2812, based on the identifier 2816 indicative of Channel B. Similarly, the authentication server 2840 may notify a combination of an authenticated peripheral device 2822 and corresponding identifier 2826 to the channel server 2844. Based on the authentication, the channel server 2844 may provide the communication channel 2828 for access to the peripheral device 2822, based on the identifier 2826 indicative of Channel B. Thus, the peripheral devices 2812 and 2822 may be granted access to the communication channel 2828, and can send and receive respective sets of data, such as audio data, text data, or video data. Thus, when hardware including an identifier indicative of channel B is attached to a peripheral device, upon the above authentication based on the identifier, the peripheral device may be granted access to communications on the communication channel 2828 (channel B).

In some examples, the peripheral device 2812 may be the peripheral device 2712 of FIG. 27. In one example, when the hardware element 2714 is detached from the peripheral device 2712 (2812), the peripheral device 2712 (2812) may maintain a channel communication in English through the communication channel 2718. In another example, when the hardware element 2714 is detached from the peripheral device 2712 (2812), the peripheral device 2712 (2812) may be disconnected from communication channel 2718 and lose the channel communication in English through the communication channel 2718. When the hardware element 2814 is attached to the peripheral device 2712 (2812), the communication channel 2828 (Channel B) may be provided for communication in Spanish.

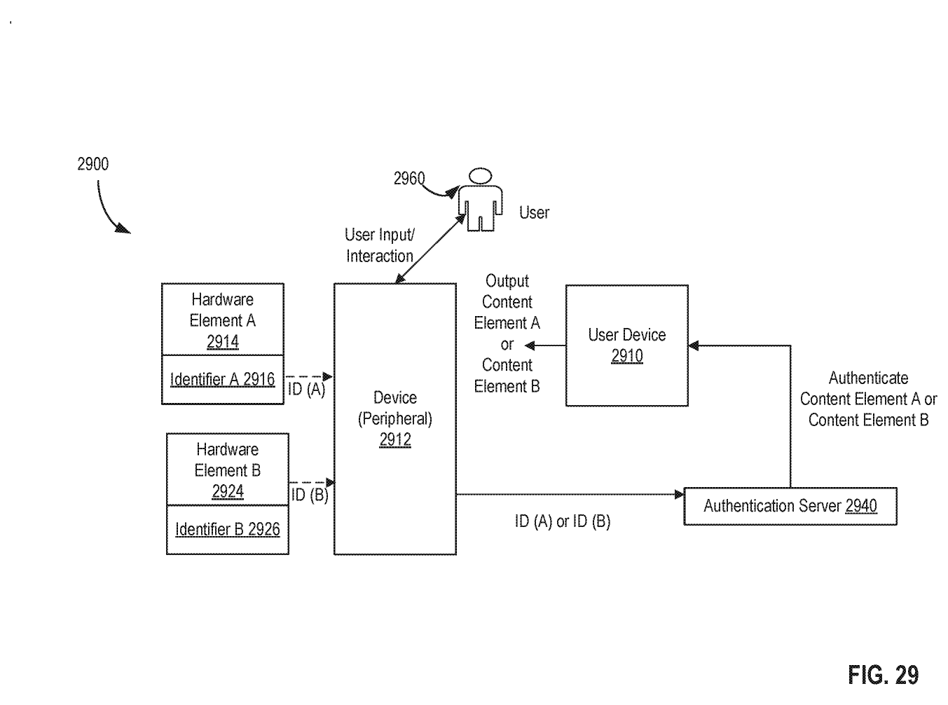

FIG. 29 is a block diagram of a communication system 2900, according to an embodiment of the present disclosure. Similarly to FIGS. 15 and 17, a communication system 2900 is described as performing operations FIGS. 16A and 16B. In addition, some of the hardware elements and devices across the two example communication systems 1500, 1700 and 2900 are similar. Such similarities are not repeated herein in the interest of clarity of explanation.

The communication system 2900 may include an authentication server 2940. The authentication server 2940 may receive identifier stored in hardware element attached to a peripheral device 2912. In one example, when hardware element 2914 storing identifier 2916 (ID (A)) may be attached to the peripheral device 2912, then the peripheral device 2912 may provide the authentication server 2940 with the identifier 2916 (ID(A)). In another example, when hardware element 2924 storing identifier 2926 (ID (B)) may be attached to the peripheral device 2912, then the peripheral device 2912 may provide the authentication server 2940 with the identifier 2926 (ID(B)). In some examples, the authentication server 2940 may authenticate either content element A or content element B to be used by a user device 2910. Based on the authentication, the user device 2910 may provide content including content element A or content B. For example, the content element A or the content element B may be attribute of a player character, and video game data of the user device 2910 may be modified to present a modified display of an avatar that is the player character with different attributes associated with the content element A showing one type of a game character or the content element B showing another type of a game character. When a user 2960 attaches the hardware element 2914 with an identifier 2916 indicative of a warrior type, and the user 2960 controls the peripheral device 2912 to start authentication, the peripheral device 2912 may provide the identifier 2916 indicative of the warrior type to the authentication server 2940. The authentication server 2940 may authenticate the warrior type content element, and a player character in game instances executed in the user device 2910 may be changed to a warrior type. When the user 2960 attaches the hardware element 2924 with an identifier 2926 indicative of a heroin type, and the user 2960 controls the peripheral device 2912 to start authentication, the peripheral device 2912 may provide the identifier 2926 indicative of the warrior type to the authentication server 2940. The authentication server 2940 may authenticate the heroin type content element, and the player character in the game instances executed in the user device 2910 may be changed to a heroin type. Other examples of modified video game data to which the embodiments of the present disclosure similarly and equivalently apply include adding, removing, or modifying a color, item, sprite, animation, sound, language, nonplayer character (NPC) companion, or some cosmetic associated with the player. Additional examples of modified video game data to which the embodiments of the present disclosure similarly and equivalently apply include changed in-game resources, equipment, powers, capabilities, speed, special movements, abilities, skills, visibility, senses, or other performance characteristics of a player character or relative to other player characters in a video game application or instance.

### Examples

The disclosure can include at least one or more of the following examples:

Example 1. A system 100, comprising: an attachable element 102 carrying an identifier 104 the identifier having ID number 106; a wearable accepting device 110 configured for accepting the attachable element 102 carrying the identifier 104, comprising:

a reader 112 configured to read the identifier 104 carried by the attachable element 102 and determine ID number 106; and a wearable accepting device processor 114 executing wearable accepting device software 116 configured for receiving ID number 106 from the reader 112 and taking an action in the wearable accepting device 110.

Example 2. The system 100 of example 1, wherein taking the action in the wearable accepting device 110 includes verifying validity of ID number 106.

Example 3. The system 100 of example 1, wherein taking the action in the wearable accepting device 110 includes modifying wearable accepting device software 116 in the wearable accepting device 110.

Example 4. The system 100 of example 1, wherein taking the action in the wearable accepting device 110 includes transmitting information from the reader 112 to the identifier 104 to change information in the identifier 104, including modifying ID number 106.

Example 5. The system 100 of example 1, wherein the wearable accepting device 110 is a headphone 111.

Example 6. The system 100 of example 5, wherein taking the action in the wearable accepting device 110 includes modifying acoustic parameters of the headphone 111.

Example 7. The system 100 of example 6, wherein modifying acoustic parameters of the headphone 111 includes modifying frequency response of the headphone 111.

Example 8. The system of example 1, wherein the attachable element 102 carrying the identifier 104 is detachable from the wearable accepting device 110.

Example 9. The system of example 1, wherein the wearable accepting device 110 for accepting the attachable element 102 is at least one of a headphone, headset, earbud, earpiece, in-ear headphone, on-ear headphone, over-the-ear headphone, hang-from-the-ear headphone, earcup, headband, wearable computer, wearable mobile phone, or wearable keychain.

Example 10. The system of example 1, wherein the attachable element carrying the identifier is at least one of a decorative cover, sticker, headphone cover, headset cover, earcup cover, earbud cover, earpiece cover, keychain, keychain attachment, or figurine.

Example 11. The system of example 1, wherein the identifier 104 is at least one of a single unique identifier, one of a group of unique identifiers, or a non-unique identifier.

Example 12. The system of example 1, wherein ID number 106 is at least one of a single unique ID number, one of a group of unique ID numbers, or a non-unique ID number.

Example 13. The system of example 1, wherein the identifier 104 is at least one of an unencrypted identifier, encrypted identifier, hashed identifier, RFID (Radio Frequency Identification) tag, Electronic Product Code (EPC), electronic circuit, microchip, integrated circuit, antenna, substrate, active identifier, semi-passive identifier, passive identifier, or inductively coupled identifier.

Example 14. The system of example 1, wherein the reader 112 is configured to read the identifier 104 using a connection of at least one of wired, direct connection, near-field communications, Bluetooth, Internet, optical, inductively coupled, magnetic field induction, electromagnetic, capacitively coupled, or wireless.

Example 15. The system 100 of example 1, further comprising host 404 having host processor 406 executing host software 408, wherein taking the action in the wearable accepting device 110 includes communicating message 118 corresponding to ID number 106 over first communications link 402 from the wearable accepting device 110 to host processor 406 executing host software 408, and wherein host processor 406 is configured for receiving message 118 corresponding to ID number 106 and triggering an event in host 404 based on message 118 corresponding to ID number 106.

Example 16. The system of example 15, wherein first communications link 402 is at least one of wired, direct connection, near-field communications, Bluetooth, Internet, optical, inductively coupled, magnetic field induction, electromagnetic, capacitively coupled, or wireless.

Example 17. The system 100 of example 15, wherein triggering the event in host 404 based on message 118 corresponding to ID number 106 includes verifying validity of ID number 106 from message 118.

Example 18. The system 100 of example 15, wherein triggering the event in host 404 based on message 118 corresponding to ID number 106 includes modifying host software 408 in host 404 correlated to ID number 106.

Example 19. The system 100 of example 18, wherein host processor 406 is executing host game 410 and wherein modifying host software 408 in host 404 correlated to ID number 106 changes characteristics of host game 410 in correlation to ID number 106.

Example 20. The system 100 of example 19, wherein changes characteristics of host game 410 is at least one of changing characters in host game 410, changing characters’ characteristics in host game 410, granting powers, giving equipment, providing resources, providing capabilities, providing assets, providing weapons, improving speed, providing special movements, increasing skills, creating invisibility, enabling enhanced senses, enabling access to other player information, modifying interactions, modifying interactions with other players, and increasing physical capabilities.

Example 21. The system of example 18, further comprising game engine 504, wherein triggering the event in host 404 based on message 118 corresponding to ID number 106 includes sending information 412 corresponding to ID number 106 from host 404 to game engine 504 over second communications link 502, and wherein game engine 504 is configured for receiving the information corresponding to ID number 106 and causing the interrupt in game engine 504 based on information corresponding to ID number 106.

Example 22. The system 100 of example 21, wherein causing the interrupt in game engine 504 based on information 412 corresponding to ID number 106 includes verifying validity of ID number 106 in game engine 504 based on information 412 corresponding to ID number 106.

Example 23. The system 100 of example 21, wherein causing the interrupt in game engine 504 based on information 412 corresponding to ID number 106 includes modifying game engine software 508 in game engine 504 in a manner that is correlated to ID number 106.

Example 24. The system 100 of example 23, wherein causing the interrupt in game engine 504 based on information 412 corresponding to ID number 106 includes modifying game engine software 508 that changes characteristics of game engine game 510 in correlation to ID number 106.

Example 25. The system 100 of example 24, wherein changes characteristics of game engine game 510 is at least one of changing characters in game engine game 510, changing characters’ characteristics in game engine game 510, granting powers, giving equipment, providing resources, providing capabilities, providing assets, providing weapons, improving speed, providing special movements, increasing skills, creating invisibility, enabling enhanced senses, enabling access to other player information, modifying interactions, modifying interactions with other players, and increasing physical capabilities.

Example 26. The system of example 1, further comprising game engine 504, wherein taking the action in the wearable accepting device 110 includes sending signal 618 corresponding to ID number 106 from the wearable accepting device 110 to game engine 504 over third communications link 602, and wherein game engine 504 is configured for receiving signal 618 corresponding to ID number 106 and causing the interrupt in game engine 504 based on information corresponding to ID number 106.

Example 27. The system 100 of example 26, wherein causing the interrupt in game engine 504 based on signal 618 corresponding to ID number 106 includes verifying validity of ID number 106 in game engine 504 based on signal 618 corresponding to ID number 106.

Example 28. The system 100 of example 26, wherein causing the interrupt in game engine 504 based on signal 618 corresponding to ID number 106 includes modifying game engine software 508 in game engine 504 in a manner that is correlated to ID number 106.

Example 29. The system 100 of example 26, wherein causing the interrupt in game engine 504 based on signal 618 corresponding to ID number 106 includes modifying game engine software 508 that changes characteristics of game engine game 510 in correlation to ID number 106.

Example 30. The system 100 of example 29, wherein changes characteristics of game engine game 510 is at least one of changing characters in game engine game 510, changing characters’ characteristics in game engine game 510, granting powers, giving equipment, providing resources, providing capabilities, providing assets, providing weapons, improving speed, providing special movements, increasing skills, creating invisibility, enabling enhanced senses, enabling access to other player information, modifying interactions, modifying interactions with other players, changing game dynamics, and increasing physical capabilities.

Example 31. The system 100 of Example 1, further comprising network 718, wherein taking the action in the wearable accepting device 110 includes verifying validity of ID number 106 over fourth comms link 702 with messages 704 through network 718 and over seventh comms link 714 to game database 720, wherein game database 720, communicates back to the wearable accepting device 110 with responses 716 including at least one of verifying identifiers, returning info on actions, interactions, triggers, interrupts, and signals to the wearable accepting device 110.

Example 32. The system 100 of Example 31, wherein host 404 communicating over fifth comms link 706 with data 708 through network 718 includes verifying validity of ID number 106 through network 718 and over seventh comms link 714 to game database 720, wherein game database 720, communicates back to host 404 with responses 716 including at least one of verifying identifiers, returning info on actions, interactions, triggers, interrupts, and signals, modifying characteristics of host game 410, including modifying characteristics of host game 410 dynamically for specific time periods and durations.

Example 33. The system 100 of Example 32, wherein game engine 504 communication over sixth comms link 710 with interrupts 712 through network 718 includes verifying validity of ID number 106 through network 718 and over seventh comms link 714 to game database 720, wherein game database 720, communicates back to game engine 504 with responses 716 including at least one of verifying identifiers, returning info on actions, interactions, triggers, interrupts, and signals, modifying characteristics of game engine game 510, including modifying characteristics of game engine game 510 dynamically for specific time periods and durations.

Example 34. An attachable element 102 comprising: An attachable member 103 configured to attach to a headphone 111, the attachable member carrying an identifier 104.

Example 35. The attachable element 102 of example 34, wherein the attachable element 102 is detachable from the headphone 111.

Example 36. The attachable element 102 of example 34, wherein the identifier 104 is at least one of: affixed to, adhered to, attached to, embedded in, or embedded within, the attachable member 103.

Example 37. The attachable element 102 of example 34, wherein the identifier 104 is at least one of a single unique identifier, one of a group of unique identifiers, or a non-unique identifier.

Example 38. The attachable element 102 of example 33, wherein the identifier 104 is at least one of an unencrypted identifier, encrypted identifier, hashed identifier, RFID (Radio Frequency Identification) tag, Electronic Product Code (EPC), electronic circuit, microchip, integrated circuit, antenna, substrate, active identifier, semi-passive identifier, passive identifier, or inductively coupled identifier.

Example 39. The attachable element 102 of example 34, wherein the attachable member 103 carrying the identifier 104 further carries at least one of a decoration, decal, emblem, design, label, sticker, sign, symbol, character, tag, marker, indicator, figure, figurine, statuette, ornamentation, embellishment, enhancement, adornment, pattern, advertisement, announcement, notice, information, movie, music, media figure, picture, image, photograph, logo, insignia, sports teams logos, sports team players, musicians, game characters, or 3D representation.

Example 40. The attachable element 102 of example 34, wherein the attachable member 103 carrying the identifier 104 attaches to the headphone 111 by at least one of magnetic force, press-fitting into an indentation, screwing on, unscrewing off, adhesive substances, fastening tabs, fastening clips, or electrostatic force.

Example 41. The attachable element 102 of example 34, wherein the attachable member 103 carrying the identifier 104 attaches to an indentation 820 in an earcup 822, wherein the earcup has a cavity 824 on one side of the indentation 820, wherein the attachable element 102 is removed by pressing the attachable member 103 into the cavity.

Example 42. A headphone 111 comprising: an external area of the headphone 111 configured for attaching an attachable element 102 carrying an identifier 104; a reader 112 carried by the headphone 111, the reader configured to read the identifier 104 carried by the attachable element 102 and determine ID number 106 of the identifier; and a wearable accepting device processor 114 carried by the headphone, the wearable accepting device processor configured for receiving ID number 106 from the reader 112 and taking an action in the headphone 111.

Example 43. The headphone 111 of example 42, wherein taking the action in the headphone 111 includes verifying validity of ID number 106.

Example 44. The headphone 111 of example 42, wherein taking the action in the headphone 111 includes modifying wearable accepting device software 116 in the headphone 111 based on ID number 106.

Example 45. The headphone 111 of example 42, wherein taking the action in the headphone 111 includes modifying acoustic parameters of the headphone 111 based on ID number 106.

Example 46. The headphone 111 of example 42, wherein taking the action in the headphone 111 includes modifying frequency response of the headphone 111.

Example 47. The headphone 111 of example 42, wherein taking the action in the headphone 111 includes sending messages to external devices over communications links and receiving responses from external devices over communications links causing taking a subsequent action in the headphone 111.

Example 48. The headphone 111 of example 42, wherein the attachable element 102 carrying the identifier 104 is detachable from the headphone 111.

Example 49. The headphone 111 of example 42, wherein the reader 112 is at least one of affixed to, adhered to, attached to, embedded in, or embedded within, the headphone 111.

Example 50. The headphone 111 of example 42, wherein the reader 112 is configured to read the identifier 104 wherein the identifier 104 is at least one of an unencrypted identifier, encrypted identifier, hashed identifier, RFID (Radio Frequency Identification) tag, Electronic Product Code (EPC), electronic circuit, microchip, integrated circuit, antenna, substrate, active identifier, semi-passive identifier, passive identifier, or inductively coupled identifier.

Example 51. The headphone 111 of example 42, wherein attachable element 102 carrying the identifier 104 attaches to an area of the headphone 111 by at least one of magnetic force, press-fitting into an indentation, screwing on, unscrewing off, adhesive substances, fastening tabs, fastening clips, or electrostatic force.

Example 52. The headphone 111 of example 42, wherein the reader 112 is configured to read the identifier 104 using a connection of at least one of wired, direct connection, near-field communications, Bluetooth, Internet, optical, inductively coupled, magnetic field induction, electromagnetic, capacitively coupled, or wireless.

Example 53. The headphone 111 of example 47, wherein the communications links are at least one of wired, direct connection, near-field communications, Bluetooth, Internet, optical, inductively coupled, magnetic field induction, electromagnetic, capacitively coupled, or wireless.

Example 54. The headphone 111 of example 42, wherein an attachable element 102 carrying the identifier 104 attaches to an indentation 820 in the headphone 111, wherein the indentation 820 has a cavity 824 on one side of the indentation 820, wherein the attachable element 102 is removed by pressing the attachable element 102 into the cavity 824.

Example 55. A method 1100, comprising the steps of: attaching an attachable element 102 carrying an identifier 104 to a headphone 111; reading the identifier 104 by a reader 112 carried by the headphone 111; transferring ID number 106 of the identifier 104 from the reader 112 to a wearable accepting device processor 114 carried by the headphone 111; and taking an action in the headphone 111.

Example 56. The method of example 55, wherein taking the action in the headphone 111 includes verifying validity of ID number 106.

Example 57. The method of example 55, wherein taking the action in the headphone 111 includes modifying wearable accepting device software 116 in the headphone 111 based on ID number 106.

Example 58. The method of example 55, wherein taking the action in the headphone 111 includes modifying frequency response of the headphone 111.

Example 59. The method of example 55, wherein taking the action in the headphone 111 includes communicating with external devices over communications links causing subsequent actions in the headphone 111.

Example 60. The method of example 55, wherein taking the action in the headphone 111 includes communicating with external devices over communications links causing actions in external devices, including receiving communications from the headphone 111, verifying ID number of the attachable element 102, modifying software in the external device, and receiving responses from external devices.

Example 61. The method of example 55, wherein taking the action in the headphone 111 includes communicating over communications links with external devices which are games, including causing modifications of software in games based on ID number 106.

Example 62. The method of example 55, wherein taking the action in the headphone 111 includes communicating over communications links with external devices which are games, including at least one of changing characters in games, changing characters’ characteristics in games, granting powers, giving equipment, providing resources, providing capabilities, providing assets, providing weapons, improving speed, providing special movements, increasing skills, creating invisibility, enabling enhanced senses, enabling access to other player information, modifying interactions, modifying interactions with other players, and increasing physical capabilities.

Present examples satisfy the above described needs and provide further related advantages.

The foregoing descriptions and examples have been provided for purposes of illustration and description. It is not intended to be exhaustive or to limit these examples or drawings to the precise forms disclosed. Various additional modifications of the described embodiments specifically illustrated and described herein will be apparent to those skilled in in the art, particularly in light of the teachings of these examples. It is intended that the disclosure cover all modifications and embodiments, which fall within the spirit and scope. Thus, while examples of the present disclosure have been disclosed, it will be understood that these are not limited to the description herein, but is otherwise modified based upon these examples.

What is claimed is:

1. A method implemented by a first peripheral device, the method comprising:
presenting first output data of an execution of a video game, wherein the first output data is received from a first user device with which the first peripheral device is communicatively coupled;
receiving, over a communication channel with a second peripheral device, second output data from the second peripheral device, wherein the second output data represents user input received at the second peripheral device;
presenting the second output data;
identifying, based on game play data of the execution of the video game, an in-game event; and
causing a change to the communication channel based on the in-game event.

2. The method of claim 1, wherein the second peripheral device is communicatively coupled to the first user device, wherein the communication channel is modified based on an instruction of the first user device, and wherein the communication channel is modified by the first peripheral device.

3. The method of claim 1, wherein the second peripheral device is communicatively coupled to a second user device associated with the execution of the video game, wherein the communication channel is modified based on an instruction of the first user device, and wherein the communication channel is modified by the first peripheral device.

4. The method of claim 1, further comprising:
receiving an identifier from a hardware element that stores the identifier and that is communicatively coupled with the first peripheral device, wherein the communication channel is modified based on the identifier.

5. The method of claim 1, wherein the first peripheral device includes a headphone, and wherein the first output includes audio, and wherein the communication channel includes an audio channel.

6. The method of claim 5, wherein the communication channel is based on an earcup storing an identifier, attached to the headphone, and communicably coupled to the headphone.

7. The method of claim 1, wherein third output data of the execution of the video game is presented by a video game console, and wherein the communication channel between the first peripheral device and the second peripheral device is configured based on a direct, short range communication protocol.

8. A first peripheral device comprising:
one or more processors; and
one or more memories storing instructions that, upon execution by the one or more processors, configure the first peripheral device to:
present first output data of an execution of an application, wherein the first output data is received from a first user device with which the first peripheral device is communicatively coupled;
maintain a communication channel with a second peripheral device;
receive an indication of an event associated with the execution of the application; and
modify the communication channel in response to receiving the indication of the event.

9. The first peripheral device of claim 8, wherein the first peripheral device is configured to interface with a hardware element storing an identifier; and wherein the communication channel is established based on the identifier.

10. The first peripheral device of claim 8, wherein modifying the communication channel includes at least one of: muting the communication channel, terminating the communication channel, changing the communication channel from being one-directional to being bi-directional, changing the communication channel from being bi-directional to being one-directional, changing a characteristic of audio sent over the communication channel, or changing, an accessibility setting associated with the communication channel.

11. The first peripheral device of claim 8, wherein the application includes a video game application, and wherein the event includes an in-game event associated with a player operating the first user device or a second user device with which the second peripheral device is communicatively coupled.

12. The first peripheral device of claim 11, wherein the in-game event corresponds to game play data of the player.

13. The first peripheral device of claim 8, wherein the user device includes a video game console operated by a player, wherein the event corresponding to a change in one or more characteristics of a in-game character corresponding to the player, and wherein the change includes at least one of: character resources, character equipment, character powers, character capabilities, character speed, character special movements, character skills, character visibility, or character senses.

14. The first peripheral device of claim 8, wherein modifying the communication channel causes a change to an input to the execution of the application, and wherein the change modifies the first output data.

15. The first peripheral device of claim 8, wherein the communication channel is a wired channel, a near-field communication channel, a Bluetooth channel, or an over Internet channel.

16. One or more non-transitory computer-readable storage media storing instructions that, upon execution on a first peripheral device, cause the first peripheral device to perform operations comprising:
presenting first output data of an execution of an application, wherein the first output data is received from a first user device with which the first peripheral device is communicatively coupled;
maintaining a communication channel with a second peripheral device;
receiving an indication of an event associated with the execution of the application; and
modifying the communication channel in response to receiving the indication of the event.

17. The one or more non-transitory computer-readable storage media of claim 16, wherein modifying the communication channel comprises modifying one or more characteristics of the communication channel, and wherein the one or more characteristics relate to audio received from the second peripheral device and presented by the first peripheral device.

18. The one or more non-transitory computer-readable storage media of claim 16, wherein the operations further comprise:
determining an identifier received by the second peripheral device upon the second peripheral device interfacing with a hardware element that stores the identifier; and
establishing the communication channel based on the identifier.

19. The one or more non-transitory computer-readable storage media of claim 18, wherein the operations further comprise:
terminating the communication channel based on a status of the hardware element changing from active to inactive.

20. The one or more non-transitory computer-readable storage media of claim 16, wherein the operations further comprise:
presenting, prior to the event, first audio data received from the second peripheral device; and
presenting, after the event, second audio data received from the second peripheral device, wherein the second audio data is presented using a different output characteristic than the first audio data.
